(19) United States
(12) Patent Application Publication
(10) Pub. No.: US 2023/0216051 A1
(43) Pub. Date: Jul. 6, 2023

(54) ELECTRODE, NEGATIVE ELECTRODE ACTIVE MATERIAL, VEHICLE, ELECTRONIC DEVICE, AND METHOD FOR MANUFACTURING NEGATIVE ELECTRODE ACTIVE MATERIAL

(71) Applicant: SEMICONDUCTOR ENERGY LABORATORY CO., LTD., Atsugi-shi, Kanagawa-ken (JP)

(72) Inventors: Kazutaka KURIKI, Ebina, Kanagawa (JP); Yuji IWAKI, Isehara, Kanagawa (JP); Kaori OGITA, Isehara, Kanagawa (JP); Mayumi MIKAMI, Atsugi-shi, Kanagawa (JP); Yoshiharu ASADA, Odawara, Kanagawa (JP); Tatsuyoshi TAKAHASHI, Atsugi-shi, Kanagawa (JP); Shunpei YAMAZAKI, Setagaya, Tokyo (JP); Kazuki TANEMURA, Isehara, Kanagawa (JP)

(21) Appl. No.: 17/996,697

(22) PCT Filed: Apr. 23, 2021
(86) PCT No.: PCT/IB2021/053356

§ 371 Date: Oct. 20, 2022

(30) Foreign Application Priority Data
May 1, 2020 (JP) 2020-081484
Oct. 26, 2020 (JP) 2020-178831

(51) Int. Cl. H01M 4/583; H01M 4/04

(52) U.S. Cl. CPC H01M 4/583; H01M 4/0471; H01M 2004/027

(57) ABSTRACT

A negative electrode active material particle with little deterioration is provided. Alternatively, a novel negative electrode active material particle is provided. Alternatively, a power storage device with little deterioration is provided. Alternatively, a highly safe power storage device is provided. Alternatively, a novel power storage device is provided. The electrode includes an active material and a conductive additive; the active material contains a metal or a compound including one or more elements selected from silicon, tin, gallium, aluminum, germanium, lead, antimony, bismuth, silver, zinc, cadmium, and indium; the conductive additive contains a graphene compound; and the graphene compound contains fluorine.

### TECHNICAL FIELD

One embodiment of the present invention relates to a secondary battery including a negative electrode active material and a manufacturing method thereof. Furthermore, one embodiment of the present invention relates to a portable information terminal, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a negative electrode active material with a coating film has been studied to increase the cycle performance and the capacity of the lithium-ion secondary battery (Patent Document 1).

Fluorine has high electronegativity and its reactivity has been studied variously. Non-Patent Document 1 describes a reaction of a compound containing fluorine.

A silicon-based material has high capacity and is used for an active material of a secondary battery. The silicon-based material can be characterized by a chemical shift value obtained from a NMR spectrum (Patent Document 2).

X-ray diffraction (XRD) is one of methods used for analysis of a crystal structure of a negative electrode active material. With use of the ICSD (Inorganic Crystal Structure Database) described in Non-Patent Document 2, XRD data can be analyzed.

### PRIOR ART DOCUMENT

### Patent Document

[Patent Document 1]

Japanese Published Patent Application No. 2015-88482

[Patent Document 2]

Japanese Published Patent Application No. 2015-156355

### Non-Patent Document

[Non-Patent Document 1]

J. M. Sangster and A. D. Pelton, “Critical Coupled Evaluation of Phase Diagrams and Thermodynamic Properties of Binary and Ternary Alkali Salt Systems”, American Ceramic Society; Westerville, Ohio; pp. 4-231(1987).

[Non-Patent Document 2]

Belsky, A. et al., “New developments in the Inorganic Crystal Structure Database (ICSD): accessibility in support of materials research and design”, Acta Cryst., (2002) B58 364-369.

### SUMMARY OF THE INVENTION

### Problems to be Solved by the Invention

An object of one embodiment of the present invention is to provide a method for manufacturing a negative electrode active material with little deterioration. Another object of one embodiment of the present invention is to provide a novel method for manufacturing a negative electrode active material.

Another object of one embodiment of the present invention is to provide a negative electrode active material particle with little deterioration. Another object of one embodiment of the present invention is to provide a novel negative electrode active material particle. Another object of one embodiment of the present invention is to provide a power storage device with little deterioration. Another object of one embodiment of the present invention is to provide a highly safe power storage device. Another object of one embodiment of the present invention is to provide a novel power storage device.

Another object of one embodiment of the present invention is to provide a novel material, a novel active material particle, a novel power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is an electrode including an active material and a conductive additive; the active material contains a metal or a compound including one or more elements selected from silicon, tin, gallium, aluminum, germanium, lead, antimony, bismuth, silver, zinc, cadmium, and indium; the conductive additive contains a graphene compound; and the graphene compound contains fluorine.

In the above structure, the graphene compound preferably has a two-dimensional structure formed with a six-membered ring of carbon atoms.

Another embodiment of the present invention is a method for manufacturing a negative electrode active material, which includes a first step of mixing a first material, a second material containing halogen, and a third material containing oxygen and carbon to form a first mixture and a second step of performing heating of the first mixture; the first material is one or more selected from graphite, graphitizing carbon, non-graphitizing carbon, carbon nanotube, carbon black, and graphene; and the heating is performed in a reduction atmosphere.

In the above structure, the second material is preferably fluoride or chloride including one or more selected from lithium, magnesium, aluminum, sodium, potassium, calcium, barium, lanthanum, cerium, chromium, manganese, iron, cobalt, nickel, zinc, zirconium, titanium, vanadium, and niobium.

In the above structure, the third material is preferably carbonate including one or more selected from lithium, magnesium, aluminum, sodium, potassium, calcium, barium, lanthanum, cerium, chromium, manganese, iron, cobalt, and nickel.

In the above structure, the reduction atmosphere is preferably a nitrogen atmosphere or a rare gas atmosphere.

Another embodiment of the present invention is a method for manufacturing a negative electrode active material, which includes a first step of mixing a first material, lithium fluoride, and lithium carbonate to form a first mixture and a second step of performing heating of the first mixture; the heating is performed at a temperature higher than or equal to 350° C. and lower than or equal to 900° C. for a time longer than or equal to 1 hour and shorter than or equal to 60 hours; and the heating is performed in a nitrogen atmosphere or a rare gas atmosphere.

In the above structure, the first material is preferably one or more selected from graphite, graphitizing carbon, non-graphitizing carbon, carbon nanotube, carbon black, and graphene.

In the above structure, the first material preferably contains a metal or a compound including one or more elements selected from silicon, tin, gallium, aluminum, germanium, lead, antimony, bismuth, silver, zinc, cadmium, and indium.

In the above structure, the first material preferably contains an oxide including one or more elements selected from titanium, niobium, tungsten, and molybdenum.

Another embodiment of the present invention is a negative electrode active material including a first region, a second region, at least one of fluorine and oxygen, lithium, and carbon; the first region contains a first material; the second region is positioned on an outer side of the first region; the second region is in contact with at least part of a surface of the first region; the fluorine concentration in the second region is higher than the fluorine concentration in the first region; the oxygen concentration in the second region is higher than the oxygen concentration in the first region; and the first material is one or more selected from graphite, graphitizing carbon, non-graphitizing carbon, carbon nanotube, carbon black, and graphene.

In the above structure, at least part of the first region preferably includes a surface of the negative electrode active material.

In the above structure, the lithium concentration in the second region is preferably higher than the lithium concentration in the first region.

Another embodiment of the present invention is a negative electrode active material including a first region and a second region; the first region contains a first material; the second region contains at least one of lithium fluoride and lithium carbonate; the second region is positioned on an outer side of the first region; and the second region is in contact with at least part of the first region.

In the above structure, at least part of the first region preferably includes a surface of the negative electrode active material.

In the above structure, when the negative electrode active material is measured by an energy dispersive X-ray spectroscopy method with a scanning electron microscope, the fluorine concentration whose concentration unit is represented as atomic % is preferably higher than or equal to 10 atomic % and lower than or equal to 70 atomic %.

In the above structure, the first material is a negative electrode active material that is one or more selected from graphite, graphitizing carbon, non-graphitizing carbon, carbon nanotube, carbon black, and graphene.

In the above structure, when the negative electrode active material is measured by energy dispersive X-ray spectroscopy, the fluorine concentration is preferably higher than or equal to 1 atomic %.

In the above structure, the first material is preferably one or more selected from graphite, graphitizing carbon, non-graphitizing carbon, carbon nanotube, carbon black, and graphene, and when the negative electrode active material is measured by energy dispersive X-ray spectroscopy, the fluorine concentration is preferably higher than or equal to 1 atomic % with respect to the total concentration of fluorine, oxygen, lithium, and carbon.

Another embodiment of the present invention is a secondary battery including a negative electrode including the above-described negative electrode active material, a positive electrode, and an electrolyte.

Another embodiment of the present invention is a vehicle including the above-described secondary battery, an electric motor, and a circuit portion; and the circuit portion has function of controlling the secondary battery.

Another embodiment of the present invention is an electronic device including the above-described secondary battery, a display portion, and a circuit portion; and the circuit portion has a function of controlling the secondary battery.

### Effect of the Invention

According to one embodiment of the present invention, a method for manufacturing a negative electrode active material with little deterioration can be provided. According to another embodiment of the present invention, a novel method for manufacturing a negative electrode active material can be provided.

According to another embodiment of the present invention, a negative electrode active material particle with little deterioration can be provided. According to another embodiment of the present invention, a method for manufacturing a negative electrode active material can be provided. According to another embodiment of the present invention, a novel negative electrode active material particle can be provided. According to another embodiment of the present invention, a novel power storage device can be provided.

According to another embodiment of the present invention, a novel material, a novel active material particle, a novel power storage device, or a manufacturing method thereof can be provided.

Note that the description of these effects does not preclude the existence of other effects. One embodiment of the present invention does not have to have all of these effects. Other effects will be apparent from the descriptions of the specification, the drawings, the claims, and the like, and other effects can be derived from the descriptions of the specification, the drawings, the claims, and the like.

### BRIEF DESCRIPTION OF THE DRAWINGS

FIG. 1A is a diagram illustrating an example of a cross section of a negative electrode, FIG. 1B is a diagram illustrating an example of a graphene compound, and FIG. 1C is a schematic diagram showing a graphene compound and an active material.

FIG. 2 is a phase chart showing a relation between temperatures and rates of LiF and Li₂CO₃.

FIG. 3 is a diagram showing a method for manufacturing a material.

FIG. 4A, FIG. 4B, FIG. 4C, and FIG. 4D each illustrates an example of a cross section of a negative electrode active material.

FIG. 5 shows calculation results of stabilization energy.

FIG. 6 shows a structure of graphite.

FIG. 7 shows a structure of graphite.

FIG. 8 shows a structure of graphite.

FIG. 9 shows calculation results of stabilization energy.

FIG. 10 is a diagram showing a method for manufacturing a material.

FIG. 11 is a process cross-sectional view showing an example of one embodiment of the present invention.

FIG. 12 is a diagram showing crystal structures of a positive electrode active material.

FIG. 13 is a diagram showing crystal structures of a positive electrode active material.

FIG. 14 is a diagram showing an example of a method for manufacturing a positive electrode active material.

FIG. 15A and FIG. 15B are diagrams each illustrating an example of a secondary battery.

FIG. 16A, FIG. 16B, and FIG. 16C are diagrams illustrating an example of a secondary battery.

FIG. 17A and FIG. 17B are diagrams illustrating an example of a secondary battery.

FIG. 18A, FIG. 18B, and FIG. 18C are diagrams illustrating a coin-type secondary battery.

FIG. 19A, FIG. 19B, FIG. 19C, and FIG. 19D are diagrams illustrating cylindrical secondary batteries.

FIG. 20A and FIG. 20B are diagrams illustrating examples of a secondary battery.

FIG. 21A, FIG. 21B, FIG. 21C, and FIG. 21D are diagrams illustrating examples of a secondary battery.

FIG. 22A, FIG. 22B, and FIG. 22C are diagrams illustrating an example of a secondary battery.

FIG. 23A, FIG. 23B, and FIG. 23C are diagrams illustrating an example of a secondary battery.

FIG. 24A, FIG. 24B, and FIG. 24C are diagrams illustrating an example of a laminated secondary battery.

FIG. 25A and FIG. 25B are diagrams illustrating a laminated secondary battery.

FIG. 26 is an external view of a secondary battery.

FIG. 27 is an external view of a secondary battery.

FIG. 28A, FIG. 28B, and FIG. 28C are diagrams illustrating a method for manufacturing a secondary battery.

FIG. 29A, FIG. 29B, FIG. 29C, FIG. 29D, and FIG. 29E are diagrams illustrating a bendable secondary battery.

FIG. 30A and FIG. 30B are diagrams illustrating a bendable secondary battery.

FIG. 31A, FIG. 31B, FIG. 31C, FIG. 31D, FIG. 31E, FIG. 31F, FIG. 31G, and FIG. 31H are diagrams illustrating examples of electronic devices.

FIG. 32A, FIG. 32B, and FIG. 32C are diagrams illustrating an example of an electronic device.

FIG. 33 is a diagram illustrating examples of electronic devices.

FIG. 34A, FIG. 34B, and FIG. 34C are diagrams illustrating examples of electronic devices.

FIG. 35A, FIG. 35B, and FIG. 35C are drawings each illustrating an example of an electronic device.

FIG. 36A is a perspective view of a battery pack, FIG. 36B is a block diagram of a battery pack, and FIG. 36C is a block diagram of a vehicle including a motor.

FIG. 37A, FIG. 37B, and FIG. 37C are diagrams each illustrating an example of a vehicle.

FIG. 38A and FIG. 38B are SEM images.

FIG. 39A is an image showing an EDX observation point, and FIG. 39B is an EDX spectrum.

FIG. 40A is an image showing an EDX observation point, and FIG. 40B is an EDX spectrum.

FIG. 41A, FIG. 41B, FIG. 41C, and FIG. 41D each show XPS.

FIG. 42A, FIG. 42B, FIG. 42C, and FIG. 42D each show XPS.

FIG. 43A, FIG. 43B, FIG. 43C, and FIG. 43D each show XPS.

FIG. 44A, FIG. 44B, FIG. 44C, and FIG. 44D each show XPS.

FIG. 45 shows XPS.

FIG. 46A and FIG. 46B each show XPS.

FIG. 47A and FIG. 47B each show XPS.

FIG. 48A shows rate performance, and FIG. 48B shows cycle characteristics.

FIG. 49A and FIG. 49B each show cycle characteristics.

FIG. 50 shows results of XRD measurement.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (−) at the front of a number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, segregation refers to a phenomenon in which, in a solid made of a plurality of elements (e.g., A, B, and C), a certain element (e.g., B) is spatially non-uniformly distributed.

In this specification and the like, a surface portion of a particle of an active material or the like is preferably a region that is less than or equal to 50 nm, preferably less than or equal to 35 nm, further preferably less than or equal to 20 nm from the surface, for example. A plane generated by a split and a crack may also be referred to as a surface. In addition, a region whose position is deeper than that of the surface portion is referred to as an inner portion.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure of a composite oxide containing lithium and a transition metal belongs to the space group R-3m crystal structure, and is not a spinel crystal structure but a crystal structure in which an ion of cobalt, magnesium, or the like is coordinated to six oxygen atoms and the cation arrangement has symmetry similar to that of the spinel crystal structure. Note that in the O3′ type crystal structure, a light element such as lithium sometimes occupies a site coordinated to four oxygen atoms; also in this case, the ion arrangement has symmetry similar to that of the spinel structure.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, simple and pure lithium cobalt oxide or a layered rock-salt positive electrode active material including a large amount of cobalt is known not to have this crystal structure generally.

Anions of a layered rock-salt crystal and anions of a rock-salt crystal have a cubic close-packed structure (face-centered cubic lattice structure). Anions of an O3′ type crystal structure are also presumed to form a cubic close-packed structure. When the O3′ type crystal structure is in contact with the layered rock-salt crystal and the rock-salt crystal, there is a crystal plane at which orientations of cubic close-packed structures composed of anions are aligned. Note that the space groups of the layered rock-salt crystal and the O3′ type crystal structure are R-3m, which is different from the space groups Fm-3m (the space group of a general rock-salt crystal) of rock-salt crystals; thus, the Miller index of the crystal plane satisfying the above conditions in the layered rock-salt crystal and the O3′ type crystal structure is different from that in the rock-salt crystal. In this specification, a state where the orientations of the cubic close-packed structures composed of anions in the layered rock-salt crystal, the O3′ type crystal structure, and the rock-salt crystal are aligned is sometimes referred to as a state where crystal orientations are substantially aligned.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted and is contained in a positive electrode active material is extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. A positive electrode active material with a charge depth greater than or equal to 0.7 and less than or equal to 0.9 may be referred to as a positive electrode active material charged with high voltage.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. A positive electrode active material with a charge depth less than or equal to 0.06 or a positive electrode active material from which more than or equal to 90% of the charge capacity is discharged from a high-voltage charged state is referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

A secondary battery includes a positive electrode and a negative electrode, for example. A positive electrode active material is a material included in the positive electrode. The positive electrode active material is a substance that performs a reaction contributing to the charge/discharge capacity, for example. Note that the positive electrode active material may partly contain a substance that does not contribute to the charge/discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The discharging rate refers to the relative ratio of current at the time of discharging to battery capacity and is expressed in a unit C. A current corresponding to 1 C in a battery with a rated capacity X (Ah) is X (A). The case where discharging is performed at a current of 2X (A) is rephrased as to perform discharging at 2 C, and the case where discharging is performed at a current of X/5 (A) is rephrased as to perform discharging at 0.2 C. The same applies to the charging rate; the case where charging is performed at a current of 2X (A) is rephrased as to perform charging at 2 C, and the case where charging is performed at a current of X/5 (A) is rephrased as to perform charging at 0.2 C.

Constant-current charging refers to, for example, a method for performing charging at a constant charging rate. Constant voltage charging refers to a charging method in which voltage is fixed when reaching the upper voltage limit, for example. Constant-current discharging refers to, for example, a method for performing discharging at a constant discharging rate.

### Embodiment 1

In this embodiment, a negative electrode, a negative electrode active material, and a method for manufacturing a negative electrode active material of one embodiment of the present invention will be described.

### <Negative Electrode>

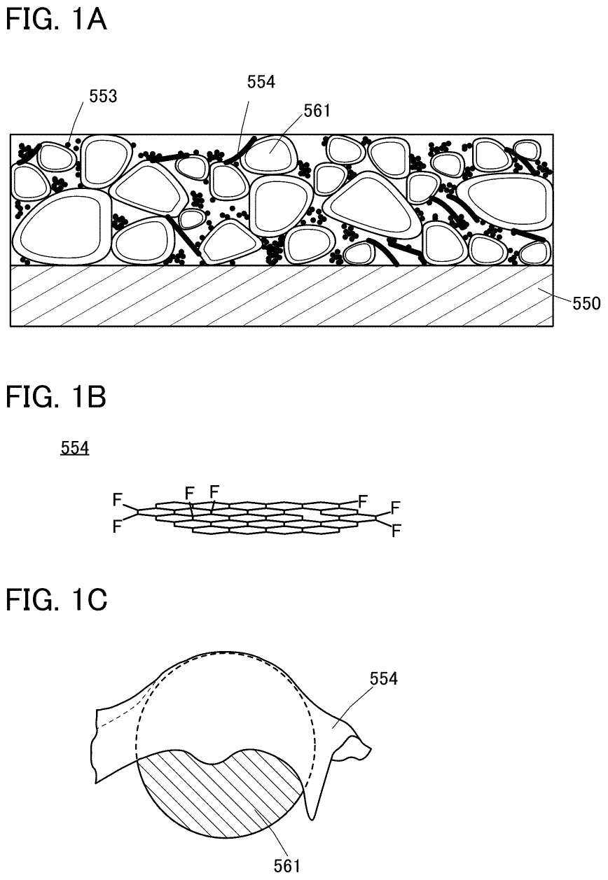

FIG. 1A illustrates an example of a cross section of a negative electrode of one embodiment of the present invention. In the negative electrode of one embodiment of the present invention, a negative electrode active material layer including a negative electrode active material 561, graphene 554, and acetylene black 553 is formed over a current collector 550.

The active material of one embodiment of the present invention preferably contains fluorine in a surface portion.

In the secondary battery, the charge/discharge efficiency might be decreased owing to an irreversible reaction typified by a reaction between an electrode and an electrolyte. A decrease in the charge/discharge efficiency occurs significantly in first charging and discharging especially, in some cases.

The surface portion of a negative electrode active material of one embodiment of the present invention contains halogen, whereby a decrease in charge/discharge efficiency can be inhibited. The surface portion of the negative electrode active material of one embodiment of the present invention contains halogen, which presumably enables a reaction with an electrolyte at a surface of the active material to be inhibited. At least part of the surface of the negative electrode active material of one embodiment of the present invention is covered with a region containing halogen in some cases. The region can be a film form, for example.

The surface portion is preferably a region that is less than or equal to 50 nm, preferably less than or equal to 35 nm, further preferably less than or equal to 20 nm from the surface, for example. In addition, a region whose position is deeper than that of the surface portion is referred to as an inner portion.

The surface portion of the negative electrode active material of one embodiment of the present invention contains halogen, whereby a secondary battery can achieves good performance even at a high charge/discharge rate. Thus, the charge/discharge speed can be increased. In the case where the negative electrode active material contains graphite in the inner portion and halogen in the surface portion, halogen or a halogen compound is inserted between layers of graphite in some cases. The insertion of halogen or a halogen compound between the layers expands the interlayer distance at a surface of graphite or in the vicinity of the surface, whereby the insertion/extraction of carrier ions between the layers is facilitated. This leads to a possibility that a secondary battery achieves good performance at a high charge/discharge rate. The interlayer distance of graphite can be analyzed through XRD, observation with a transmission electron microscope, EDX (energy dispersive X-ray spectroscopy), or the like.

Furthermore, the surface portion of the negative electrode active material of one embodiment of the present invention contains halogen, which leads to a possibility that a solvent in an electrolyte solution with solvated carrier ions is likely to be desorbed at the surface of the negative electrode active material. When the solvent solvated with carrier ions is likely to be desorbed, a secondary battery has a possibility of achieving good performance at a high charge/discharge rate.

The negative electrode active material of one embodiment of the present invention preferably contains fluorine particularly, as halogen.

Fluorine has high electronegativity. The surface portion of the negative electrode active material of one embodiment of the present invention contains fluorine, in which case there is a possibility of such an effect that a solvent solvated with carrier ions at the surface of the negative electrode active material is likely to be desorbed.

### <Conductive Additive>

In the negative electrode illustrated in FIG. 1A, the graphene 554 and the acetylene black 553 preferably function as conductive additives. Moreover, the conductive additives such as the graphene 554 and the acetylene black 553 may function as an active material. As the graphene 554, graphene and a graphene compound can be used. The details of the graphene compound are described later.

Although FIG. 1A illustrates an example in which the negative electrode includes the graphene 554 and the acetylene black 553, the negative electrode may include only one of them. Alternatively, a variety of materials can be used for a conductive additive in the negative electrode.

As the conductive additive, a carbon material, a metal material, a conductive ceramic material, or the like can be used, for example. Alternatively, a fiber material may be used as the conductive additive. The content of the conductive additive to the total amount of the active material layer is preferably greater than or equal to 1 wt % and less than or equal to 10 wt %, and further preferably greater than or equal to 1 wt % and less than or equal to 5 wt %.

A network for electric conduction can be formed in the active material layer by the conductive additive. The conductive additive also allows maintaining of a path for electric conduction between the negative electrode active materials. The addition of the conductive additive to the active material layer increases the electric conductivity of the active material layer.

As the conductive additive, a graphene compound can be used. For example, natural graphite, artificial graphite such as mesocarbon microbeads, carbon fiber, or the like can be used as the conductive additive.

As carbon fiber, mesophase pitch-based carbon fiber and isotropic pitch-based carbon fiber can be used, for example. As carbon fiber, one or more selected from carbon nanofiber, carbon nanotube, and the like can also be used. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, one or more selected from metal powder and metal fiber of copper, nickel, aluminum, silver, gold, or the like, a conductive ceramic material, and the like can be used.

### [Graphene Compound]

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. A graphene compound is preferably bent. A graphene compound may be rounded like a carbon nanofiber.

Any of the materials given above can be combined as the conductive additive.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. Reduced graphene oxide may also be referred to as a carbon sheet. The reduced graphene oxide functions by itself as a single layer and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive additive with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive additive with high conductivity even with a small amount.

In the longitudinal cross section of the active material layer, the sheet-like graphene compounds are preferably dispersed substantially uniformly in an inner region of the active material layer. The plurality of graphene compounds are formed to partly cover the plurality of particles of the negative electrode active material or adhere to the surfaces thereof, so that the plurality of graphene compounds are contact with each other at their surfaces.

Here, the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the charge/discharge capacity of the secondary battery can be increased.

Here, it is preferable to perform reduction after a layer to be the active material layer is formed in such a manner that graphene oxide is used as the graphene compound and mixed with an active material. That is, the formed active material layer preferably contains reduced graphene oxide. When graphene oxide with extremely high dispersibility in a polar solvent is used to form the graphene compounds, the graphene compounds can be substantially uniformly dispersed in an inner region of the active material layer. The solvent is removed by volatilization from a dispersion medium containing the uniformly dispersed graphene oxide to reduce the graphene oxide; hence, the graphene compounds remaining in the active material layer partly overlap each other and are dispersed such that surface contact is made, thereby forming a three-dimensional conduction path. Note that graphene oxide can be reduced by heat treatment or with use of a reducing agent, for example.

FIG. 1C is a schematic diagram of an active material and a graphene compound. Unlike a particle of conductive additive such as acetylene black, which makes point contact with an active material, the graphene compound is capable of making low-resistance surface contact; accordingly, the electrical conduction between the particles of the negative electrode active material and the graphene compound can be improved with a smaller amount of the graphene compound than that of a normal conductive additive. This can increase the proportion of the negative electrode active material in the active material layer, resulting in increased discharge capacity of the secondary battery.

With a spray dry apparatus, a graphene compound serving as a conductive additive can be formed in advance as a coating film to cover the entire surface of the active material, and a conductive path can be formed between the active materials using the graphene compound.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. D50 (also referred to as a median diameter) of the particles is preferably less than or equal to 1 μm, further preferably less than or equal to 100 nm.

### [Fluorine-Modified Conductive Additive]

In the negative electrode of one embodiment of the present invention, it is preferable that the conductive additive be modified with fluorine. For example, the conductive additive can be formed using any of the above-described materials modified with fluorine.

The fluorine modification of the conductive additive can be performed by, for example, treatment or heat treatment using a gas containing fluorine, plasma treatment in an atmosphere of a gas containing fluorine, or the like. Example of gases containing fluorine that can be used include a fluorine gas and a low hydrofluorocarbon gas such as fluoromethane (CF₄).

Alternatively, as the fluorine modification of the conductive additive, the conductive additive may be immersed in a solution containing fluorine, tetrafluoroboric acid, hexafluorophosphate, or the like, a solution containing a fluorine-containing ether compound or the like, for example.

By the fluorine modification of the conductive additive, it is expected that the structure of the conductive additive is stabilized and that the side reaction in the charge/discharge process of a secondary battery would be inhibited. The inhibition of the side reaction enables an improvement in the charge/discharge efficiency. In addition, a decrease in capacity caused by the repetition of charging and discharging can be inhibited. Therefore, with use of the conductive additive modified with fluorine in the negative electrode of one embodiment of the present invention, an excellent secondary battery can be achieved.

The structure stabilization of the conductive additive causes stable conductive characteristics and achieves high output characteristics in some cases.

### <Components of Secondary Battery>

As a component of the secondary battery of one embodiment of the present invention, a fluorine-containing material is preferably used. For example, a positive electrode of one embodiment of the present invention preferably includes a positive electrode active material containing fluorine. Being described in detail later, a positive electrode active material of one embodiment of the present invention contains fluorine. The positive electrode active material containing fluorine has a stable structure in charging, and thus can be charged repeatedly at a high charge voltage. The increase in charge voltage can increase the energy density of the secondary battery.

In the positive electrode of one embodiment of the present invention, a combination of the positive electrode active material containing fluorine and the above-described fluorine-modified conductive additive is used, whereby synergistic effects such as high energy density, high output characteristics, and a long lifetime can be obtained in a secondary battery.

The fluorine-containing material is stable and used as a component of a secondary battery in which case the secondary battery can achieve characteristics stabilization, a long life, and the like. Thus, the fluorine-containing material is preferably used in a separator, an electrolyte, or an exterior body. Details of the separator, the electrolyte, and the exterior body are described later.

### <Example of Negative Electrode Structure>

In the negative electrode of one embodiment of the present invention, a combination of a high-capacity material as the active material and graphene or a graphene compound as the conductive additive is used, whereby synergistic effects such as high capacity and high output characteristics in a secondary battery can be obtained.

As the high-capacity material, a variety of negative electrode active materials described below can be used. Here, as an example, a metal, a material, or a compound including one or more elements selected from silicon, tin, gallium, aluminum, germanium, lead, antimony, bismuth, silver, zinc, cadmium, and indium, is used as the negative electrode active material. The use of the above material can increase the capacity of a secondary battery. For example, silicon has significantly high theoretical capacity of 4200 mAh/g, with which a high-capacity secondary battery can be achieved.

As a material containing silicon, a material represented by SiOₓ (x is preferably smaller than 2, further preferably larger than or equal to 0.5 and smaller than or equal to 1.6) can be used, for example.

A material containing silicon, which has a plurality of crystal grains in a single particle, for example, can be used. For example, a configuration where a single particle include one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

Graphene terminated with fluorine is used as the conductive additive. FIG. 1B is a schematic diagram of graphene terminated with fluorine. Although the illustrated example is the graphene terminated with fluorine, graphene may be terminated with a functional group including fluorine. Graphene may include a functional group such as a carbonyl group, a carboxyl group, a hydroxyl group, and an ether group, in addition to fluorine and a functional group including fluorine.

The conductive additive modified with fluorine has high conductivity. On an electrode using the high-capacity material, charging and discharging with a higher current density are performed. The use of the conductive additive with high conductivity enables higher output characteristics to be achieved also in an electrode using the high-capacity material.

### <Example of Manufacturing Method>

The negative electrode active material of one embodiment of the present invention can be manufactured, for example, in a manner such that a first material that can contribute to reaction of a secondary battery and a compound containing halogen as a second material are mixed and subjected to heat treatment.

In addition to the second material, a material generating eutectic reaction with the second material may be mixed as a third material. The eutectic point caused by the eutectic reaction is preferably lower than at least one of the melting point of the second material and the melting point of the third material. A decrease in the melting point due to the eutectic reaction brings the feasibility of covering the surface of the first material with the second material and the third material during the heating treatment, which increases the coverage in some cases.

As the second material and the third material, a material including a metal whose ion functions as a carrier ion in the reaction of the secondary battery is used, whereby such a metal can contribute to charging and discharging using its carrier ion, in some cases, when the metal is included in a negative electrode active material.

As the third material, a material containing oxygen and carbon can be used, for example. As the material containing oxygen and carbon, carbonate can be used, for example. Alternatively, as the material containing oxygen and carbon, an organic compound can be used, for example.

Alternatively, as the third material, hydroxide may be used.

Materials such as carbonate and hydroxide are preferable because many of them are inexpensive and have a high level of safety. Furthermore, carbonate, hydroxide, and the like generate a eutectic point with a material containing halogen, which is preferable.

Note that a negative electrode active material described below may have an effect of increasing conductivity in an electrode. When the negative electrode active material has an effect of increasing the conductivity, a small reacting weight of a carrier ion and the negative electrode active material, caused by a battery reaction, in the negative electrode active material is allowable in some cases.

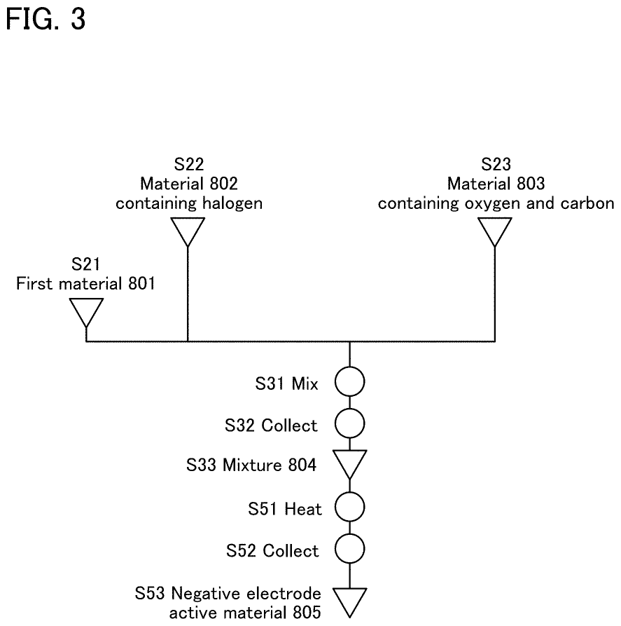

Furthermore, a manufacturing method of a negative electrode active material described below may be applied to a manufacturing method of a conductive additive. For example, as fluorine modification of graphene functioning as a conductive additive, Step S31 to Step S53 in a flowchart of FIG. 3 described below are performed on the assumption that a first material 801 is graphene, so that graphene modified with fluorine can be obtained as a conductive material.

More specific examples of the second material and the third material are described. When lithium fluoride is used as the second material, the lithium fluoride does not cover the surface of the first material but is aggregated only with itself, in some cases, in heating after being mixed with the first material. In such a case, a material generating a eutectic reaction with lithium fluoride is used as the third material, whereby the coverage of the surface of the first material is improved in some cases.

As an example of the third material generating a eutectic reaction with lithium fluoride, lithium carbonate is described.

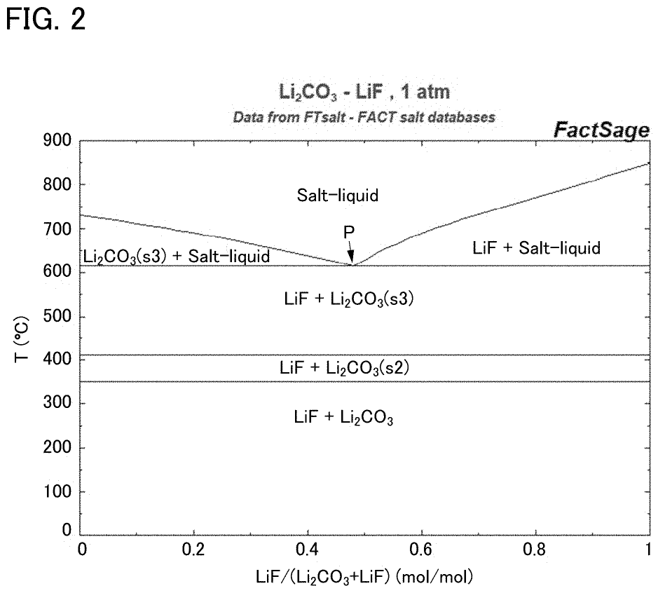

FIG. 2 is a phase chart showing the relation between temperatures and rates of LiF and Li₂CO₃. Data extracted from FACT Salt Phase Diagrams is used in FIG. 2. As shown in FIG. 2, the melting point of LiF is approximately 850° C., but the melting point can be decreased by mixing with Li₂CO₃. Thus, at the same heating temperature, the dissolution occurs more easily in the case of mixing LiF and Li₂CO₃ than the case of using only LiF, for example, and the coverage of the surface of the first material can be improved in the former case. In addition, the temperature in heating can be decreased.

With the eutectic reaction, the affinity with the surface of the first material can be increased. For example, when graphite is used as the first material, a region formed with a C—H bond in the surface of the graphite has low affinity with fluorine, in some cases. With the eutectic reaction between LiF and Li₂CO₃, the affinity between the surface of the graphite and the material containing fluorine is increased, whereby the coverage of the surface may be improved.

According to FIG. 2, the molar quantity of LiF with respect to the total molar quantity of LiF and Li₂CO₃ [LiF/(Li₂CO₃+LiF)] is approximately 0.48 at a point P in FIG. 2, which shows the lowest melting point. In other words, at a molar ratio of LiF to Li₂CO₃ (LiF:Li₂CO₃) set to a1:(1−a1), the lowest melting point can be obtained when a1 is around 0.48. The temperature T at the point P is approximately 615° C.

Note that when a1 is set to a value larger than 0.48, the surface of the first material can be covered with a material with a higher fluorine content. Thus, for example, a1 is preferably a value larger than 0.2, further preferably a value larger than or equal to 0.3. However, when the fluorine content is too high, the coverage might be poor due to an increase in the melting point. For example, a1 is preferably a value smaller than 0.9, further preferably a value smaller than or equal to 0.8.

An example of a manufacturing method of the negative electrode active material of one embodiment of the present invention is described with reference to the flowchart shown in FIG. 3.

In Step S21, the first material 801 is prepared.

As the first material 801, it is preferable to use a material that can be reacted with a carrier ion of a secondary battery, a material into/from which a carrier ion can be inserted and extracted, a material capable of alloying reaction with a metal that is to be a carrier ion, a material that can dissolve and precipitate a metal that is to be a carrier ion, or the like.

Examples of carrier ions of secondary batteries include an alkali metal ion such as a lithium ion, a sodium ion, and a potassium ion and an alkaline-earth metal ion such as a calcium ion, a strontium ion, a barium ion, a beryllium ion, and a magnesium ion.

As the first material 801, a carbon-based material such as graphite, graphitizing carbon, non-graphitizing carbon, a carbon nanotube, carbon black, and graphene can be used, for example.

In addition, as the first material 801, a metal, a material, or a compound including one or more elements selected from silicon, tin, gallium, aluminum, germanium, lead, antimony, bismuth, silver, zinc, cadmium, and indium, can be used, for example.

An impurity element such as phosphorus, arsenic, boron, aluminum, or gallium may be added to silicon so that silicon is lowered in resistance.

As a material containing silicon, a material represented by SiOₓ (x is preferably smaller than 2, further preferably larger than or equal to 0.5 and smaller than or equal to 1.6) can be used, for example.

A material containing silicon, which has a plurality of crystal grains in a single particle, for example, can be used. For example, a configuration where a single particle include one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

A compound containing silicon can be analyzed with NMR, XRD, Raman spectroscopy, or the like.

Furthermore, as the first material 801, an oxide including one or more elements selected from titanium, niobium, tungsten, and molybdenum can be used, for example.

As the first material 801, a plurality of the above-described metal, material, compound, and the like can be combined to be used.

When the first material 801 is heated, reaction with oxygen in an atmosphere occurs in the heating, whereby an oxide film is formed on the surface of the first material 801 in some cases. In the manufacture of the negative electrode active material of one embodiment of the present invention, eutectic reaction between a material 802 containing halogen and a material 803 containing oxygen and carbon is caused in Step S51 described later, whereby heating at low temperatures can be performed. As a result, oxidation reaction at the surface or the like can be inhibited.

When a carbon material is used as the first material 801, there is a concern that carbon dioxide is generated by reaction of the carbon material and oxygen in an atmosphere in the heating to cause a reduction in the weight of the first material 801, damage to the surface of the first material 801, and the like. In the manufacture of the negative electrode active material of one embodiment of the present invention, the heating can be performed at a low temperature; thus, a reduction in weight, the surface damage, and the like can be inhibited even when the carbon material is used as the first material.

Here, graphite is prepared for the first material 801. As the graphite, flake graphite, spherical natural graphite, MCMB, or the like can be used. The surface of graphite may be covered with a low-crystalline carbon material.

In Step S22, the material 802 containing halogen is prepared for the second material. As the material 802 containing halogen, a halogen compound containing a metal A1 can be used. As the metal A1, one or more elements selected from lithium, magnesium, aluminum, sodium, potassium, calcium, barium, lanthanum, cerium, chromium, manganese, iron, cobalt, nickel, zinc, zirconium, titanium, vanadium, and niobium can be used. As the halogen compound, for example, a fluoride or a chloride can be used. The halogen contained in the material 802 containing halogen is represented by an element Z.

Here, lithium fluoride is prepared as an example.

In Step S23, the material 803 containing oxygen and carbon is prepared for the third material. As the material 803 containing oxygen and carbon, carbonate containing a metal A2 can be used, for example. As the metal A2, one or more elements selected from lithium, magnesium, aluminum, sodium, potassium, calcium, barium, lanthanum, cerium, chromium, manganese, iron, cobalt, and nickel can be used.

Here, lithium carbonate is prepared as an example.

Next, in Step S31, the first material 801, the material 802 containing halogen, and the material 803 containing oxygen and carbon are mixed. In Step 32, a mixture is collected. In Step S33, a mixture 804 is obtained.

The material 802 containing halogen and the material 803 containing oxygen and carbon are preferably mixed to have a ratio such that (the material 802 containing halogen):(the material 803 containing oxygen and carbon)=a1:(1−a1) [unit: mol.] where a1 is preferably larger than 0.2 and smaller than 0.9, further preferably larger than or equal to 0.3 and smaller than or equal to 0.8.

Furthermore, the first material 801 and the material 802 containing halogen are preferably mixed to have a ratio such that (the first material 801):(the material 802 containing halogen)=1:b1[unit: mol.] where b1 is preferably larger than or equal to 0.001 and smaller than or equal to 0.2.

Next, in Step S51, the mixture 804 is heated.

It is preferable that the heating be performed in a reduction atmosphere because the oxidation of the surface of the first material 801 and the reaction of the first material 801 with oxygen can be inhibited. The reduction atmosphere may be a nitrogen atmosphere or a rare gas atmosphere, for example. Furthermore, two or more types of gases selected from nitrogen and a rare gas may be mixed and used. The heating may be performed under reduced pressure.

In the case where the melting point of the material 802 containing halogen is represented by M₂ [° C.], the temperature at heating is preferably higher than (M₂−550) [K] and lower than (M₂+50) [K], further preferably higher than or equal to (M₂−400) [° C.] and lower than or equal to (M₂) [° C.].

Moreover, in the compound, solid-phase diffusion occurs easily at a temperature higher than or equal to Tamman temperature. The Tamman temperature of an oxide, for example, is 0.757 times of the melting point. Thus, the temperature at the heating is preferably higher than or equal to 0.757 times of the melting point or higher than its vicinity, for example.

In the case of lithium fluoride that is a typical example of the material containing halogen, the amount of evaporation increases rapidly at a temperature higher than or equal to the melting point. Thus, the temperature at heating is preferably lower than or equal to the melting point of the material containing halogen, for example.

In the case where the eutectic point of the material 802 containing halogen and the material 803 containing oxygen and carbon is represented by M₂₃ [K], the temperature at heating is, for example, preferably higher than (M₂₃×0.7) [K] and lower than (M₂+50) [K], preferably higher than or equal to (M₂₃×0.75) [K] and lower than or equal to (M₂+20) [K], preferably higher than or equal to (M₂₃×0.75) [K] and lower than or equal to (M₂+20) [K], preferably higher than M₂₃ [K] and lower than (M₂+10) [K], further preferably higher than or equal to (M₂₃×0.8) [K] and lower than or equal to M₂ [K], and further preferably higher than or equal to (M₂₃) [K] and lower than or equal to M₂ [K].

In the case where lithium fluoride is used as the material 802 containing halogen, and lithium carbonate is used as the material 803 containing oxygen and carbon, the temperature at heating is, for example, preferably higher than 350° C. and lower than 900° C., further preferably higher than or equal to 390° C. and lower than or equal to 850° C., still further preferably higher than or equal to 520° C. and lower than or equal to 910° C., still further preferably higher than or equal to 570° C. and lower than or equal to 860° C., yet still further preferably higher than or equal to 610° C. and lower than or equal to 860° C.

The heating time is preferably longer than or equal to 1 hour and shorter than or equal to 60 hours, further preferably longer than or equal to 3 hour and shorter than or equal to 20 hours.

By the heating, one or more of the element Z, oxygen, carbon, the metal A1, and the metal A2 diffuse in a surface portion of the first material 801 in some cases. When the first material 801 includes the element(s), carrier ions are likely to be inserted and extracted into/from the first material 801 in some cases. Furthermore, the desolvation of carrier ions is facilitated in some cases. Alternatively, the heating can inhibit the deformation of the crystal structure of the first material 801 caused by the repetition of insertion and extraction of carrier ions.

Next, in Step S52, the heated mixture is collected, whereby a negative electrode active material 805 is obtained in Step S53.

Through the steps described above, the negative electrode active material of one embodiment of the present invention can be obtained.

Next, the negative electrode and the negative electrode active material of one embodiment of the present invention are described.

The negative electrode of one embodiment of the present invention includes a negative electrode active material layer. The negative electrode active material layer includes a negative electrode active material. The negative electrode active material layer may include a conductive additive, a binder, and the like. The negative electrode active material layer may include an electrolyte. When the negative electrode active material layer includes an electrolyte, carrier ions of the negative electrode active material layer are likely to diffuse. The electrolyte is mixed in slurry for forming the negative electrode active material layer, and the slurry is applied to a negative electrode current collector, whereby the negative electrode active material layer can include the electrolyte. Alternatively, after the slurry is applied to a negative electrode current collector and dried, the negative electrode is immersed in a solution containing an electrolyte, whereby the negative electrode active material layer can include the electrolyte.

The negative electrode of one embodiment of the present invention preferably includes a negative electrode current collector, and the negative electrode active material layer is preferably provided over the negative electrode current collector.

### <Negative Electrode Active Material>

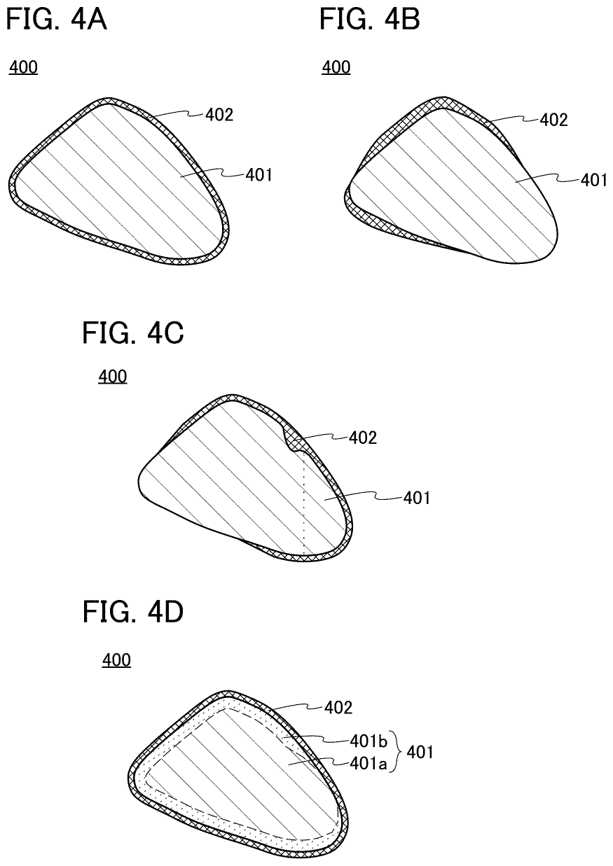

FIG. 4A, FIG. 4B, FIG. 4C, and FIG. 4D each illustrate an example of a cross section of a negative electrode active material 400.

The cross section of the negative electrode active material 400 is exposed by processing, whereby observation and analysis of the cross section can be performed.

The negative electrode active material 400 illustrated in FIG. 4A includes a region 401 and a region 402. The region 402 is positioned on an outer side of the region 401. The region 402 is preferably in contact with a surface of the region 401.

At least part of the region 402 preferably includes a surface of the negative electrode active material 400.

The region 401 is, for example, a region including an inner portion of the negative electrode active material 400.

The region 401 includes the first material 801 described above. The region 402 is a region formed using the material 802 containing halogen and the material 803 containing oxygen and carbon described above. The region 402 includes the element Z, oxygen, carbon, the metal A1, and the metal A2, for example. The element Z is, for example, fluorine, chlorine, or the like. The region 402 does not include some of elements of the element Z, oxygen, carbon, the metal A1, and the metal A2, in some cases. Alternatively, in the region 402, some of the elements of the element Z, oxygen, carbon, the metal A1, and the metal A2, has low concentration and is not detected by analysis in some cases.

The region 402 is called a surface portion of the negative electrode active material 400 or the like, in some case.

The negative electrode active material 400 can have a variety of forms such as one particle, an aggregation of a plurality of particles, and a thin film.

The region 401 may be a particle of the first material 801. Alternatively, the region 401 may be an aggregation of a plurality of particles of the first material 801. Alternatively, the region 401 may be a thin film of the first material 801.

The region 402 may be part of a particle. For example, the region 402 may be a surface portion of the particle. Alternatively, the region 402 may be part of a thin film. For example, the region 402 may be an upper layer portion of a thin film.

The region 402 may be a coating layer formed on the surface of the particle.

The region 402 may be a region including a bond of a constituent element of the first material 801 and the element Z. For example, in the region 402 or the interface between the region 401 and the region 402, the surface of the first material 801 may be modified with the element Z or a functional group including the element Z. Thus, in the negative electrode active material of one embodiment of the present invention, the bond of a constituent element of the first material 801 and the element Z is observed in some cases. For example, in the case where the first material 801 is graphite and the element Z is fluorine, a C—F bond is, for example, observed in some cases. As another example, in the case where the first material 801 contains silicon and the element Z is fluorine, a Si—F bond is, for example, observed in some cases.

For example, in the case where graphite is used as the first material 801, the region 401 is a particle of graphite, and the region 402 is a coating layer of the graphite particle. As another example, in the case where graphite is used for the first material 801, the region 401 is a region including an inner portion of a graphite particle, and the region 402 is a surface portion of the graphite particle.

The region 402 includes, for example, a bond of the element Z and carbon. The region 402 includes, for example, a bond of the element Z and the metal A1. The region 402 includes, for example, a carbonate group.

When the negative electrode active material 400 is analyzed by X-ray photoelectron spectroscopy (XPS), the element Z is preferably detected, in which case the concentration of the detected element Z is preferably higher than or equal to 1 atomic %. In this case, the concentration of the element Z can be calculated on the assumption that the total of concentrations of carbon, oxygen, the metal A1, the metal A2, and the element Z is 100%, for example. Alternatively, the calculation may be performed on the assumption that the value obtained by adding the nitrogen concentration to the concentrations of the above elements is set as 100%. The concentration of the element Z is, for example, lower than or equal to 60 atomic %, or for example, lower than or equal to 30 atomic %.

When the negative electrode active material 400 is analyzed by XPS, a peak attributed to the bond of the element Z and carbon is preferably detected. A peak attributed to the bond of the element Z and the metal A1 may be detected.

In the case where the element Z is fluorine and the metal A1 is lithium, in the F1s spectrum by XPS, a peak indicating the carbon-fluorine bond (hereinafter, a peak F2) is observed in the vicinity of 688 eV (e.g., its peak position is observed in a range of energy higher than 686.5 eV and lower than 689.5 eV), and a peak indicating the lithium-fluorine bond (hereinafter, a peak F1) is observed in the vicinity of 685 eV (e.g., its peak position is observed in an energy range higher than 683.5 eV and lower than 686.5 eV). The intensity of the peak F2 is preferably higher than a value that is 0.1 times of the intensity of peak F1 and lower than a value that is 10 times of the intensity of the peak F1. For example, the intensity of the peak F2 is higher than or equal to 0.3 times and lower than or equal to 3 times of the intensity of the peak F1.

When the negative electrode active material 400 is analyzed by XPS, a peak corresponding to carbonate or a carbonate group is preferably observed. In the C1s spectrum by XPS, the peak corresponding to carbonate or a carbonate group is observed in the vicinity of 290 eV (e.g., its peak position is observed in an energy range higher than 288.5 eV and lower than 291.5 eV).

In the example illustrated in FIG. 4B, the region 401 includes a region not covered with the region 402. In the example illustrated in FIG. 4C, the region 402 covering a region depressed at the surface of the region 401 has a large thickness.

In the negative electrode active material 400 illustrated in FIG. 4D, the region 401 includes a region 401a and a region 401b. The region 401a is a region including the inner portion of the region 401, and the region 401b is positioned on an outer side of the region 401a. In addition, the region 401b is preferably in contact with the region 402.

The region 401b is a surface portion of the region 401.

The region 401b includes one or more elements of the element Z, oxygen, carbon, the metal A1, and the metal A2 included in the region 402. In the region 401b, the elements included in the region 402, such as the element Z, oxygen, carbon, the metal A1, and the metal A2, may have a concentration gradient such that the element concentration decreases gradually from the surface or the vicinity of the surface to the inner portion.

The concentration of the element Z included in the region 401b is higher than that of the element Z included in the region 401a. The concentration of the element Z included in the region 401b is preferably lower than that of the element Z included in the region 402.

The concentration of oxygen included in the region 401b is higher than that of oxygen included in the region 401a in some cases. The concentration of oxygen included in the region 401b is lower than that of oxygen included in the region 402 in some cases.

When the negative electrode active material of one embodiment of the present invention is measured by energy dispersive X-ray spectroscopy using a scanning electron microscope, it is preferable that the element Z be detected. For example, the concentration of the element Z is preferably higher than or equal to 10 atomic % and lower than or equal to 70 atomic % on the assumption that the total of the concentrations of the element Z and oxygen is 100 atomic %.

The region 402 has a region whose thickness is smaller than or equal to 50 nm, preferably larger than or equal to 1 nm and smaller than or equal to 35 nm, further preferably, larger than or equal to 5 nm and smaller than or equal to 20 nm, for example.

The region 401b has a region whose thickness is smaller than or equal to 50 nm, preferably larger than or equal to 1 nm and smaller than or equal to 35 nm, further preferably, larger than or equal to 5 nm and smaller than or equal to 20 nm, for example.

In the case where fluorine is used as the element Z and lithium is used as the metal A1 and the metal A2, the region 402 may include a region covered with a region including lithium fluoride and a region covered with a region including lithium carbonate, with respect to the region 401. The region 402 does not obstruct the insertion and extraction of lithium and accordingly enables an excellent secondary battery to be achieved without a degradation output characteristics or the like of the secondary battery.

<Graphite Modified with Fluorine>

For the structure in which graphite is modified with fluorine, the stabilization energy was calculated with first-principles calculation.

A first principle electronic state calculation package, VASP (Vienna ab initio Simulation Package), was used for the atomic relaxation calculation. As a functional, GGA+U (DFT-D2) was used, and as a pseudopotential, PAW was used. The cut-off energy was set to 600 eV. As the number of atoms, 144 C (carbon) atoms, 32 H (hydrogen) atoms, 32 F (fluorine) atoms, and 24 Li (lithium) atoms were used in total. K-points were set to 1×1×1. In the calculation, the lattice and atom sites were optimized with constant volume conditions.

The stabilization energy ΔE represented by the following formula was calculated.

ΔE={Eₜₒₜₐₗ(C₁₄₄H₃₂₋ₓFₓLi_{y})+xEₜₒₜₐₗ(H)+(32−x)Eₜₒₜₐₗ(F)+(24−y)Eₜₒₜₐₗ(Li)}−{Eₜₒₜₐₗ(C₁₄₄H₃₂)+32Eₜₒₜₐₗ(F)+24Eₜₒₜₐₗ(Li)} [Formula 1]

In the above formula, Eₜₒₜₐₗ(C₁₄₄H₃₂₋ₓFₓLi_{y}) is the energy of a model where F atoms are substituted and Li atoms are introduced into graphite; Eₜₒₜₐₗ(H) is the energy of one H atom; Eₜₒₜₐₗ(F) is the energy of one F atom; Eₜₒₜₐₗ(Li) is the energy of one Li atom; and Eₜₒₜₐₗ(C₁₄₄H₃₂) is the energy of graphite. Note that x represents the number of replaced atoms in the graphite, i.e., x H atoms are replaced by F atoms, and y represents the number of Li atoms introduced into graphite.

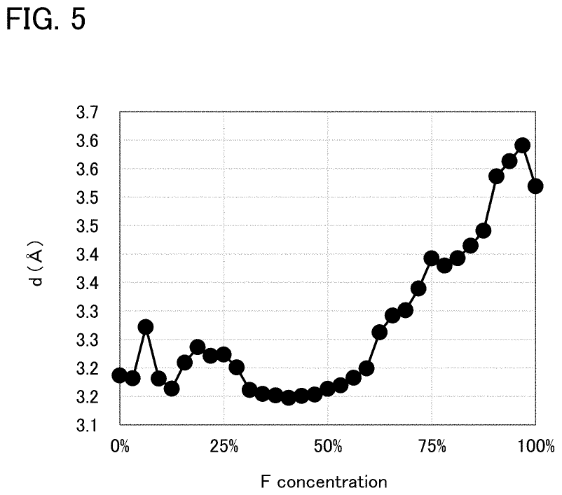

FIG. 5 shows interplanar spacing d of graphite when the number of substituted F atoms is changed. Note that the introduction of Li atoms is not performed.

The horizontal axis of FIG. 5 shows the F concentration. When the concentration is 50%, 16 H atoms are replaced by F atoms, and when the concentration is 100%, 32 H atoms, that is, all H atoms are replaced by F atoms.

When the F concentration was increased up to 50%, the tendency of stable interplanr spacing d was observed. Meanwhile, when the F concentration exceeds 50%, the interplanr spacing d increases, which suggests that the crystal structure become unstable. It is considered that the density of introduced F atoms is high and the F atoms repel each other, resulting in the unstable structure.

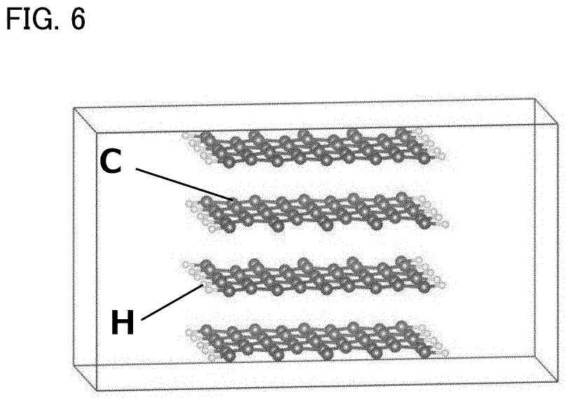

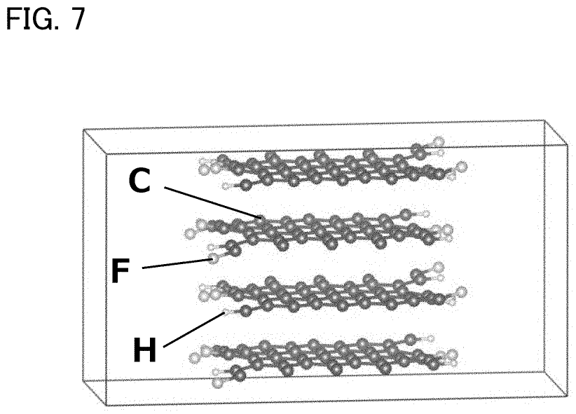

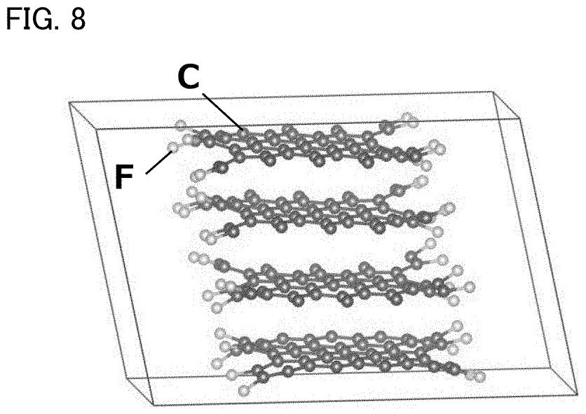

FIG. 6 shows a structure of graphite obtained by calculation when the F concentration is 0%. FIG. 7 shows a structure of graphite obtained by calculation when the F concentration is 50% %. FIG. 8 shows a structure of graphite obtained by calculation when the F concentration is 100% %. An F atom is replaced by an H atom at an edge of the graphite. As the F concentration increases, the distortion of graphene layers of the graphite is observed, and repelling F atoms each other is observed.

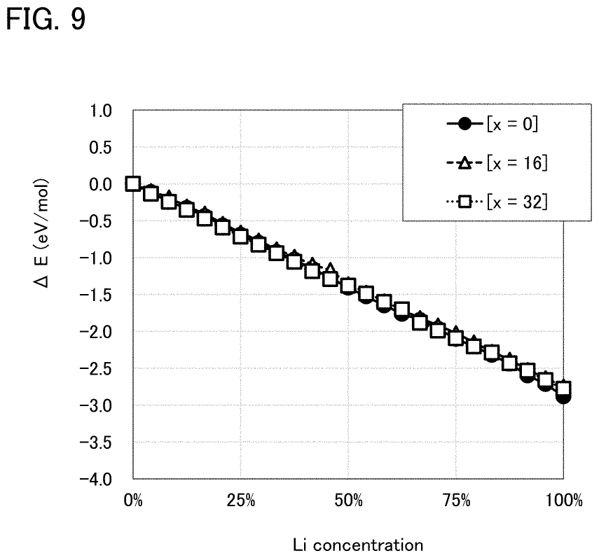

FIG. 9 shows a change in the stabilization energy ΔE when Li atoms are introduced at F concentrations of 0%, 50%, and 100%.

As the Li concentration increases, the stabilization energy ΔE significantly decreases, which suggests that the graphite structure be more stable.

The fluorine modification of graphite suggested that the crystal structure be less likely to be affected as long as the fluorine is appropriately performed, resulting in the crystallinity being kept favorably.

This embodiment can be implemented in appropriate combination with any of the other embodiments.

### Embodiment 2

In this embodiment, a positive electrode active material of one embodiment of the present invention is described.

Examples of a positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As the positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

Another example of the positive electrode active material is a lithium-manganese composite oxide represented by a composition formula LiₐMn_{b}M_{c}O_{d}. Here, the element M is preferably silicon, phosphorus, or a metal element other than lithium and manganese, and further preferably nickel. When the whole particle of a lithium-manganese composite oxide is measured, it is preferable to satisfy 0<a/(b+c)<2; c>0; and 0.26≤(b+c)/d<0.5 at the time of discharging. Note that the proportion of metals, silicon, phosphorus, or the like in the whole particle of a lithium-manganese composite oxide can be measured with, for example, an ICP-MS (inductively coupled plasma-mass spectrometer). The proportion of oxygen in the whole particle of a lithium-manganese composite oxide can be measured by, for example, energy dispersive X-ray spectroscopy (EDX). Alternatively, the proportion can be measured by ICP-MS combined with fusion gas analysis and valence evaluation of XAFS (X-ray absorption fine structure) analysis. Note that a lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Example of Manufacturing Method of Cobalt-Containing Material>

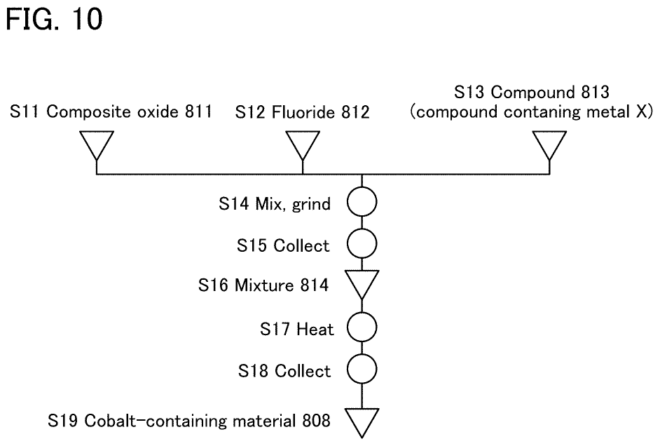

Next, an example of a manufacturing method for LiMO₂ of one embodiment of a material that can be used as the positive electrode active material is described with reference to FIG. 10. For example, at least one of manganese, cobalt, and nickel can be used as a metal M. The metal M can contain a metal X in addition to the metals given above. There is no particular limitation on the substitution site of the metal M. A cobalt-containing material in which the metal X is Mg is described as an example below. Note that the positive electrode active material of one embodiment of the present invention has a crystal structure of a lithium composite oxide represented by LiMO₂, but the composition is not limited to Li:M:O=1:1:2.

First, in Step S11, a composite oxide containing lithium, a transition metal, and oxygen is used as a composite oxide 811. Here, one or more transition metals including cobalt are preferably used.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. Aluminum may be used in addition to these transition metals. That is, as the transition metal source, only a cobalt source may be used; only a nickel source may be used; two types of cobalt and manganese sources or two types of cobalt and nickel sources may be used; or three types of cobalt, manganese, and nickel sources may be used. Furthermore, an aluminum source may be used in addition to these metal sources. The heating temperature at this time is preferably higher than the temperature in Step S17 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen, the cobalt-containing material, and the positive electrode active material, and elements other than the main components are regarded as impurities. For example, when analyzed with a glow discharge mass spectroscopy method (GD-MS), the total impurity concentration is preferably less than or equal to 10,000 ppmw (parts per million weight), further preferably less than or equal to 5000 ppmw. In particular, the total impurity concentration of transition metals such as titanium and arsenic is preferably 3000 ppmw or less, further preferably 1500 ppmw or less.

For example, as the lithium cobalt oxide synthesized in advance, lithium cobalt oxide particles (product name: CELLSEED C-10N) formed by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method, the magnesium concentration and the fluorine concentration are less than or equal to 50 ppmw, the calcium concentration, the aluminum concentration, and the silicon concentration are less than or equal to 100 ppmw, the nickel concentration is less than or equal to 150 ppmw, the sulfur concentration is less than or equal to 500 ppmw, the arsenic concentration is less than or equal to 1100 ppmw, and the concentrations of elements other than lithium, cobalt, and oxygen are less than or equal to 150 ppmw.

A composite oxide 811 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large amount of impurities, the crystal structure is highly likely to have a large number of defects or distortions.

Furthermore, a fluoride 812 is prepared in Step S12. As the fluoride 812, lithium fluoride (LiF), magnesium fluoride (MgF₂), aluminum fluoride (A₁F₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride (MnF₂), iron fluoride (FeF₃), chromium fluoride (CrF₃), niobium fluoride (NbF₅), zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃A₁F₆), or the like can be used. As the fluoride 812, any material that functions as a fluorine source can be used. Thus, in place of the fluoride 812 or as part thereof, fluorine (F₂), carbon fluoride (CF₄), sulfur fluoride (SF₂, SF₄, SF₆, or S₂F₁₀), oxygen fluoride (OF₂, O₂F₂, O₃F₂, O₄F₂, or O₂F), or the like may be used and mixed in an atmosphere.

In the case where a compound containing the metal X is used as the fluoride 812, a compound 813 (compound containing the metal X) described later can also serve as the fluoride 812.

In this embodiment, lithium fluoride (LiF) is prepared as the fluoride 812. LiF is preferable because it has a cation common with LiCoO₂. LiF, which has a relatively low melting point of 848° C., is preferable because it is easily melted in a heating step described later.

In the case where LiF is used as the fluoride 812, the compound 813 (compound containing the metal X) is preferably prepared in addition to the fluoride 812 in Step S13. The compound 813 is the compound containing the metal X. In Step S13, the compound 813 is prepared. As the compound 813, a fluoride, an oxide, a hydroxide, or the like of the metal X can be used, and in particular, a fluoride is preferably used.

In the case where magnesium is used as the metal X, MgF₂ or the like can be used as the compound 813. Magnesium can be distributed at a high concentration in the vicinity of the surface of the cobalt-containing material.

A material containing a metal that is neither cobalt nor the metal X in addition to the fluoride 812 and the compound 813 may be mixed. As the material containing a metal that is neither cobalt nor the metal X, at least one of a nickel source, a manganese source, an aluminum source, an iron source, a vanadium source, a chromium source, a niobium source, a titanium source, and the like can be mixed, for example. For example, a hydroxide, a fluoride, an oxide, or the like of each metal is preferably pulverized and mixed. The pulverization can be performed by wet method, for example.

The sequence of Step S11, Step S12, and Step S13 may be freely determined.

Next, in Step S14, the materials prepared in Step S11, Step S12, and Step S13 are mixed and ground. Although the mixing can be performed by a dry method or a wet method, the wet method is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When a ball mill is used, zirconia balls are preferably used as media, for example. The mixing and grinding steps are preferably performed sufficiently to pulverize a mixture 814.

The materials mixed and ground in the above manner are collected in Step S15, whereby the mixture 814 is obtained in Step S16.

For example, the D50 of the mixture 814 is preferably greater than or equal to 600 nm and less than or equal to 20 μm, further preferably greater than or equal to 1 μm and less than or equal to 10 μm.

The heating temperature is further preferably higher than or equal to the temperature at which the mixture 814 melts. The heating temperature is preferably lower than or equal to a decomposition temperature of LiCoO₂ (1130° C.).

LiF is used as the fluoride 812 and the heating in S17 is conducted with the lid put on, whereby a cobalt-containing material 808 with favorable cycle performance and the like can be manufactured. It is considered that when LiF and MgF₂ are used as the fluoride 812, the reaction with LiCoO₂ is promoted with the heating temperature in Step S17 set to higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the heating temperature is preferably higher than or equal to 742° C., further preferably higher than or equal to 820° C.

Accordingly, the heating temperature is preferably higher than or equal to 742° C. and lower than or equal to 1130° C., further preferably higher than or equal to 742° C. and lower than or equal to 1000° C. Moreover, the heating temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 814 inhibits production of LiMO₂. Therefore, heating needs to be performed while volatilization of LiF is inhibited.

Thus, when the mixture 814 is heated in an atmosphere containing LiF, that is, the mixture 814 is heated in a state where the partial pressure of LiF in the heating furnace is high, volatilization of LiF in the mixture 814 is inhibited. By performing heating using the fluoride (LiF or MgF) to form an eutectic mixture with the lid put on, the heating temperature can be lowered to the decomposition temperature of the LiCoO₂ (1130° C.) or lower, specifically, a temperature higher than or equal to 742° C. and lower than or equal to 1000° C., thereby enabling the production of LiMO₂ to progress efficiently. Accordingly, the cobalt-containing material having favorable characteristics can be formed, and the annealing time can be reduced.

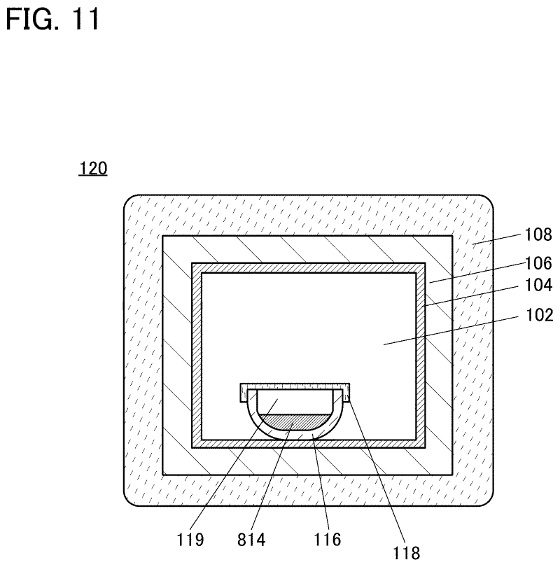

FIG. 11 illustrates an example of the heating method in S17.

A heating furnace 120 illustrated in FIG. 11 includes a space 102 in the heating furnace, a hot plate 104, a heater unit 106, and a heat insulator 108. It is further preferable to put a lid 118 on a container 116 in annealing. With this structure, an atmosphere containing a fluoride can be obtained in a space 119 enclosed by the container 116 and the lid 118. In the annealing, the state of the space 119 is maintained with the lid put on so that the concentration of the gasified fluoride inside the space 119 can be constant or cannot be reduced, in which case fluorine or magnesium can be contained in the vicinity of the particle surface. The atmosphere containing a fluoride can be provided in the space 119, which is smaller in capacity than the space 102 in the heating furnace, by volatilization of a smaller amount of a fluoride. This means that an atmosphere containing a fluoride can be provided in the reaction system without a significant reduction in the amount of a fluoride included in the mixture 814. Accordingly, LiMO₂ can be produced efficiently. In addition, the use of the lid 118 allows the heating of the mixture 814 in an atmosphere including a fluoride to be simply and inexpensively performed.

Here, the valence number of Co (cobalt) in LiMO₂ formed according to one embodiment of the present invention is preferably approximately 3. The valence number of cobalt can be 2 and 3. Thus, to inhibit reduction of cobalt, it is preferable that the atmosphere in the space 102 in the heating furnace contain oxygen, the ratio of oxygen to nitrogen in the atmosphere in the space 102 in the heating furnace be higher than or equal to that in the air atmosphere, and the oxygen concentration in the atmosphere in the space 102 in the heating furnace be higher than or equal to that in the air atmosphere. Thus, an atmosphere containing oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, a step of providing an atmosphere containing oxygen in the space 102 in the heating furnace and a step of placing the container 116 in which the mixture 814 is placed in the space 102 in the heating furnace are performed. The steps in this order enable the mixture 814 to be heated in an atmosphere containing oxygen and a fluoride. During the heating, the space 102 in the heating furnace is preferably sealed to prevent any gas from being discharged to the outside. For example, it is preferable that no gas flows during the heating.

Although there is no particular limitation on the method of providing an atmosphere containing oxygen in the space 102 in the heating furnace, given examples are a method of introducing an oxygen gas or a gas containing oxygen such as dry air after exhausting air from the space 102 in the heating furnace and a method of flowing an oxygen gas or a gas containing oxygen such as dry air into the space 102 for a certain period of time. In particular, introducing an oxygen gas after exhausting air from the space 102 in the heating furnace (oxygen displacement) is preferably performed. Note that the atmosphere of the space 102 in the heating furnace may be regarded as an atmosphere containing oxygen.

When the lid 118 is put on the container 116, an atmosphere containing oxygen is provided, and then heating is performed, an appropriate amount of oxygen enters the container 116 through a gap of the lid 118 put on the container 116 and an appropriate amount of fluoride can be kept within the container 116.

Furthermore, the fluoride or the like attached to inner walls of the container 116 and the lid 118 is likely to be fluttered again by the heating and attached to the mixture 814.

The heating in Step S17 is preferably performed at an appropriate temperature for an appropriate time. The appropriate temperature and time change depending on the conditions such as the particle size and the composition of the particle of the composite oxide 811 in Step S11. In the case where the particle size is small, the heating is preferably performed at a lower temperature or for a shorter time than the case where the particle size is large, in some cases. After the heating in S17, a step of removing the lid is performed.

For example, in the case where the average particle diameter (D50) of particles in Step S11 is approximately 12 μm, the heating time is preferably longer than or equal to 3 hours, further preferably longer than or equal to 10 hours.

By contrast, in the case where the average particle diameter (D50) of particles in Step S11 is approximately 5 μm, the heating time is preferably longer than or equal to 1 hour and shorter than or equal to 10 hours, further preferably approximately 2 hours, for example.

The temperature decreasing time after the heating is, for example, preferably longer than or equal to 10 hours and shorter than or equal to 50 hours.

Then, the materials heated in the above manner are collected in Step S18, whereby the cobalt-containing material 808 is obtained in Step S19.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. The metal M contains the metal given above. The metal M can contain the metal X given above in addition to the metal M given above.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

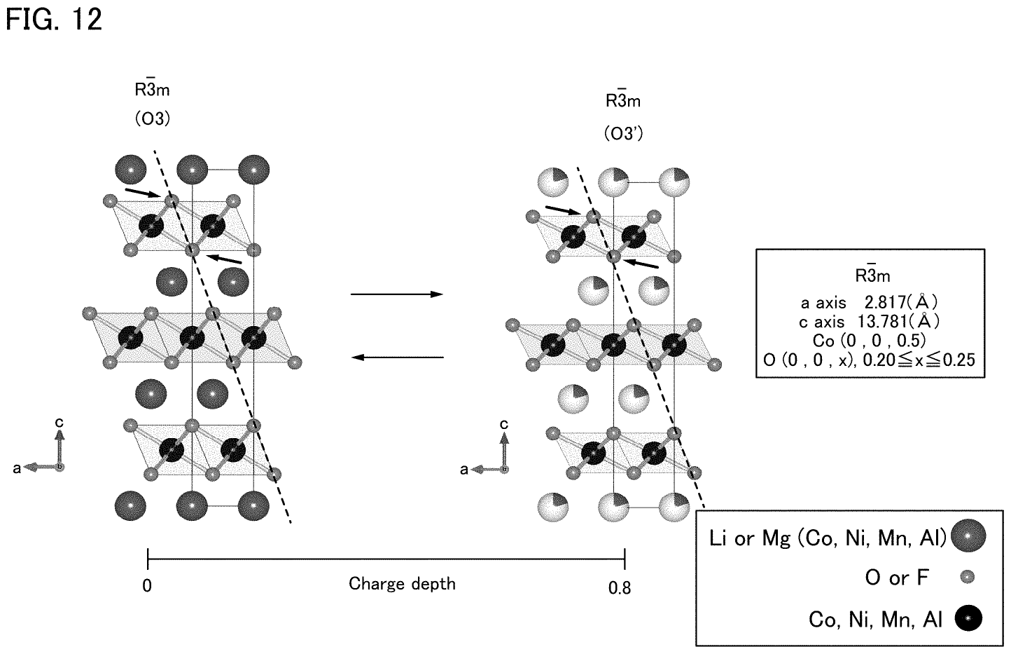

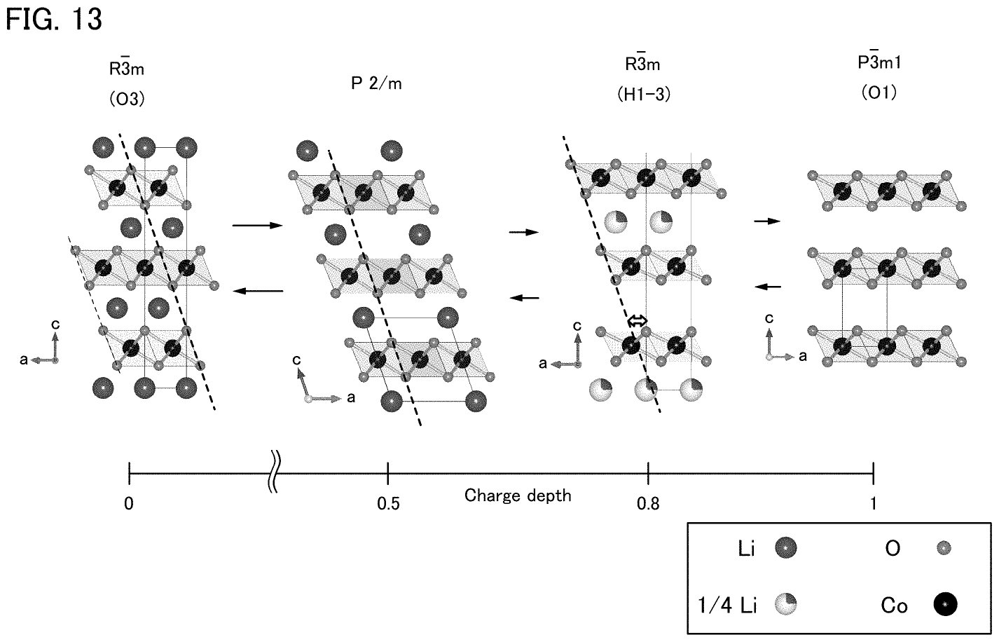

The positive electrode active material is described with reference to FIG. 12 and FIG. 13.

In the positive electrode active material formed according to one embodiment of the present invention, the difference in the positions of CoO₂ layers can be small in repeated charging and discharging at high voltage. Furthermore, the change in the volume can be small. Thus, the compound can have excellent cycle performance. In addition, the compound can have a stable crystal structure in a high-voltage charged state. Thus, in the compound, sometimes a short circuit is less likely to occur while the high-voltage charged state is maintained. This is preferable because the safety is further improved.

The compound has a small change in the crystal structure and a small difference in volume per the same number of transition metal atoms between a sufficiently discharged state and a high-voltage charged state.

The positive electrode active material of one embodiment of the present invention contains lithium, the above-described metal M, oxygen, and titanium. The positive electrode active material of one embodiment of the present invention preferably contains fluorine and halogen such as chlorine.

The positive electrode active material of one embodiment of the present invention preferably has a form of particles. In the case where the positive electrode active material of one embodiment of the present invention has a form of particles, the titanium concentration in a surface portion of a particle is higher than the titanium concentration in an inner portion thereof. The magnesium concentration in the surface portion is higher than the magnesium concentration in the inner portion. The surface portion of the positive electrode active material of one embodiment of the present invention is located less than or equal to 10 nm, less than or equal to 5 nm, or less than or equal to 3 nm from the surface toward the inner portion, and may include a first region where the magnesium concentration is particularly high. In addition, for example, the ratio of the magnesium concentration to the titanium concentration (Mg/Ti) in the first region is higher than the ratio of the magnesium concentration to the titanium concentration (Mg/Ti) in a region of the surface portion that is located inward from the first region, in some cases.

For example, the concentrations of elements such as the metal M and titanium each have a gradient in each of the regions such as the surface portion, the inner portion, and the first region of the surface portion. That is, for example, the concentration of each element does not change sharply but changes with a gradient in the boundary between the regions. Here, for the metal M, aluminum, nickel, or the like can be used in addition to cobalt and magnesium, for example. In such a case, aluminum and nickel each have, for example, a concentration gradient in each of the regions such as the surface portion, the inner portion, and the first region of the surface portion.

The positive electrode active material of one embodiment of the present invention includes the first region. In the case where the positive electrode active material of one embodiment has a form of particles, the first region preferably includes a region located inward from the surface portion. At least part of the surface portion may be included in the first region. The first region preferably exhibits a layered rock-salt crystal structure, and the region is represented by the space group R-3m. The first region is a region containing lithium, the metal M. FIG. 12 shows examples of crystal structures of the first region before and after charging and discharging. The surface portion of the positive electrode active material of one embodiment of the present invention may include a crystal containing titanium, magnesium, and oxygen and exhibiting a structure different from a layered rock-salt crystal structure in addition to or instead of the region exhibiting a layered rock-salt crystal structure described below with reference to FIG. 12 and the like. For example, the surface portion of the positive electrode active material may include a crystal containing titanium, magnesium, and oxygen and exhibiting a spinel structure.

The crystal structure with a charge depth of 0 (the discharged state) in FIG. 12 is R-3m (O3), which is the same as that in FIG. 13. Meanwhile, the first region with a charge depth in a sufficiently charged state includes a crystal whose structure is different from the H1-3 type structure. This structure belongs to the space group R-3m, and is not a spinel crystal structure but a structure in which oxygen is hexacoordinated to ions of cobalt, magnesium, or the like and the cation arrangement has symmetry similar to that of the spinel crystal structure. Furthermore, the symmetry of CoO₂ layers of this structure is the same as that in the 03 type structure. Accordingly, this structure is referred to as an O3′ type crystal structure or a pseudo-spinel crystal structure in this specification and the like. Note that although lithium exists in any of lithium sites at an approximately 20% probability in the diagram of the O3′ type crystal structure illustrated in FIG. 12, the structure is not limited thereto. Lithium may exist in only some certain lithium sites. In addition, in both the 03 type crystal structure and the O3′ type crystal structure, a slight amount of magnesium preferably exists between the CoO₂ layers, i.e., in lithium sites. In addition, a slight amount of halogen such as fluorine may exist in oxygen sites at random.

Note that in the O3′ type crystal structure, oxygen is tetracoordinated to a light element such as lithium in some cases; also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of an O3′ type crystal are also presumed to form a cubic close-packed structure. When these crystals are in contact with the layered rock-salt crystal and the rock-salt crystal, there is a crystal plane at which orientations of cubic close-packed structures composed of anions are aligned. Note that a space group of the layered rock-salt crystal and the O3′ type crystal structure is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal structure is different from that in the rock-salt crystal. In this specification, a state where the orientations of the cubic close-packed structures composed of anions in the layered rock-salt crystal, the O3′ type crystal structure, and the rock-salt crystal are aligned is sometimes referred to as a state where crystal orientations are substantially aligned.

In the first region, a change in the crystal structure when charging is performed at high voltage and a large amount of lithium is extracted is inhibited as compared with a comparative example described later. As shown by dotted lines in FIG. 12, for example, CoO₂ layers hardly deviate in the crystal structures.

More specifically, the structure of the first region is highly stable even when a charge voltage is high. For example, an H1-3 type crystal structure is formed at a voltage of approximately 4.6 V with the potential of a lithium metal as the reference in FIG. 13; however, the positive electrode active material of one embodiment of the present invention can maintain the crystal structure of R-3m (O3) even at the charge voltage of approximately 4.6 V. Even at higher charge voltages, e.g., a voltage of approximately 4.65 V to 4.7 V with the potential of a lithium metal as the reference, the positive electrode active material of one embodiment of the present invention can have the O3′ type crystal structure. At a charge voltage increased to be higher than 4.7 V, an H1-3 type crystal may be finally observed in the positive electrode active material of one embodiment of the present invention. In addition, the positive electrode active material of one embodiment of the present invention might have the O3′ type crystal structure even at a lower charge voltage (e.g., a charge voltage of greater than or equal to 4.5 V and less than 4.6 V with the potential of a lithium metal as the reference).

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery that includes graphite as a negative electrode active material and has a voltage of greater than or equal to 4.3 V and less than or equal to 4.5 V, for example, the positive electrode active material of one embodiment of the present invention can maintain the crystal structure of R-3m (O3) and moreover, includes a region that can have the O3′ type crystal structure at higher voltages, e.g., a voltage of the secondary battery exceeding 4.5 V and less than or equal to 4.6 V. In addition, the positive electrode active material of one embodiment of the present invention can have the O3′ type crystal structure at lower charge voltages, e.g., at a voltage of the secondary battery greater than or equal to 4.2 V and less than 4.3 V, in some cases.

Thus, in the first region, the crystal structure is less likely to be broken even when charging and discharging are repeated at high voltage.

In addition, in the positive electrode active material of one embodiment of the present invention, a difference in the volume per unit cell between the 03 type crystal structure with a charge depth of 0 and the O3′ type crystal structure with a charge depth of 0.8 is less than or equal to 2.5%, specifically, less than or equal to 2.2%.

In the unit cell of the O3′ type crystal structure, the coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high, so that magnesium is highly likely to enter the cobalt sites. Magnesium in the cobalt sites is less effective in maintaining the R-3m structure in high-voltage charging in some cases. Furthermore, heat treatment at an excessively high temperature might have an adverse effect; for example, cobalt might be reduced to have a valence of two or lithium might be evaporated.

In view of the above, a halogen compound such as fluoride is preferably added to lithium cobalt oxide before the heat treatment for distributing magnesium over whole particles. The addition of the halogen compound depresses the melting point of lithium cobalt oxide. The decreased melting point makes it easier to distribute magnesium throughout the particle at a temperature at which the cation mixing is unlikely to occur. Furthermore, it is expected that the existence of the fluorine compound can improve corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material formed by one embodiment of the present invention is preferably 0.001 times or more and 0.1 times or less, further preferably more than 0.01 times and less than 0.04 times, still further preferably approximately 0.02 times as large as the number of cobalt atoms. The magnesium concentration described here may be a value obtained by element analysis on the whole particles of the positive electrode active material using ICP-MS or the like, or may be a value based on the ratio of the raw materials mixed in the process of forming the positive electrode active material, for example.

The number of nickel atoms in the positive electrode active material of one embodiment of the present invention is preferably 7.5% or lower, preferably 0.05% or higher and 4% or lower, further preferably 0.1% or higher and 2% or lower of the number of cobalt atoms. The nickel concentration described here may be a value obtained by element analysis on the entire particle of the positive electrode active material using ICP-MS or the like, or may be a value based on the ratio of the raw materials mixed in the forming process of the positive electrode active material, for example.

### <Particle Diameter>

A too large particle diameter of the positive electrode active material of one embodiment of the present invention causes problems such as difficulty in lithium diffusion and too much surface roughness of an active material layer in coating to a current collector. By contrast, too small a particle diameter causes problems such as difficulty in loading of the active material layer at the time when the material is applied to the current collector and overreaction with the electrolyte solution. Therefore, the average particle diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described above, the positive electrode active material of one embodiment of the present invention features in a small change in the crystal structure between a high voltage charged state and a discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. For example, although the positive electrode active material that is lithium cobalt oxide containing magnesium and fluorine is a commonality, the positive electrode active material has 60 wt % or more of the O3′ type crystal structure in some cases, and has 50 wt % or more of the H1-3 type crystal structure in other cases, when charged with a high voltage. Furthermore, at a predetermined voltage, the positive electrode active material has almost 100 wt % of the O3′ type crystal structure, and with an increase in the predetermined voltage, the H1-3 type crystal structure is generated in some cases. Thus, the crystal structure of the positive electrode active material of one embodiment of the present invention is preferably analyzed by XRD or the like. The combination of the analysis methods and measurement such as XRD enables more detailed analysis.

Note that a positive electrode active material in the high-voltage charged state or the discharged state sometimes causes a change in the crystal structure when exposed to air. For example, the O3′ type crystal structure changes into the H1-3 type crystal structure in some cases. Thus, all samples are preferably handled in an inert atmosphere such as an atmosphere containing argon.

A positive electrode active material illustrated in FIG. 13 is lithium cobalt oxide (LiCoO₂) to which the metal X is not added. The crystal structure of the lithium cobalt oxide illustrated in FIG. 13 is changed depending on a charge depth.

As illustrated in FIG. 13, lithium cobalt oxide with a charge depth of 0 (the discharged state) includes a region having the crystal structure of the space group R-3m, and includes three CoO₂ layers in a unit cell. Thus, this crystal structure is referred to as an O3 type crystal structure in some cases. Note that, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3ml and includes one CoO₂ layer in a unit cell. Hence, this crystal structure is referred to as an O1 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3ml (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 13, the c-axis of the H1-3 type crystal structure is described half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. Meanwhile, the O3′ type crystal structure of one embodiment of the present invention is preferably represented by a unit cell including one cobalt and one oxygen. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (good of fitness) is smaller in the Rietveld analysis of XRD, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in a discharged state.

However, there is a large deviation in the position of the CoO₂ layer between these two crystal structures. As indicated by the dotted lines and the arrows in FIG. 13, the CoO₂ layer in the H1-3 type crystal structure greatly shifts from that in R-3m (O3). Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3ml (O1), included in the H1-3 type crystal structure is highly likely to be unstable.

Thus, the repeated high-voltage charging and discharging break the crystal structure of lithium cobalt oxide. The break of the crystal structure degrades the cycle performance. This is probably because the break of the crystal structure reduces sites where lithium can stably exist and makes it difficult to insert and extract lithium.

This embodiment can be implemented in appropriate combination with any of the other embodiments.

### Embodiment 3

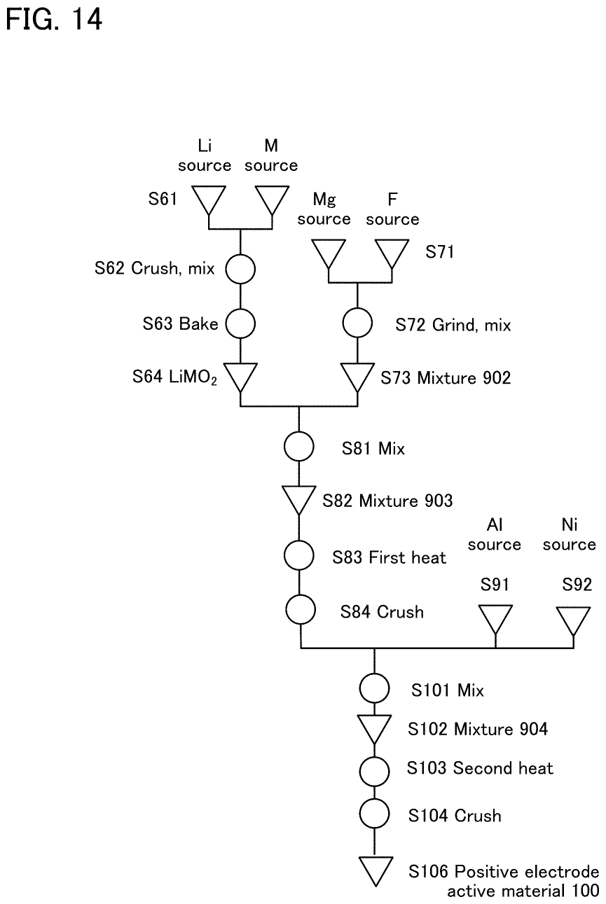

In this embodiment, an example of a method of forming a positive electrode active material of one embodiment of the present invention will be described with reference to FIG. 14.

### <Step S61>

First, in Step S61 in FIG. 14, a lithium source and a transition metal M source are prepared as materials of a composite oxide (LiMO₂) containing lithium, the transition metal M, and oxygen.

As the lithium source, for example, lithium carbonate, lithium hydroxide, lithium nitrate, or lithium fluoride can be used.

As the transition metal M, a metal that can form, together with lithium, a composite oxide having the layered rock-salt structure belonging to the space group R-3m is preferably used. For example, at least one of manganese, cobalt, and nickel can be used. That is, as the transition metal M source, only cobalt may be used; only nickel may be used; two types of metals of cobalt and manganese or cobalt and nickel may be used; or three types of metals of cobalt, manganese, and nickel may be used.

When metals that can form a layered rock-salt composite oxide are used, cobalt, manganese, and nickel are preferably mixed at the ratio at which the composite oxide can have a layered rock-salt crystal structure. In addition, aluminum may be added to the transition metal as long as the composite oxide can have a layered rock-salt crystal structure.

As the transition metal M source, an oxide or a hydroxide of the metal described as an example of the transition metal M, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S62>

Next, in Step S62, the lithium source and the transition metal M source are mixed. The mixing can be performed by a dry method or a wet method. For example, a ball mill, a bead mill, or the like can be used for the mixing. When the ball mill is used, a zirconia ball is preferably used as grinding media, for example.

### <Step S63>

Next, in Step S63, the materials mixed in the above manner are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Alternatively, the heating is preferably performed at higher than or equal to 800° C. and lower than or equal to 1000° C. Alternatively, the heating is preferably performed at higher than or equal to 900° C. and lower than or equal to 1100° C. An excessively low temperature might lead to insufficient decomposition and melting of the lithium source and the transition metal M source. An excessively high temperature, on the other hand, might cause a defect due to excessive reduction of the metal taking part in an oxidation-reduction reaction and used as the transition metal M, evaporation of lithium, or the like. The use of cobalt as the transition metal M, for example, may lead to a defect in which cobalt has divalence.

The heating time can be longer than or equal to 1 hour and shorter than or equal to 100 hours, for example, and is preferably longer than or equal to 2 hours and shorter than or equal to 20 hours. Alternatively, the heating time is preferably longer than or equal to 1 hour and shorter than or equal to 20 hours. Alternatively, the heating time is preferably longer than or equal to 2 hours and shorter than or equal to 100 hours. Baking is preferably performed in an atmosphere with few moisture, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature (25° C.). The temperature decreasing time from the specified temperature to room temperature is preferably longer than or equal to 10 hours and shorter than or equal to 50 hours, for example.

Note that the cooling to room temperature in Step S63 is not essential. As long as later steps of Step S81 to Step S83 are performed without problems, the cooling may be performed to a temperature higher than room temperature.

### <Step S64>

Next, in Step S64, the materials baked in the above manner are collected, whereby the composite oxide (LiMO₂) containing lithium, the transition metal M, and oxygen is obtained. Specifically, lithium cobalt oxide, lithium manganese oxide, lithium nickel oxide, lithium cobalt oxide in which manganese is substituted for part of cobalt, lithium cobalt oxide in which nickel is substituted for part of cobalt, lithium nickel-manganese-cobalt oxide, or the like is obtained.

Alternatively, a composite oxide containing lithium, the transition metal M, and oxygen that is synthesized in advance may be used in Step S64. In that case, Step S61 to Step S63 can be omitted.

For example, as a composite oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the average particle diameter (D50) is approximately 6.5 μm, and the concentrations of elements other than lithium, cobalt, and oxygen are approximately equal to or less than those of C-10N in the impurity analysis by GD-MS.

In this embodiment, cobalt is used as the metal M, and the lithium cobalt oxide particle synthesized in advance (Cellseed C-10N produced by NIPPON CHEMICAL INDUSTRIAL CO., LTD.) is used.

### <Step S71>

Next, in Step S71, a halogen source such as a fluorine source or a chlorine source and a magnesium source are prepared as materials of a mixture 902. In addition, a lithium source is preferably prepared as well.

As the fluorine source, for example, lithium fluoride (LiF), magnesium fluoride (MgF₂), aluminum fluoride (AlF₃), titanium fluoride (TiF₄ and TiF₃), cobalt fluoride (CoF₂ and CoF₃), nickel fluoride (NiF₂), zirconium fluoride (ZrF₄), vanadium fluoride (VF₅), manganese fluoride (MnF₂ and MnF₃), iron fluoride (FeF₂ and FeF₃), chromium fluoride (CrF₂ and CrF₃), niobium fluoride (NbF₅), zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), or sodium aluminum hexafluoride (Na₃A₁F₆) can be used. A plurality of fluorine sources may be mixed to be used. Among them, lithium fluoride, which has a relatively low melting point of 848° C., is preferable because it is easily melted in a heating step described later.

As the chlorine source, for example, lithium chloride or magnesium chloride can be used.

As the magnesium source, for example, magnesium fluoride, magnesium oxide, magnesium hydroxide, magnesium carbonate, or the like can be used.

As the lithium source, for example, lithium fluoride and lithium carbonate can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a molar ratio of approximately LiF:MgF₂=65:35, the effect of lowering the melting point becomes the highest. On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

In addition, in the case where the following mixing and grinding steps are performed by a wet method, a solvent is prepared. As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetone is used.

### <Step S72>

Next, in Step S72, the materials of the mixture 902 are ground and mixed. Although the mixing can be performed by a dry method or a wet method, the wet method is preferable because the materials can be ground to a smaller size. For example, a ball mill, a bead mill, or the like can be used for the mixing. When the ball mill is used, a zirconia ball is preferably used as grinding media, for example. The mixing step and the grinding step are preferably performed sufficiently to pulverize the mixture 902.

### <Step S73>

Next, in Step S73, the materials mixed and ground in the above manner are collected, whereby the mixture 902 is obtained.

For example, the mixture 902 preferably has a D50 (median diameter) of greater than or equal to 600 nm and less than or equal to 20 μm, further preferably greater than or equal to 1 μm and less than or equal to 10 μm. Alternatively, the D50 is preferably greater than or equal to 600 nm and less than or equal to 10 μm. Alternatively, the D50 is preferably greater than or equal to 1 μm and less than or equal to 20 μm. When mixed with a composite oxide containing lithium, the transition metal M, and oxygen in the later step, the mixture 902 pulverized to such a small size is likely to exist on surfaces of composite oxide particles uniformly.

### <Step S81>

Next, in Step S81, LiMO₂ obtained in Step S64 and the mixture 902 are mixed. The atomic ratio of the transition metal M in the composite oxide containing lithium, the transition metal, and oxygen to magnesium Mg in the mixture 902 (M:Mg) is preferably 100:y (0.1≤y≤6), further preferably 100:y (0.3≤y≤3).

The conditions of the mixing in Step S81 are preferably milder than those of the mixing in Step S62 in order not to damage the particles of the composite oxide. For example, conditions with a lower rotation frequency or shorter time than the mixing in Step S62 are preferable. In addition, it can be said that conditions of the dry method are less likely to break the particles than those of the wet method. For example, a ball mill, a bead mill, or the like can be used for the mixing. When the ball mill is used, a zirconia ball is preferably used as grinding media, for example.

### <Step S82>

Next, in Step S82, the materials mixed in the above manner are collected, whereby a mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through baking after addition of a magnesium source, a fluorine source, and the like to the starting material of lithium cobalt oxide may be used instead of the mixture 903 in Step S82. In that case, there is no need to separate steps of Step S61 to Step S64 and steps of Step S71 to Step S73, which is simple and productive.

Alternatively, lithium cobalt oxide to which magnesium and fluorine are added in advance may be used. When lithium cobalt oxide to which magnesium and fluorine are added is used, the process can be simpler because steps up to Step S82 can be omitted.

In addition, a magnesium source and a fluorine source may be further added to the lithium cobalt oxide to which magnesium and fluorine are added in advance.

### <Step S83>

Next, in Step S83, the mixture 903 is heated in an atmosphere containing oxygen. This step is referred to as first heating (first temperature condition) to be distinguish from the other heating step, in some cases. The heating further preferably has the adhesion preventing effect to prevent particles of the mixture 903 from adhering to one another.

Examples of the heating having the adhesion preventing effect are heating while the mixture 903 is being stirred and heating while a container containing the mixture 903 is being vibrated.

The heating temperature in Step S83 needs to be higher than or equal to the temperature at which a reaction between LiMO₂ and the mixture 902 proceeds. Here, the temperature at which the reaction proceeds is a temperature at which interdiffusion between elements included in LiMO₂ and the mixture 902 occurs. Thus, the heating temperature may be lower than the melting temperatures of these materials. For example, in salts and an oxide, solid-phase diffusion occurs at a temperature that is 0.757 times (Tamman temperature TO the melting temperature T.

A temperature higher than or equal to the temperature at which at least part of the mixture 903 is melted is preferable because the reaction proceeds more easily. Accordingly, the heating temperature is preferably higher than or equal to the eutectic point of the mixture 902. In the case where the mixture 902 includes LiF and MgF₂, the temperature in Step S83 is preferably set to higher than or equal to 742° C. that is the eutectic point.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the heating temperature is further preferably higher than or equal to 830° C. The mixture 903 includes at least fluorine, lithium, cobalt, and magnesium. The mixture 903 has the O3′ type crystal structure.

A higher heating temperature is preferable because it facilitates the reaction, shortens the heating time, and enables high productivity.

Note that the heating temperature needs to be lower than or equal to a decomposition temperature of LiMO₂ (1130° C. in the case of LiCoO₂). At around the decomposition temperature, a slight amount of LiMO₂ might be decomposed. Thus, the heating temperature is preferably lower than or equal to 1130° C., further preferably lower than or equal to 1000° C., further preferably lower than or equal to 950° C., and further preferably lower than or equal to 900° C.

In view of the above, the heating temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the formation method described in this embodiment, some of the materials, e.g., LiF as the fluorine source, function as flux. Owing to this function, the heating temperature can be lower than or equal to the decomposition temperature of LiMO₂, e.g., a temperature higher than or equal to 742° C. and lower than or equal to 950° C., which allows distribution of the additive such as magnesium in the surface portion more densely than in the core portion and formation of the positive electrode active material having favorable performance.

However, LiF is lighter than an oxygen molecule and thus volatilized and dissipated by the heating. In that case, the amount of LiF in the mixture 903 is reduced, and the function as flux is lowered. Therefore, heating needs to be performed while volatilization of LiF is inhibited. Note that even when LiF is not used as the fluorine source or the like, there is a possibility in that Li and F at a surface of LiMO₂ react with each other to generate LiF and vaporize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating is preferably performed for an appropriate time. The appropriate heating time is changed depending on conditions, such as the heating temperature, and the particle size and composition of LiMO₂ in Step S64. In the case where the particle size is small, the heating is preferably performed at a lower temperature or for a shorter time than the case where the particle size is large, in some cases.

When the average particle diameter (D50) of the particles in Step S64 is approximately 12 μm, for example, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example.

On the other hand, when the average particle diameter (D50) of the particles in Step S73 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example.

The temperature decreasing time after the heating is, for example, preferably longer than or equal to 10 hours and shorter than or equal to 50 hours.

### <Step S84>

In Step S84, crushing is performed, and mixing is performed as necessary. After the mixing, it is preferable that powder be collected and sifted.

### <Step S91>

Next, in Step S91, an additive source is prepared. As the additive, one or more selected from nickel, aluminum, manganese, titanium, zirconium, vanadium, iron, chromium, niobium, cobalt, arsenic, zinc, silicon, sulfur, phosphorus, and boron can be used, for example. In Step S91, an example of using an aluminum source as the additive source is described.

As a mixing method of the additives, a solid phase method, a sol-gel method, a sputtering method, a mechanochemical method, a CVD method, or the like can be used, for example. A combination of a plurality of methods may be used.

### <Step S92>

Next, an additive source is prepared in Step S92. As the additive, one or more selected from nickel, aluminum, manganese, titanium, zirconium, vanadium, iron, chromium, niobium, cobalt, arsenic, zinc, silicon, sulfur, phosphorus, and boron can be used, for example. In Step S92, an example of using a nickel source as the additive source is described.

As a mixing method of the additives, a solid phase method, a sol-gel method, a sputtering method, a mechanochemical method, a CVD method, or the like can be used, for example. A combination of a plurality of methods may be used.

### <Step S101>

Next, the heated mixture 903 and the additive source are mixed in Step S101. In other words, the additive is attached and included to/in the surface of the heated mixture 903.

As a mixing method, a solid phase method, a sol-gel method, a sputtering method, a mechanochemical method, a CVD method, a spray drying method, or the like can be used, for example. The solid phase method and the sol-gel method are preferable because these methods enable the additive to be attached and included to/in the surface of the heated mixture 903 easily at the atmospheric pressure and room temperature.

After the above process, precipitate is collected from the mixed solution. As the collection method, filtration, centrifugation, evaporation to dryness, a spray drying method, and the like can be used. In this embodiment, evaporation to dryness is used. In this embodiment, circulation drying at 95° C. is performed.

### <Step S102>

Next, in Step S102, the materials dried in the above manner are collected, whereby a mixture 904 is obtained.

### <Step S103>

Next, the mixture 904 synthesized in Step S102 is heated (in the case where S83 is referred to as first heating, heating in S103 may be referred to as second heating (second temperature condition)). In the heating, the retention time within a specified temperature range is preferably shorter than or equal to 50 hours, further preferably longer than or equal to 2 hours and shorter than or equal to 10 hours, still further preferably longer than or equal to 1 hour and shorter than or equal to 3 hours.

The range of the specified temperature is preferably higher than or equal to 500° C. and lower than or equal to 1200° C., further preferably higher than or equal to 800° C. and lower than or equal to 1000° C.

The heating is performed preferably in an oxygen-containing atmosphere.

In this embodiment, the specified temperature is 800° C. and kept for 2 hours, the temperature rising rate is 200° C./h, and the flow rate in a dry atmosphere is 10 L/min.

### <Step S104>

In Step S104, crushing is performed, and mixing is performed as necessary.

### <Step S106>

Next, in Step S106, the material crushed in the above manner is collected, whereby the positive electrode active material 100 can be formed. Here, the collected particles are preferably made to pass through a sieve. Through the sieve, adhesion between the positive electrode active material particles can be solved.

### Embodiment 4

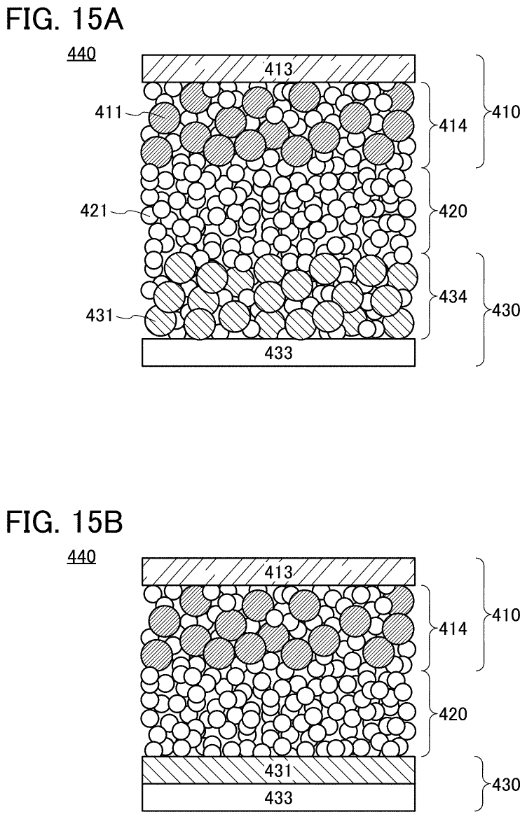

In this embodiment, an example of a secondary battery of one embodiment of the present invention will be described with reference to FIG. 15 to FIG. 17.

### <Structure Example of Secondary Battery 1>

Hereinafter, a secondary battery in which a positive electrode, a negative electrode, and an electrolyte solution are wrapped in an exterior body is described as an example.

### [Negative Electrode]

The negative electrode includes a negative electrode active material layer and a negative electrode current collector. The negative electrode active material layer may contain a conductive additive and a binder.

### [Negative Electrode Active Material]

As the negative electrode active material, the negative electrode active material described in the above embodiment can be used. Alternatively, a combination of a plurality of the negative electrode active materials described in the above embodiment can be used.

As the conductive additive, the conductive additive described in the above embodiment can be used.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, and/or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group and/or a carboxyl group. Because of functional groups, polymers are expected to interact with each other and cover an active material surface in a large area.

In the case where the binder that covers the active material surface or is in contact with the surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### [Current Collector]

A positive electrode current collector and a negative electrode current collector can be formed using a highly conductive material which is not alloyed with a carrier ion such as lithium, for example, a metal such as stainless steel, gold, platinum, zinc, iron, copper, aluminum, or titanium, or an alloy thereof. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet shape, a net shape, a punching-metal shape, an expanded-metal shape, or the like as appropriate. The current collector having a thickness of 10 μm to 30 μm inclusive is preferably used.

Note that a material that is not alloyed with carrier ions of lithium or the like is preferably used for the negative electrode current collector.

As the current collector, a titanium compound may be stacked over the above-described metal element. As a titanium compound, for example, it is possible to use one selected from titanium nitride, titanium oxide, titanium nitride in which oxygen is substituted for part of nitrogen, titanium oxide in which nitrogen is substituted for part of oxygen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal element, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

### [Positive Electrode]

The positive electrode includes a positive electrode active material layer and a positive electrode current collector. The positive electrode active material layer includes a positive electrode active material, and may include a conductive additive and a binder. As the positive electrode active material, the positive electrode active material formed by the formation method described in the above embodiments is used.

For the conductive additive and the binder that can be included in the positive electrode active material layer, materials similar to those of the conductive additive and the binder that can be included in the negative electrode active material layer can be used.

### [Electrolyte]

As the electrolyte, an electrolyte solution containing a solvent and a salt containing carrier ions can be used. As the electrolyte, a solid electrolyte such as can be used.

The electrolyte containing a solvent and a salt containing carrier ions is described. As the solvent of the electrolyte, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are unlikely to burn and volatize as the solvent of the electrolyte can prevent a secondary battery from exploding or catching fire even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the solvent of the electrolyte, an organic solvent containing fluorine can be used. Examples of the organic solvent containing fluorine may include fluorinated carbonate, fluorinated carboxylic acid ester, and an ether compound containing fluorine.

For example, tetrafluoroethylene carbonate (F4EC) represented by Chemical Formula (1) shown below can be used.

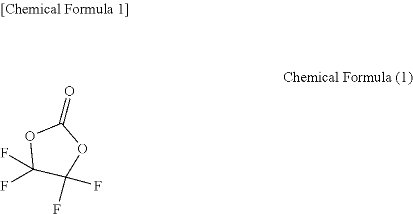

Fluorinated cyclic carbonates enable incombustibility of a lithium-ion secondary battery to be improved, resulting in high safety.

In addition, difluoroethylene carbonate (DFEC, F2EC) represented by Chemical Formula (2) shown below can be used.

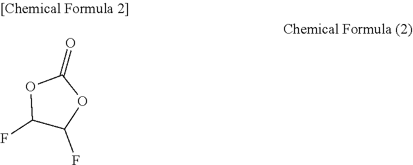

In addition, monofluoroethylene carbonate (FEC, F1EC) represented by Chemical Formula (3) shown below can be used.

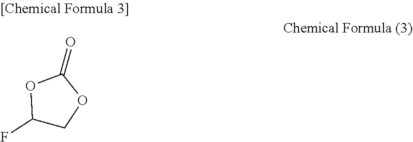

As the salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

The electrolyte used for a secondary battery is preferably highly purified and contains a small number of dust particles and elements other than the constituent elements of the electrolyte (hereinafter, also simply referred to as impurities). Specifically, the weight ratio of impurities to the electrolyte is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound like succinonitrile or adiponitrile may be added to the electrolyte. The concentration of a material to be added in the whole solvent is, for example, higher than or equal to 0.1 wt % and lower than or equal to 5 wt %.

Alternatively, a polymer gel electrolyte obtained in such a manner that a polymer is swelled with an electrolyte may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

An example of a solid electrolyte is described. A solid electrolyte including an inorganic material such as a sulfide-based and/or oxide-based inorganic material, and a solid electrolyte including a polymer material such as a PEO (polyethylene oxide)-based polymer material can be used. When the solid electrolyte is used, one or the both of a separator and a spacer are not necessary. Furthermore, the battery can be entirely solidified; therefore, there is no possibility of liquid leakage and thus the safety is dramatically improved.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved. When the separator or the surface of an electrode layer is coated with the ceramic-based material, the separator and the active material can be prevented from being in direct contact with each other.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in a secondary battery, one or more selected from a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of polyethylene, polypropylene, polycarbonate, ionomer, polyamide, or the like and an insulating synthetic resin film of a polyamide-based resin, a polyester-based resin, or the like is provided over the metal thin film as the outer surface of the exterior body. Furthermore, a fluorine resin film is preferably used as the film. The fluorine resin film has high stability against acid, alkaline, an organic solvent, and the like and inhibits side reactions, corrosion, or the like, caused by the reaction of a secondary battery, thereby achieving an excellent secondary battery. Examples of fluorine resin films include PTFE (polytetrafluoroethylene), PFA (perfluoroalkoxyalkane: a copolymer of tetrafluoroethylene and perfluoroalkylvinylether), FEP (perfluoroethylene propene copolymer: a copolymer of tetrafluoroethylene and hexafluoropropylene), and ETFE (ethylene-tetrafluoroethylene copolymer: a copolymer of tetrafluoroethylene and ethylene).

### <Structure Example 2 of Secondary Battery>

A structure of a secondary battery including a solid electrolyte layer is described below as another structure example of a secondary battery.

As illustrated in FIG. 15A, a secondary battery 440 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, the negative electrode 430 that does not include the solid electrolyte 421 can be formed, as illustrated in FIG. 15B. The use of metal lithium for the negative electrode 430 is preferable, in which case the energy density of the secondary battery 440 can be increased.

As the solid electrolyte 421 included in the solid electrolyte layer 420, a sulfide-based solid electrolyte, an oxide-based solid electrolyte, a halide-based solid electrolyte, or the like can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S×₃₀P₂S₅, 30Li₂S×26B₂S₃×44LiI, 63Li₂S×38SiS₂×1Li₃PO₄, 57Li₂S×38SiS₂×5Li₄SiO₄, and 50Li₂S×50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄×50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0 [x [1) with a NASICON crystal structure (hereinafter LATP) is preferable because LATP contains aluminum and titanium, each of which is an element that can be contained in the positive electrode active material used for the secondary battery 440 of one embodiment of the present invention, and thus a synergistic effect of improving the cycle performance is expected. Moreover, higher productivity due to the reduction in the number of steps is expected. Note that in this specification and the like, a material with a NASICON crystal structure refers to a compound that is represented by M₂(AO₄)₃ (M: transition metal; A: S, P, As, Mo, W, or the like) and has a structure in which MO₆ octahedra and AO₄ tetrahedra that share common corners are arranged three-dimensionally.

### [Exterior Body and Shape of Secondary Battery]

An exterior body of the secondary battery 440 of one embodiment of the present invention can employ a variety of materials and have a variety of shapes, and preferably has a function of applying pressure to the positive electrode, the solid electrolyte layer, and the negative electrode.

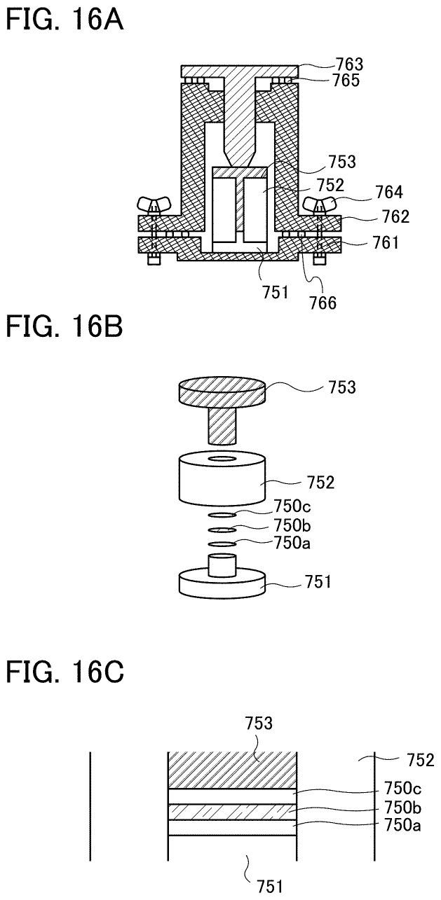

FIG. 16 illustrates an example of a cell for evaluating materials of an all-solid-state battery, for example.

FIG. 16A is a schematic cross-sectional view of the evaluation cell, and the evaluation cell includes a lower component 761, an upper component 762, and one or both of a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 16B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 16C. Note that the same portions in FIG. 16A, FIG. 16B, and FIG. 16C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

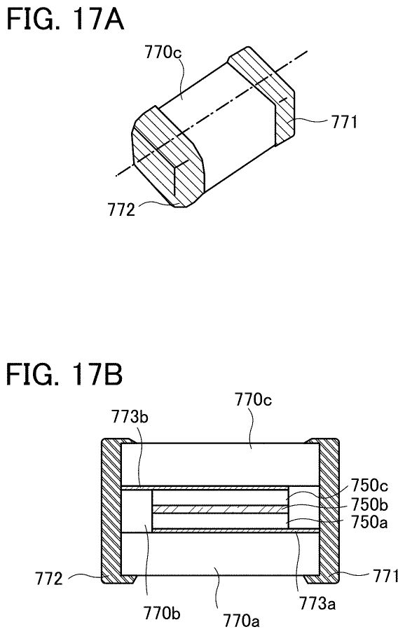

FIG. 17A illustrates a perspective view of a secondary battery of one embodiment of the present invention that has an exterior body and a shape different from those in FIG. 16. The secondary battery in FIG. 17A includes external electrodes 771 and 772 and is sealed with an exterior body including a plurality of package components.

FIG. 17B shows an example of a cross section along the dashed-dotted line in FIG. 17A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 5

In this embodiment, examples of a shape of a secondary battery including the positive electrode described in the above embodiment will be described. For the materials used for the secondary battery described in this embodiment, the description of the above embodiment can be referred to.

### <Coin-Type Secondary Battery>

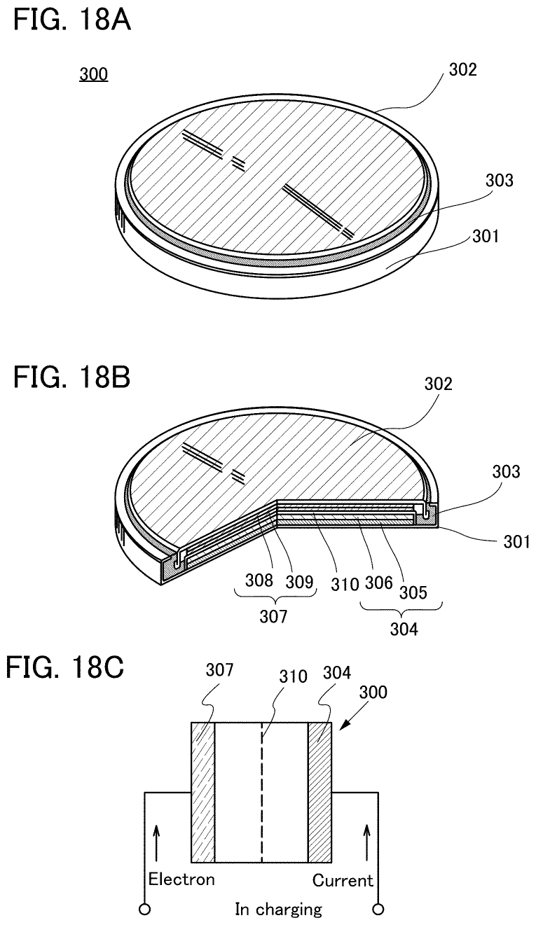

First, an example of a coin-type secondary battery is described. FIG. 18A is an external view of a coin-type (single-layer flat type) secondary battery, and FIG. 18B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as shown in FIG. 18B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 can be made.

When the positive electrode active material described in the above embodiment is used in the positive electrode 304, the coin-type secondary battery 300 with high charge/discharge capacity and excellent cycle performance can be obtained.

Here, a current flow in charging a secondary battery is described with reference to FIG. 18C. When a secondary battery using lithium is regarded as a closed circuit, movement of lithium ions and the current flow are in the same direction. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals in FIG. 18C are connected to a charger, and the secondary battery 300 is charged. As the charging of the secondary battery 300 proceeds, a potential difference between electrodes increases.

### <Cylindrical Secondary Battery>

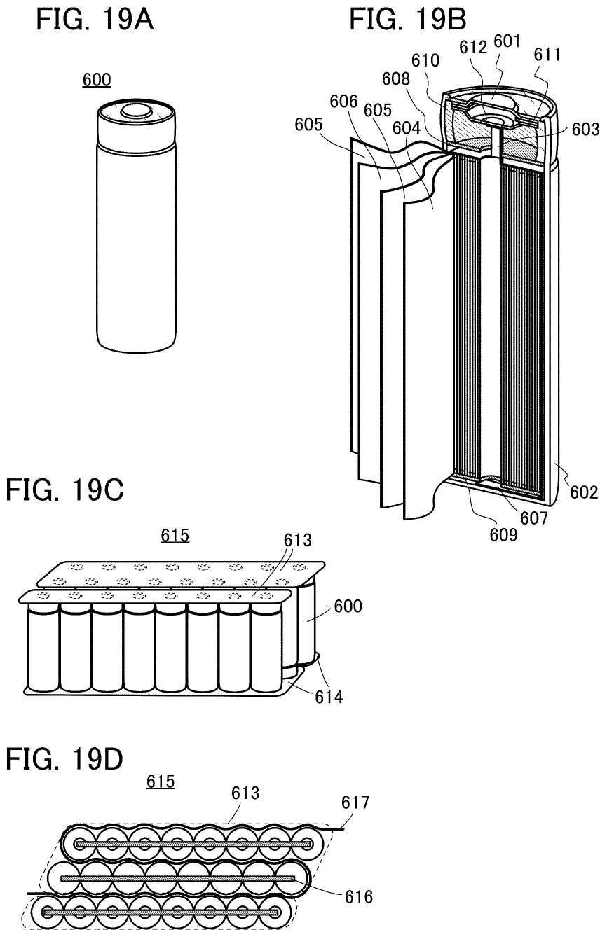

Next, examples of a cylindrical secondary battery are described with reference to FIG. 19. An external view of a cylindrical secondary battery 600 is shown in FIG. 19A. FIG. 19B is a schematic cross-sectional view of the cylindrical secondary battery 600. The cylindrical secondary battery 600 includes, as shown in FIG. 19B, a positive electrode cap (battery lid) 601 on the top surface and a battery can (outer can) 602 on a side surface and a bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected in a region inside the battery can 602 provided with the battery element. As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As shown in FIG. 19C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 19D is a top view of the module 615. The conductive plate 613 is shown by a dotted line for clarity of the diagram. As shown in FIG. 19D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge/discharge capacity and excellent cycle performance can be obtained.

### <Structure Examples of Secondary Battery>

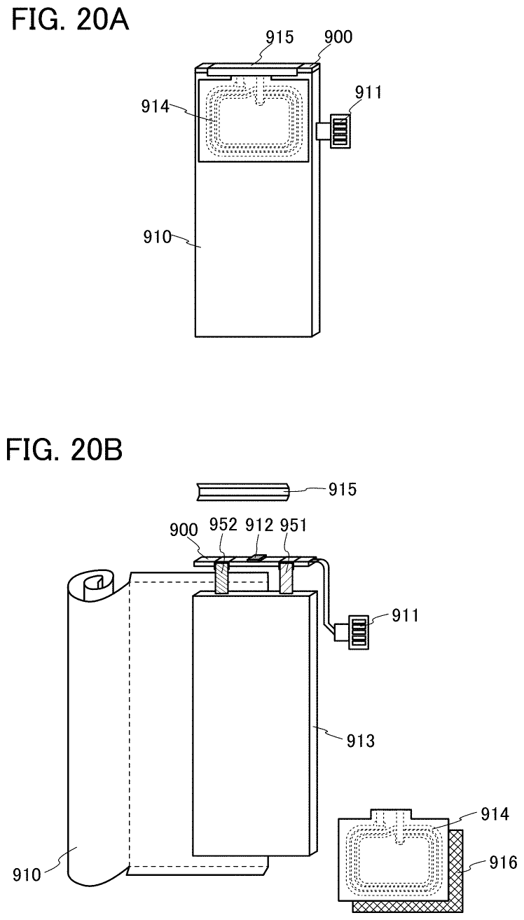

Other structure examples of secondary batteries are described using FIG. 20 to FIG. 23.

FIG. 20A and FIG. 20B are external views of a battery pack. The battery pack includes a secondary battery 913 and a circuit board 900. The secondary battery 913 is connected to an antenna 914 through the circuit board 900. A label 910 is attached to the secondary battery 913. In addition, as illustrated in FIG. 20B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

The circuit 912 is preferably a circuit portion having a function of controlling the secondary battery. The circuit 912 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

For the oxide semiconductor used in the transistor, a metal oxide functioning as an oxide semiconductor is preferably used. For example, as the metal oxide, a metal oxide such as an In-M-Zn oxide (the element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that the distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted with [In], [Ga], and [Zn], respectively. For example, the first region in the CAC-OS in the In—Ga—Zn oxide has [In] higher than [In] in the composition of the CAC-OS film. Moreover, the second region has [Ga] higher than [Ga] in the composition of the CAC-OS film. For example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, according to EDX mapping obtained by EDX, the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. A CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among the amorphous oxide semiconductor, the polycrystalline oxide semiconductor, the a-like OS, the CAC-OS, the nc-OS, and the CAAC-OS may be included in an oxide semiconductor of one embodiment of the present invention.

The circuit 912 functioning as the control circuit portion preferably uses a transistor using an oxide semiconductor because such a transistor can be used in a high-temperature environment. For the process simplicity, the circuit 912 may be formed using transistors of the same conductivity type. A transistor using an oxide semiconductor in its semiconductor layer has an operating ambient temperature range from −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. regardless of the temperature. On the other hand, the off-state current characteristics of the single crystal Si transistor largely depend on the temperature. For example, at 150° C., the off-state current of the single crystal Si transistor increases, and a sufficiently high current on/off ratio cannot be obtained.

The circuit 912 that uses a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the circuit 912 has at least one or more of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charging and discharging; an uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the circuit 912 not only detects a micro-short circuit but also senses a terminal voltage of the secondary battery and controls the charging and discharging state of the secondary battery. For example, to prevent overcharging, the circuit 912 can turn off an output transistor of a charging circuit and an interruption switch substantially at the same time.

Note that the structure of the battery pack is not limited to that in FIG. 20.

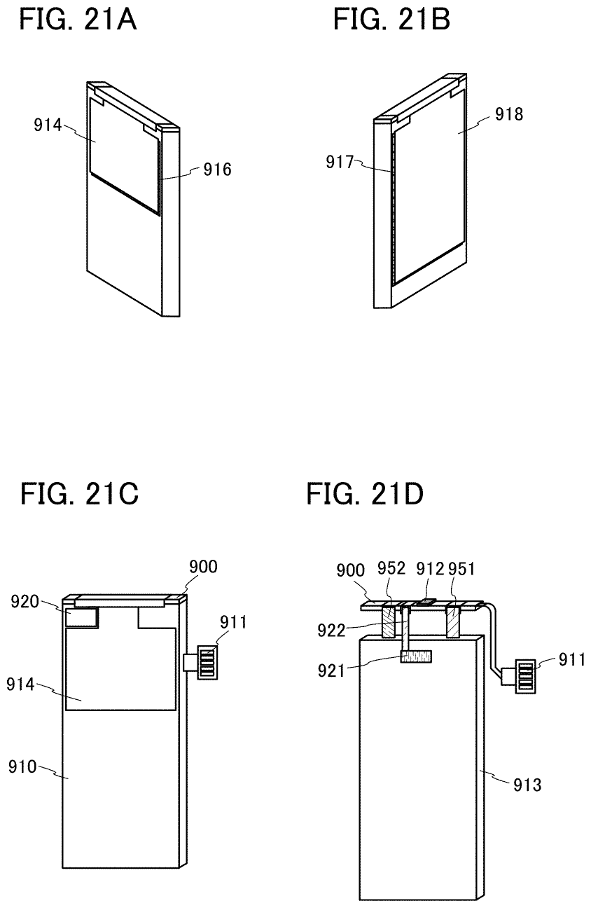

For example, as shown in FIG. 21A and FIG. 21B, opposing surfaces of the secondary battery 913 in FIG. 20A and FIG. 20B may be provided with respective antennas. FIG. 21A is an external view seen from one side of the opposing surfaces, and FIG. 21B is an external view seen from the other side of the opposing surfaces. For portions similar to those in FIG. 20A and FIG. 20B, refer to the description of the secondary battery shown in FIG. 20A and FIG. 20B as appropriate.

As shown in FIG. 21A, the antenna 914 is provided on one of the opposing surfaces of the secondary battery 913 with the layer 916 located therebetween, and as shown in FIG. 21B, an antenna 918 is provided on the other of the opposing surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as shown in FIG. 21C, the secondary battery 913 in FIG. 20A and FIG. 20B may be provided with a display device 920. The display device 920 is electrically connected to the terminal 911. Note that the label 910 is not necessarily provided in a portion where the display device 920 is provided. For portions similar to those in FIG. 20A and FIG. 20B, refer to the description of the secondary battery shown in FIG. 20A and FIG. 20B as appropriate.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as shown in FIG. 21D, the secondary battery 913 shown in FIG. 20A and FIG. 20B may be provided with a sensor 921. The sensor 921 is electrically connected to the terminal 911 via a terminal 922. For portions similar to those in FIG. 20A and FIG. 20B, refer to the description of the secondary battery shown in FIG. 20A and FIG. 20B as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, power, radiation, flow rate, humidity, gradient, vibration, odor, or infrared rays. With the sensor 921, for example, data on an environment (e.g., temperature) where the secondary battery is placed can be sensed and stored in a memory inside the circuit 912.

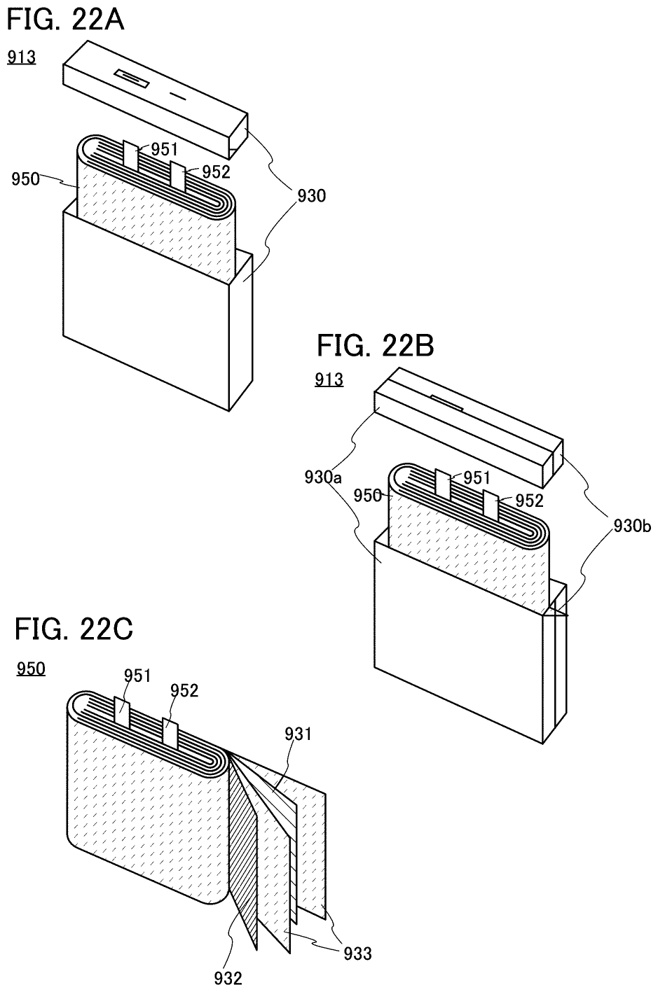

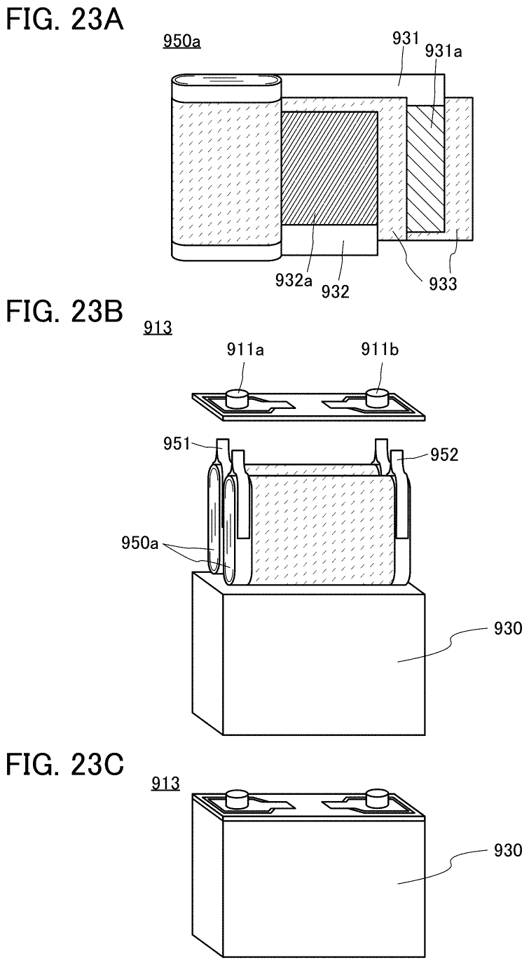

Furthermore, structure examples of the secondary battery 913 are described using FIG. 22 and FIG. 23.

The secondary battery 913 shown in FIG. 22A includes a wound body 950 provided with the terminal 951 and the terminal 952 inside a housing 930. The wound body 950 is soaked in an electrolyte solution in a region inside the housing 930. The terminal 952 is in contact with the housing 930. Using an insulator or the like inhibits contact between the terminal 951 and the housing 930. In FIG. 22A, the housing 930 divided into two pieces is shown for convenience; however, in the actual structure, the wound body 950 is covered with the housing 930 and the terminal 951 and the terminal 952 extend to the outside of the housing 930. For the housing 930, a metal material (e.g., aluminum or the like) or a resin material can be used.

As shown in FIG. 22B, the housing 930 shown in FIG. 22A may be formed using a plurality of materials. For example, in the secondary battery 913 in FIG. 22B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna such as the antenna 914 may be provided in a region inside the housing 930a. For the housing 930b, a metal material can be used, for example.

FIG. 22C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

The negative electrode 931 is connected to the terminal 911 shown in FIG. 20 through one of the terminal 951 and the terminal 952. The positive electrode 932 is connected to the terminal 911 in FIG. 20 through the other of the terminal 951 and the terminal 952.

As illustrated in FIGS. 23A to 23C, a secondary battery 913 may include a wound body 950a. The wound body 950a illustrated in FIG. 23A includes a negative electrode 931, a positive electrode 932, and separators 933. The negative electrode 931 includes a negative electrode active material layer 931a. The positive electrode 932 includes a positive electrode active material layer 932a. The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 23B, the negative electrode 931 is electrically connected to a terminal 951. The terminal 951 is electrically connected to a terminal 911a. The positive electrode 932 is electrically connected to the terminal 952. The terminal 952 is electrically connected to a terminal 911b.

As illustrated in FIG. 23C, the wound body 950a and an electrolyte solution are covered with the housing 930, whereby the secondary battery 913 is obtained. The housing 930 is preferably provided with a safety valve, an overcurrent protection element, and the like.

As illustrated in FIG. 23B, the secondary battery 913 may include a plurality of wound bodies 950a. The use of the plurality of wound bodies 950a enables the secondary battery 913 to have higher charge/discharge capacity. The description of the secondary battery 913 illustrated in FIG. 22A to FIG. 22C can be referred to for the other components of the secondary battery 913 illustrated in FIG. 23A and FIG. 23B.

When the positive electrode active material described in the above embodiment is used in the positive electrode 932, the secondary battery 913 with high charge/discharge capacity and excellent cycle performance can be obtained.

### <Laminated Secondary Battery>

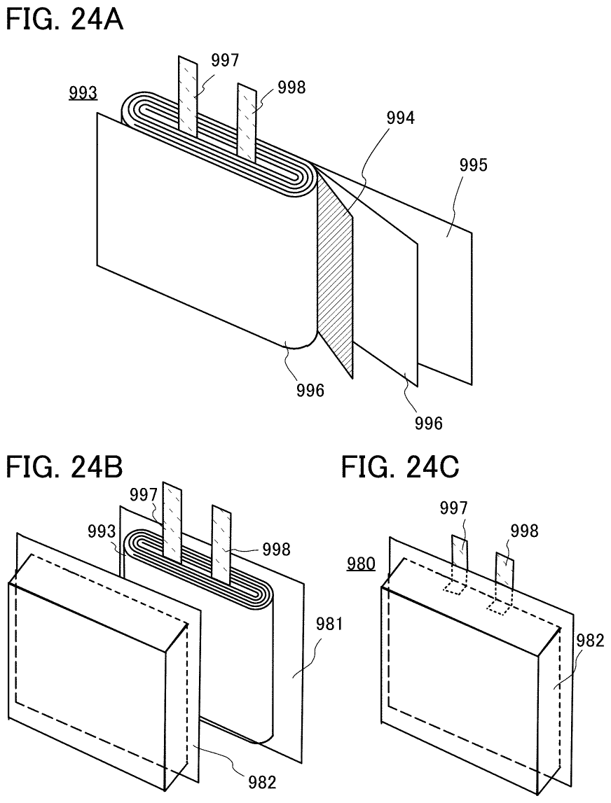

Next, an example of a laminated secondary battery is described with reference to FIG. 24 to FIG. 36. When the laminated secondary battery has flexibility or is used in an electronic device at least part of which is flexible, the secondary battery can be bent as the electronic device is bent.

A laminated secondary battery 980 is described using FIG. 24. The laminated secondary battery 980 includes the wound body 993 shown in FIG. 24A. The wound body 993 includes a negative electrode 994, a positive electrode 995, and separators 996. Like the wound body 950a shown in FIG. 23, the wound body 993 is a wound body where the negative electrode 994 is stacked to overlap with the positive electrode 995 with the separator 996 sandwiched therebetween and the sheet of the stack is wound.

Note that the number of stacks each including the negative electrode 994, the positive electrode 995, and the separator 996 may be designed as appropriate depending on required charge/discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As shown in FIG. 24B, the wound body 993 is packed in a space formed by bonding a film 981 and a film 982 having a depressed portion that serve as exterior bodies by thermocompression bonding or the like, whereby the secondary battery 980 shown in FIG. 24C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum and/or a resin material can be used, for example. With use of a resin material for the film 981 and the film 982 having a depressed portion, the film 981 and the film 982 having a depressed portion can be changed in their forms when external force is applied; thus, a flexible storage battery can be formed.

Although FIG. 24B and FIG. 24C show an example where a space is formed by two films, the wound body 993 may be placed in a space formed by bending one film.

When the positive electrode active material described in the above embodiment is used in the positive electrode 995, the secondary battery 980 with high charge/discharge capacity and excellent cycle performance can be obtained.

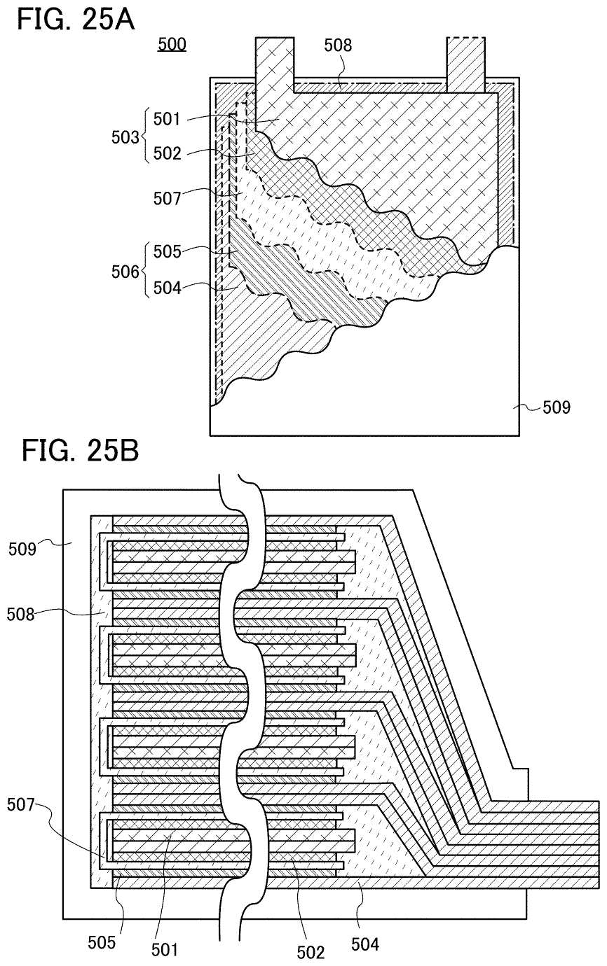

In FIG. 24, an example in which the secondary battery 980 includes a wound body in a space formed by films serving as exterior bodies is described; however, as illustrated in FIG. 25, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 shown in FIG. 25A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 shown in FIG. 25A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 25B shows an example of a cross-sectional structure of the laminated secondary battery 500. FIG. 25A shows an example in which only two current collectors are included for simplicity; an actual battery includes a plurality of electrode layers as shown in FIG. 25B.

In FIG. 25B, the number of electrode layers is 16, for example. Note that the secondary battery 500 has flexibility even though the number of electrode layers is set to 16. FIG. 25B shows a structure including 8 layers of negative electrode current collectors 504 and 8 layers of positive electrode current collectors 501, i.e., 16 layers in total. Note that FIG. 25B shows a cross section of the negative electrode extraction portion, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge/discharge capacity. In contrast, with a small number of electrode layers, the secondary battery can have a small thickness and high flexibility.

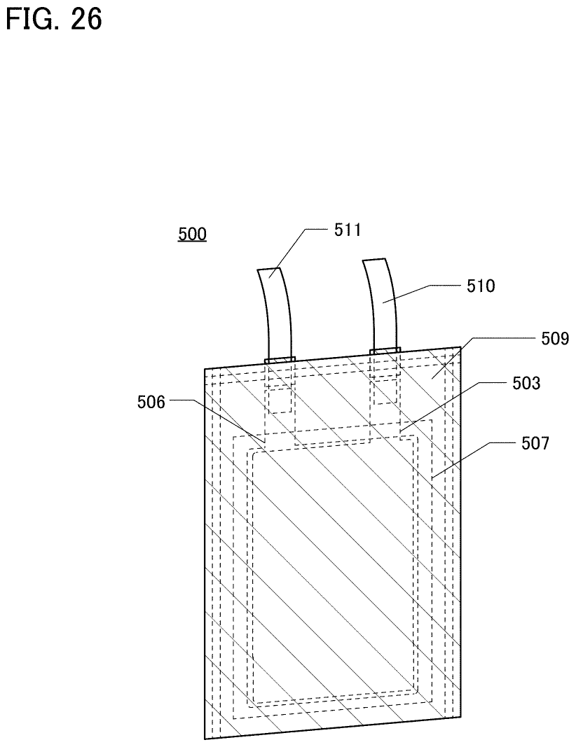

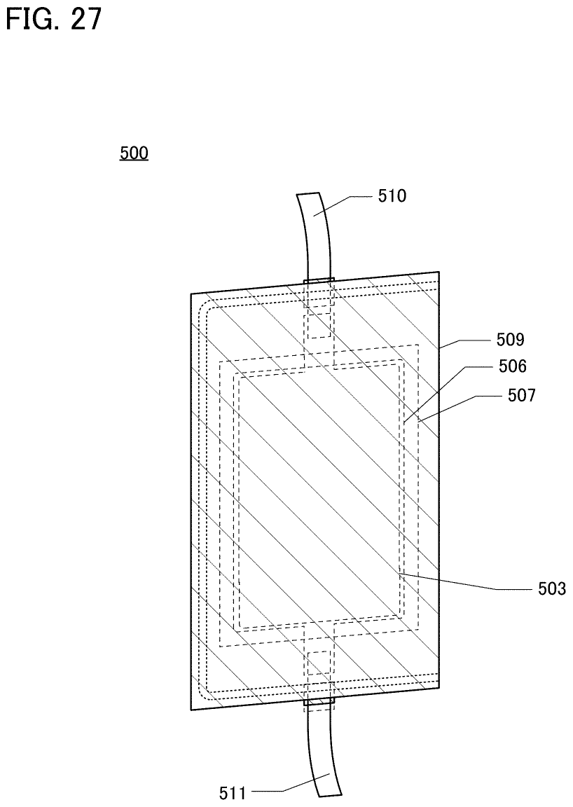

FIG. 26 and FIG. 27 each show an example of the external view of the laminated secondary battery 500. In FIG. 26 and FIG. 27, the laminated secondary battery 500 includes the positive electrode 503, the negative electrode 506, the separator 507, the exterior body 509, a positive electrode lead electrode 510, and a negative electrode lead electrode 511.

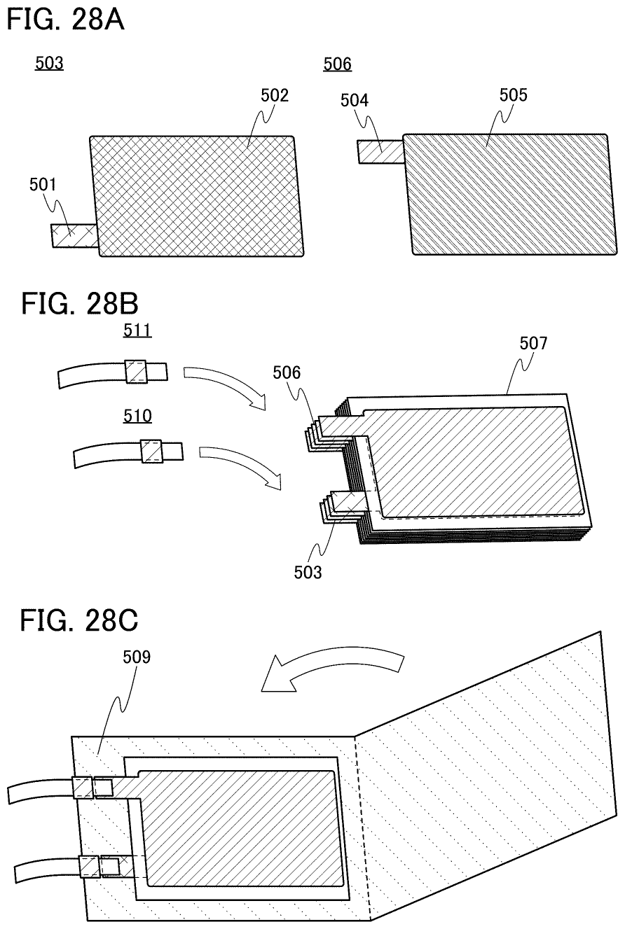

FIG. 28A shows external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 28A.

### <Manufacturing Method of Laminated Secondary Battery>

Here, an example of a method for manufacturing the laminated secondary battery whose external view is shown in FIG. 26 is described with reference to FIG. 28B and FIG. 28C.

First, the negative electrode 506, the separator 507, and the positive electrode 503 are stacked. FIG. 28B shows a stack including the negative electrode 506, the separator 507, and the positive electrode 503. Here, an example in which five negative electrodes and four positive electrodes are used is shown. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as shown in FIG. 28C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be manufactured.

When the positive electrode active material described in the above embodiment is used in the positive electrode 503, the secondary battery 500 with high charge/discharge capacity and excellent cycle performance can be obtained.

### <Bendable Secondary Battery>

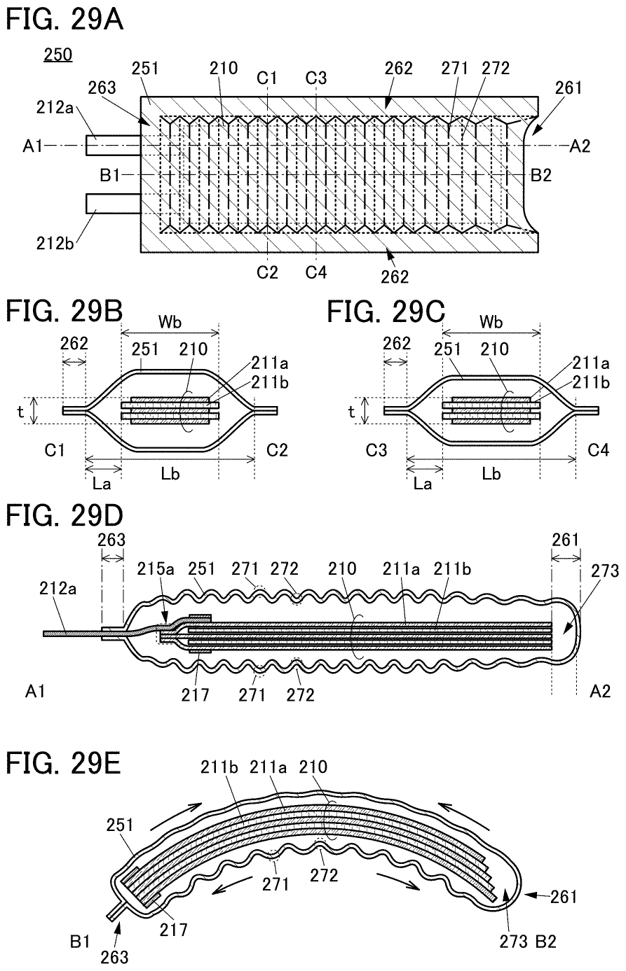

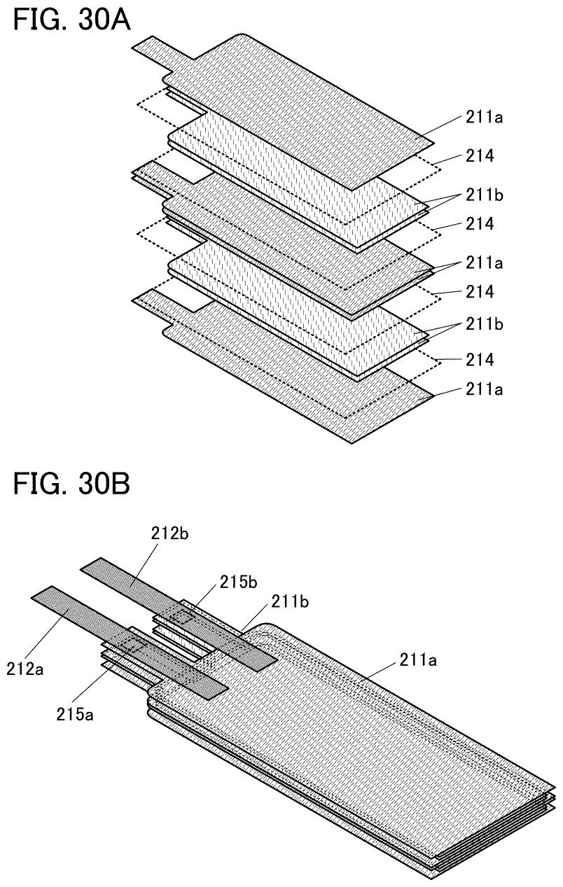

Next, an example of a bendable secondary battery is described with reference to FIG. 29 and FIG. 30.

FIG. 29A is a schematic top view of a bendable secondary battery 250. FIG. 29B, FIG. 29C, and FIG. 29D are schematic cross-sectional views taken along the cutting line C1-C2, the cutting line C3-C4, and the cutting line A1-A2, respectively, in FIG. 29A. The secondary battery 250 includes an exterior body 251 and an electrode stack 210 held in the exterior body 251. The electrode stack 210 includes at least a positive electrode 211a and a negative electrode 211b. The positive electrode 211a and the negative electrode 211b are collectively referred to as the electrode stack 210. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

The positive electrode 211a and the negative electrode 211b that are included in the secondary battery 250 are described using FIG. 30. FIG. 30A is a perspective view showing the stacking order of the positive electrode 211a, the negative electrode 211b, and a separator 214. FIG. 30B is a perspective view showing the lead 212a and the lead 212b in addition to the positive electrode 211a and the negative electrode 211b.

As shown in FIG. 30A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab. A positive electrode active material layer is formed on one surface of the positive electrode 211a other than the tab, and a negative electrode active material layer is formed on one surface of the negative electrode 211b other than the tab.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material is not formed are in contact with each other.

The separator 214 is provided between the surface of the positive electrode 211a on which the positive electrode active material is formed and the surface of the negative electrode 211b on which the negative electrode active material is formed. In FIG. 30A and FIG. 30B, the separator 214 is shown by a dotted line for easy viewing.

In addition, as shown in FIG. 30B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described with reference to FIG. 29B, FIG. 29C, FIG. 29D, and FIG. 29E.

The exterior body 251 has a film-like shape and is folded in half so as to sandwich the positive electrodes 211a and the negative electrodes 211b. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. In addition, the seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. In addition, the seal portions 262 and the seal portion 263 of the exterior body 251 are preferably flat.

FIG. 29B shows a cross section along a part overlapping with the crest line 271. FIG. 29C shows a cross section along a part overlapping with the trough line 272. FIG. 29B and FIG. 29C correspond to cross sections of the secondary battery 250, the positive electrodes 211a, and the negative electrodes 211b in the width direction.

Here, the distance in the width direction between end portions of the positive electrode 211a and the negative electrode 211b and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

The distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is indicated by t, the distance La is 0.8 times or more and 3.0 times or less, preferably 0.9 times or more and 2.5 times or less, further preferably 1.0 time or more and 2.0 times or less as large as the thickness t. Alternatively, the distance La is preferably 0.8 times or more and 2.5 times or less as large as the thickness t. Alternatively, the distance La is preferably 0.8 times or more and 2.0 times or less as large as the thickness t. Alternatively, the distance La is preferably 0.9 times or more and 3.0 times or less as large as the thickness t. Alternatively, the distance La is preferably 0.9 times or more and 2.0 times or less as large as the thickness t. Alternatively, the distance La is preferably 1.0 times or more and 3.0 times or less as large as the thickness t. Alternatively, the distance La is preferably 1.0 times or more and 2.5 times or less as large as the thickness t. When the distance La is in this range, a compact battery that is highly reliable for bending can be fabricated.

Furthermore, when the distance between the pair of seal portions 262 is indicated by a distance Lb, it is preferable that the distance Lb be sufficiently larger than the width of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; hence, the positive electrode 211a and the negative electrode 211b can be effectively prevented from rubbing against the exterior body 251.

For example, the difference between the distance Lb between the pair of seal portions 262 and the width Wb of the negative electrode 211b is preferably 1.6 times or more and 6.0 times or less, further preferably 1.8 times or more and 5.0 times or less, still further preferably 2.0 times or more and 4.0 times or less as large as the thickness t of the positive electrode 211a and the negative electrode 211b. Alternatively, the difference is preferably 1.6 times or more and 5.0 times or less as large as the thickness t. Alternatively, the difference is preferably 1.6 times or more and 4.0 times or less as large as the thickness t. Alternatively, the difference is preferably 1.8 times or more and 6.0 times or less as large as the thickness t. Alternatively, the difference is preferably 1.8 times or more and 4.0 times or less as large as the thickness t. Alternatively, the difference is preferably 2.0 times or more and 6.0 times or less as large as the thickness t. Alternatively, the difference is preferably 2.0 times or more and 5.0 times or less as large as the thickness t.

FIG. 29D shows a cross section including the lead 212a and corresponds to a cross section of the secondary battery 250, the positive electrode 211a, and the negative electrode 211b in the length direction. As shown in FIG. 29D, a space 273 is preferably provided between the end portions of the positive electrode 211a and the negative electrode 211b in the length direction and the exterior body 251 in the folded portion 261.

FIG. 29E is a schematic cross-sectional view of the secondary battery 250 in a state of being bent. FIG. 29E corresponds to a cross section along the cutting line B1-B2 in FIG. 29A.

When the secondary battery 250 is bent, a part of the exterior body 251 positioned on the outer side in bending is arched and the other part positioned on the inner side changes its shape as it shrinks. More specifically, the part of the exterior body 251 positioned on the outer side changes its shape such that the wave amplitude becomes smaller and the length of the wave period becomes larger. In contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand or contract. Thus, the secondary battery 250 can be bent with weak force without damage to the exterior body 251.

As shown in FIG. 29E, when the secondary battery 250 is bent, the positive electrode 211a and the negative electrode 211b relatively move. At this time, ends of the stacked positive electrodes 211a and negative electrodes 211b on the seal portion 263 side are fixed by a fixing member 217. Thus, the positive electrodes 211a and the negative electrodes 211b are shifted so that the shift amount becomes larger at a position closer to the folded portion 261. Therefore, stress applied to the positive electrode 211a and the negative electrode 211b is relieved, and the positive electrode 211a and the negative electrode 211b themselves do not need to expand or contract. Consequently, the secondary battery 250 can be bent without damage to the positive electrode 211a and the negative electrode 211b.

The space 273 is included between the positive electrode 211a and the negative electrode 211b, and the exterior body 251, whereby the positive electrode 211a and the negative electrode 211b can be shifted relatively while the positive electrode 211a and the negative electrode 211b located on an inner side in bending do not come into contact with the exterior body 251.

Repetitions of being stretched and squashed of the secondary battery 250 shown in FIG. 29 and FIG. 30 are less likely to damage the exterior body, the positive electrode 211a, and the negative electrode 211b, for example; battery characteristics are less likely to deteriorate. When the positive electrode active material described in the above embodiment is used in the positive electrode 211a included in the secondary battery 250, a battery with better cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be suppressed, and the reliability of the all-solid-state battery can be improved.

This embodiment can be implemented in appropriate combination with any of the other embodiments.

### Embodiment 6

In this embodiment, examples of incorporating the secondary battery of one embodiment into electronic devices will be described.

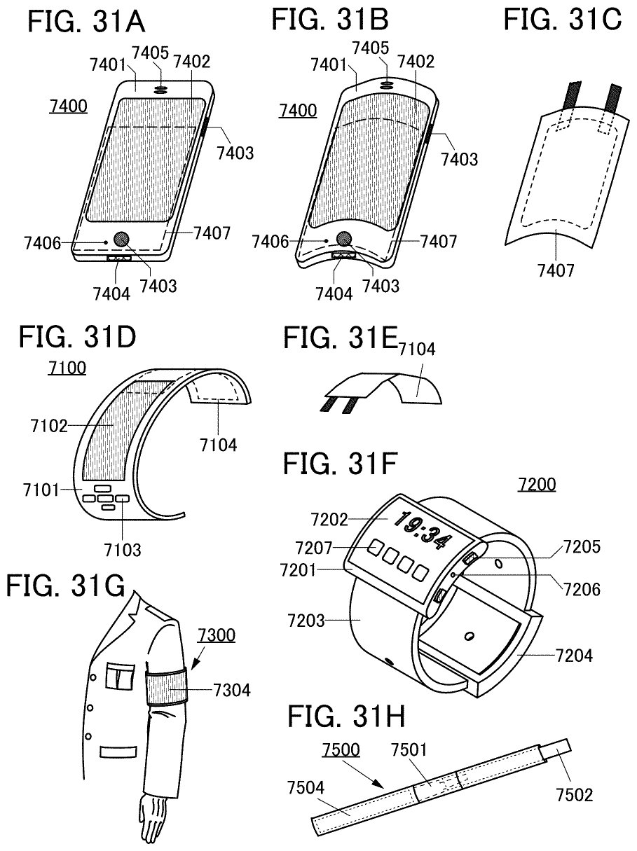

First, FIG. 31A to FIG. 31G show examples of electronic devices including the bendable secondary battery described in the above embodiment. Examples of the electronic device including the bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inner/outer wall surface of a house or a building or a curved interior/exterior surface of an automobile.

FIG. 31A illustrates an example of a mobile phone. A mobile phone 7400 includes an operation button 7403, an external connection port 7404, a speaker 7405, a microphone 7406, and the like in addition to a display portion 7402 incorporated in a housing 7401. Note that the mobile phone 7400 includes a secondary battery 7407. When the secondary battery of one embodiment of the present invention is used as the secondary battery 7407, a lightweight mobile phone with a long lifetime can be provided.

FIG. 31B illustrates the mobile phone 7400 that is curved. When the whole mobile phone 7400 is curved by external force, the secondary battery 7407 provided in a region inside the mobile phone 7400 is also curved. FIG. 31C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 31D shows an example of a bangle display device. A portable display device 7100 includes a housing 7101, a display portion 7102, operation buttons 7103, and a secondary battery 7104. FIG. 31E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 31F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and computer games.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off operation, wireless communication on/off operation, execution and cancellation of a silent mode, and execution and cancellation of a power saving mode can be performed. For example, the functions of the operation button 7205 can be set freely by setting the operating system incorporated in the portable information terminal 7200.

The portable information terminal 7200 can employ near field communication based on an existing communication standard. For example, mutual communication between the mobile terminal 7200 and a headset capable of wireless communication can be performed, and thus hands-free calling is possible. The portable information terminal 7200 may include an antenna. The antenna may be used for wireless communication.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 31E that is in the state of being curved can be provided in a region inside the housing 7201. Alternatively, the secondary battery 7104 can be provided in a region inside the band 7203 such that it can be curved.

The portable information terminal 7200 preferably includes a sensor. As the sensor, for example, one or more selected from human body sensors such as a fingerprint sensor, a pulse sensor, and a temperature sensor, a touch sensor, a pressure sensitive sensor, and an acceleration sensor are preferably mounted.

FIG. 31G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

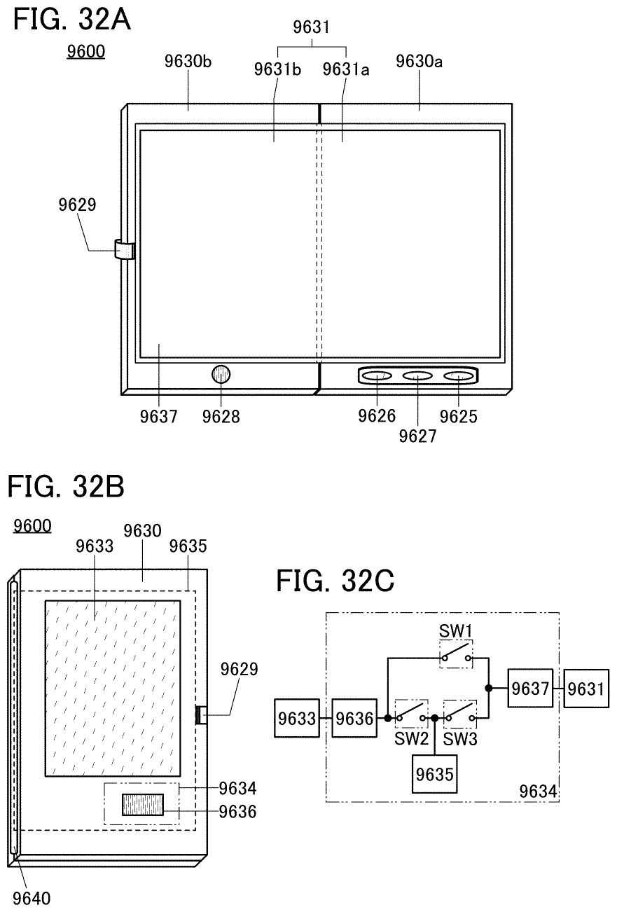

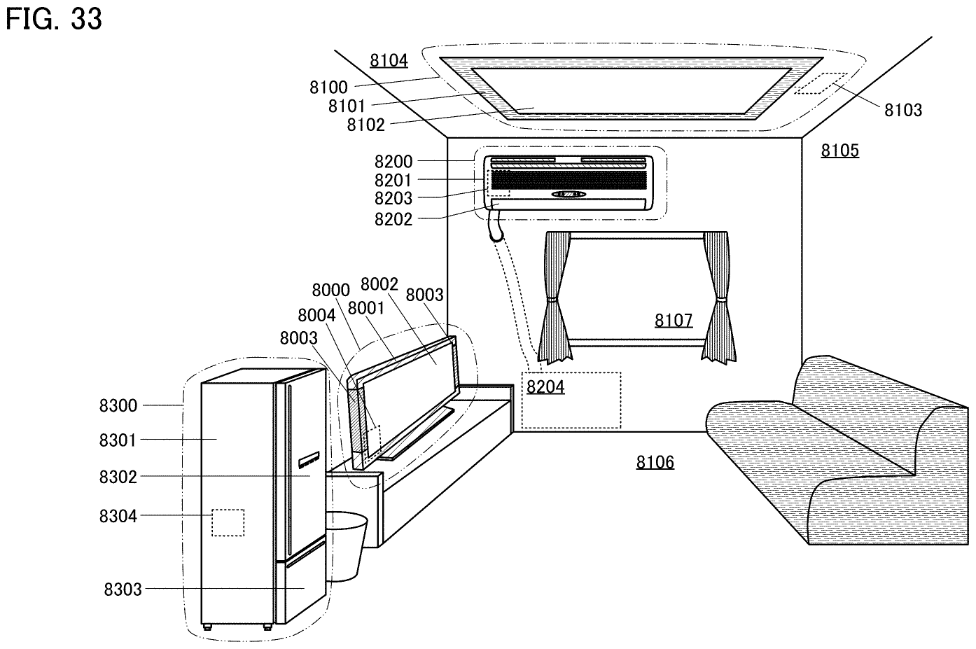

Examples of electronic devices each including the secondary battery described in the above embodiment are described with reference to FIG. 31H, FIG. 32, and FIG. 33.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge/discharge capacity are desired in consideration of handling ease for users.

FIG. 31H is a perspective view of a device called a cigarette smoking device (electronic cigarette). In FIG. 31H, an electronic cigarette 7500 includes an atomizer 7501 including a heating element, a secondary battery 7504 that supplies power to the atomizer, and a cartridge 7502 including one or more selected from a liquid supply bottle, a sensor, and the like. To improve safety, a protection circuit that prevents one or both of overcharge and overdischarge of the secondary battery 7504 may be electrically connected to the secondary battery 7504. The secondary battery 7504 illustrated in FIG. 31H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high charge/discharge capacity and excellent cycle performance, the small and lightweight electronic cigarette 7500 that can be used for a long time over a long period can be provided.

Next, FIG. 32A and FIG. 32B show an example of a tablet terminal that can be folded in half. A tablet terminal 9600 illustrated in FIG. 32A and FIG. 31B includes a housing 9630a, a housing 9630b, a movable portion 9640 connecting the housing 9630a and the housing 9630b to each other, a display portion 9631 including a display portion 9631a and a display portion 9631b, a switch 9625, a switch 9626, a switch 9627, a fastener 9629, and an operation switch 9628. A flexible panel is used for the display portion 9631, whereby a tablet terminal having a larger display portion can be provided. FIG. 32A illustrates the tablet terminal 9600 that is opened, and FIG. 32B illustrates the tablet terminal 9600 that is closed.

The tablet terminal 9600 includes a power storage unit 9635 in regions inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching an image including an icon, text, an input form, or the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching display between a portrait mode and a landscape mode or a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

In addition, FIG. 32A illustrates the example where the display portion 9631a on the housing 9630a side and the display portion 9631b on the housing 9630b side have substantially the same display area; however, there is no particular limitation on the display area of each of the display portion 9631a and the display portion 9631b, and one of the display portions may have a size different from that of the other of the display portions, and one of the display portions may have display quality different from that of the other of the display portions. For example, one may be a display panel that can display higher-definition images than the other.

The tablet terminal 9600 is folded in half in FIG. 32B. The tablet terminal 9600 includes a housing 9630, a solar cell 9633, and a charge/discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. Thus, the display portion 9631 can be protected owing to the folding, which increases the durability of the tablet terminal 9600. With the power storage unit 9635 including the secondary battery of one embodiment of the present invention, which has high charge/discharge capacity and excellent cycle performance, the tablet terminal 9600 that can be used for a long time over a long period can be provided.

In addition, the tablet terminal 9600 illustrated in FIG. 32A and FIG. 32B can also have a function of displaying various kinds of data (a still image, a moving image, a text image, and the like), a function of displaying a calendar, a date, or time on the display portion, a touch-input function of operating or editing data displayed on the display portion by touch input, a function of controlling processing by a variety of software (programs), and the like.

With the solar cell 9633 that is attached onto the surface of the tablet terminal 9600, electric power can be supplied to a touch panel, a display portion, a video signal processing portion, and the like. Note that it is possible to obtain a structure where the solar cell 9633 can be provided on one surface or both surfaces of the housing 9630 and the power storage unit 9635 is charged efficiently. The use of a lithium-ion battery as the power storage unit 9635 brings an advantage such as a reduction in size.

The structure and operation of the charge/discharge control circuit 9634 illustrated in FIG. 32B are described with reference to a block diagram in FIG. 32C. The solar cell 9633, the power storage unit 9635, the DCDC converter 9636, a converter 9637, switches SW1 to SW3, and the display portion 9631 are illustrated in FIG. 32C, and the power storage unit 9635, the DCDC converter 9636, the converter 9637, and the switches SW1 to SW3 correspond to the charge/discharge control circuit 9634 illustrated in FIG. 32B.

First, an operation example in which electric power is generated by the solar cell 9633 using external light is described. The voltage of electric power generated by the solar cell is raised or lowered by the DCDC converter 9636 to be a voltage for charging the power storage unit 9635. Then, when the electric power from the solar cell 9633 is used for the operation of the display portion 9631, the switch SW1 is turned on and the voltage of the electric power is raised or lowered by the converter 9637 to be a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit that is one or more elements selected from a piezoelectric element, a thermoelectric conversion element (Peltier element), and the like. For example, the charging may be performed with a non-contact power transmission module that performs charging by transmitting and receiving electric power wirelessly (without contact), or with a combination of other charge units.

FIG. 33 illustrates other examples of electronic devices. In FIG. 33, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, a secondary battery 8004, and the like. The secondary battery 8004 of one embodiment of the present invention is provided in a region inside the housing 8001. The display device 8000 can receive electric power from a commercial power supply and can use electric power stored in the secondary battery 8004. Thus, the display device 8000 can be operated with use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides for TV broadcast reception.

In FIG. 33, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 33 shows the case where the secondary battery 8103 is provided inside a ceiling 8104 on which the housing 8101 and the light source 8102 are installed, the secondary battery 8103 may be provided inside the housing 8101. The lighting device 8100 can receive electric power from a commercial power supply and can use electric power stored in the secondary battery 8103. Thus, the lighting device 8100 can be operated with use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 33 as an example, the secondary battery of one embodiment of the present invention can be used in an installation lighting device provided on, for example, a side wall 8105, a floor 8106, or a window 8107 other than the ceiling 8104, and can be used in a tabletop lighting device or the like.

As the light source 8102, an artificial light source that emits light artificially by using electric power can be used. Specific examples of the artificial light source include an incandescent lamp, a discharge lamp such as a fluorescent lamp, and light-emitting elements such as an LED and an organic EL element are given.

In FIG. 33, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 33 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply and can use electric power stored in the secondary battery 8203. Particularly in the case where the secondary batteries 8203 are provided in both the indoor unit 8200 and the outdoor unit 8204, the air conditioner can be operated with use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 33 as an example, the secondary battery of one embodiment of the present invention can be used in an air conditioner in which the function of an indoor unit and the function of an outdoor unit are integrated in one housing.

In FIG. 33, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided inside the housing 8301 in FIG. 33. The electric refrigerator-freezer 8300 can receive electric power from a commercial power supply and can use electric power stored in the secondary battery 8304. Thus, the electric refrigerator-freezer 8300 can be operated with use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In addition, in a time period when electronic devices are not used, particularly when the proportion of the amount of electric power that is actually used to the total amount of electric power that can be supplied from a commercial power supply source (such a proportion is referred to as a usage rate of electric power) is low, electric power is stored in the secondary battery, whereby the usage rate of electric power can be reduced in a time period other than the above time period. For example, in the case of the electric refrigerator-freezer 8300, electric power is stored in the secondary battery 8304 in night time when the temperature is low and the refrigerator door 8302 and the freezer door 8303 are not opened and closed. On the other hand, in daytime when the temperature is high and the refrigerator door 8302 and the freezer door 8303 are opened and closed, the secondary battery 8304 is used as an auxiliary power supply; thus, the usage rate of electric power in daytime can be reduced.

According to one embodiment of the present invention, the secondary battery can have excellent cycle performance and improved reliability. Furthermore, according to one embodiment of the present invention, a secondary battery with high charge/discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with any of the other embodiments.

### Embodiment 7

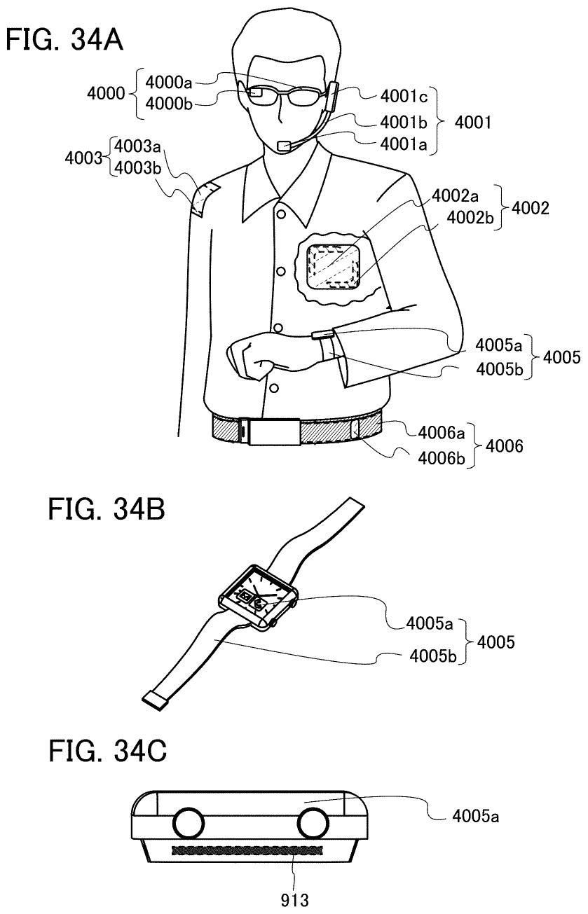

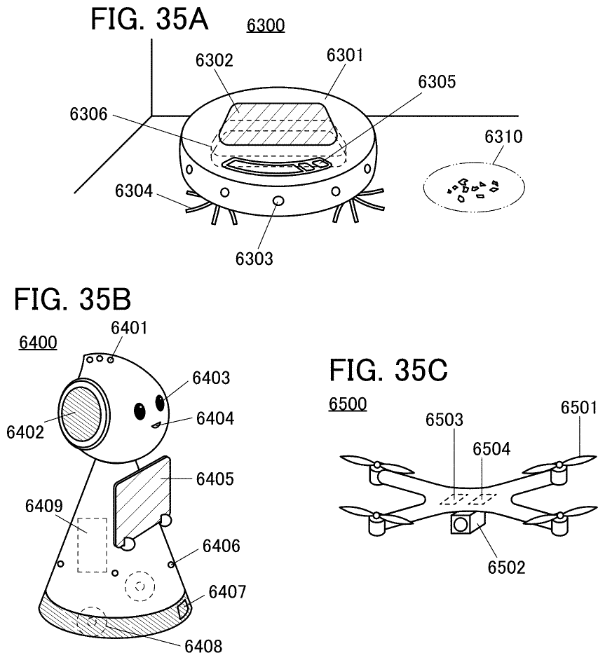

In this embodiment, examples of electronic devices each including the secondary battery described in the above embodiment are described with reference to FIG. 34 to FIG. 35.

FIG. 34A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 34A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. With use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. With use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 34B is a perspective view of the watch-type device 4005 that is detached from an arm.

FIG. 34C is a side view. FIG. 34C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 35A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 35B illustrates an example of a robot. A robot 6400 illustrated in FIG. 35B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. The robot 6400 including the secondary battery of one embodiment of the present invention can be a highly reliable electronic device that can operate for a long time.

FIG. 35C illustrates an example of a flying object. A flying object 6500 illustrated in FIG. 35C includes propellers 6501, a camera 6502, a secondary battery 6503, and the like and has a function of flying autonomously.

For example, image data shot by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention in its interior region. The flying object 6500 including the secondary battery of one embodiment of the present invention can be a highly reliable electronic device that can operate for a long time.

This embodiment can be implemented in appropriate combination with any of the other embodiments.

### Embodiment 8

In this embodiment, an example in which a secondary battery is applied to an electric vehicle (EV) will be described.

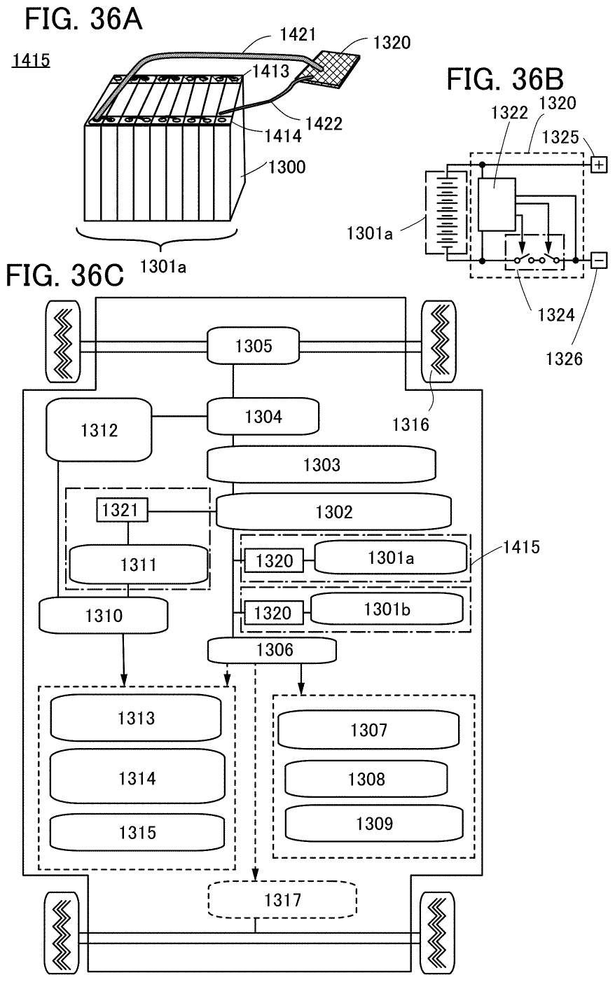

The electric vehicle is provided with first batteries 1301a and 1301b as main secondary batteries for driving and a second battery 1311 that supplies electric power to an inverter 1312 for starting a motor 1304 as shown in FIG. 36C. The second battery 1311 is also referred to as a cranking battery (a starter battery). The second battery 1311 only needs high output and high capacity is not so much needed; the capacity of the second battery 1311 is lower than that of the first batteries 1301a and 1301b.

For the first batteries 1301a and 1301b, secondary batteries with the manufacturing method of a secondary battery described in the above embodiment can be used.

Although this embodiment shows an example where the two first batteries 1301a and 1301b are connected in parallel, three or more batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a is described with reference to FIG. 36A.

FIG. 36A illustrates an example in which nine rectangular secondary batteries 1300 form one battery pack 1415. The nine rectangular secondary batteries 1300 are connected in series;

one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, a structure in which the secondary batteries are stored in a battery container box (also referred to as a housing) may be employed. Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor) in some cases.

The control circuit portion 1320 detects a terminal voltage of the secondary battery and controls the charging and discharging state of the secondary battery. For example, to prevent overcharging, the control circuit portion 1320 can turn off an output transistor of a charging circuit and an interruption switch substantially at the same time.

FIG. 36B illustrates an example of a block diagram of the battery pack 1415 illustrated in FIG. 36A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is incorporated into a moving vehicle, typically a transport vehicle, will be described.

By incorporating the secondary battery of one embodiment of the present invention into vehicles, next-generation clean energy automobiles such as hybrid vehicles (HVs), electric vehicles (EVs), and plug-in hybrid vehicles (PHVs) can be achieved.

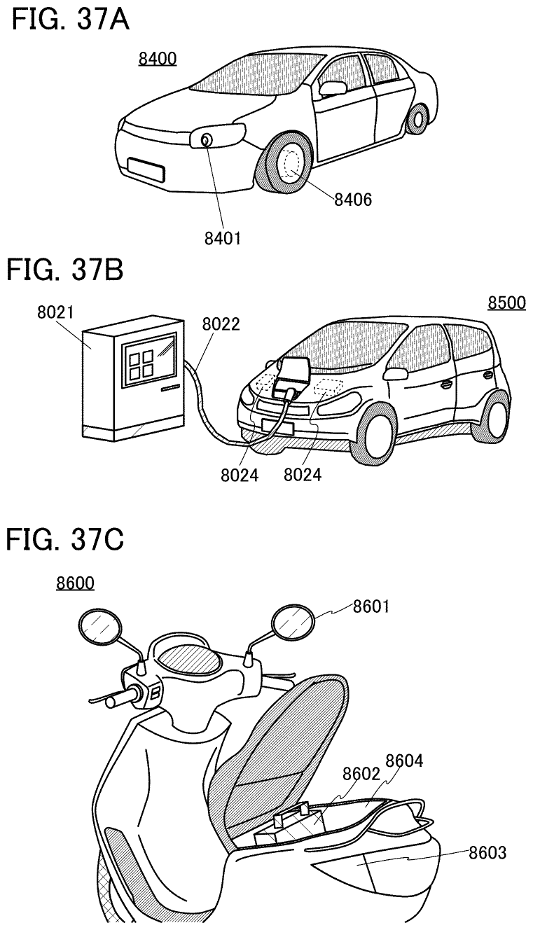

FIG. 37 illustrates examples of a vehicle including the secondary battery of one embodiment of the present invention. An automobile 8400 illustrated in FIG. 37A is an electric vehicle that runs on the power of an electric motor. Alternatively, the automobile 8400 is a hybrid electric vehicle capable of driving appropriately using either an electric motor or an engine as a power source. The use of one embodiment of the present invention can achieve a high-mileage vehicle. The automobile 8400 includes the secondary battery. As the secondary battery, the modules of the secondary batteries shown in FIG. 19C and FIG. 19D may be arranged to be used in a floor portion in the automobile. Alternatively, a battery pack in which a plurality of secondary batteries shown in FIG. 22 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 37B can be charged when the secondary battery included in the automobile 8500 is supplied with electric power through external charge equipment by a plug-in system, a contactless power feeding system, and/or the like. FIG. 37B illustrates a state where a secondary battery 8024 included in the automobile 8500 is charged with the use of a ground-based charging apparatus 8021 through a cable 8022. In charging, a given method such as CHAdeMO (registered trademark) or Combined Charging System may be employed as a charging method, the standard of a connector, and the like as appropriate. The charging apparatus 8021 may be a charging station provided in a commerce facility or a household power source. For example, with use of a plug-in technique, the secondary battery 8024 included in the automobile 8500 can be charged by being supplied with electric power from outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road and/or an exterior wall, charging can be performed not only when the vehicle is stopped but also when driven. The contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, one or more of an electromagnetic induction method and a magnetic resonance method can be used.

FIG. 37C illustrates an example of a motorcycle including the secondary battery of one embodiment of the present invention. A motor scooter 8600 illustrated in FIG. 37C includes a secondary battery 8602, side mirrors 8601, and direction indicators 8603. The secondary battery 8602 can supply electric power to the direction indicators 8603.

In the motor scooter 8600 illustrated in FIG. 37C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge/discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

### Example 1

In this example, the negative electrode active material of one embodiment of the present invention is formed and its characteristics are evaluated.

### <Formation of Negative Electrode Active Material>

A negative electrode active material was formed according to the flowchart shown in FIG. 3. MCMB graphite having a specific surface area of 1.5 m²/g was used as the first material 801. Lithium fluoride was used as the material 802 containing halogen. Lithium carbonate was used as the material 803 containing oxygen and carbon.

As the negative electrode active material, an active material AG1, an active material AG2, an active material AG3, and an active material AG4 were formed.

### [AG1]

As materials for the active material AG1, graphite, lithium fluoride, and lithium carbonate were prepared (refer to Step S21, Step S22, and Step S23 in FIG. 3). They were compounded such that graphite:lithium fluoride:lithium carbonate=100:5:5 (weight %), and dry mixing was performed (refer to Step S31 to Step S33 in FIG. 3).

### [AG2]

As materials for the active material AG2, graphite and lithium carbonate were prepared. They were compounded such that graphite:lithium carbonate=100:10 (weight %), and dry mixing was performed.

### [AG3]

As materials for the active material AG3, graphite and lithium fluoride were prepared. They were compounded such that graphite:lithium fluoride=100:10 (weight %), and dry mixing was performed.

Each mixture of the materials for the active materials was baked at 850° C. for 10 hours in a nitrogen atmosphere, whereby each of the active materials was obtained (refer to Step S51 to Step S53 in FIG. 3).

### [AG4]

As the active material AG4, graphite was prepared. Baking was not performed.

### <SEM and EDX>

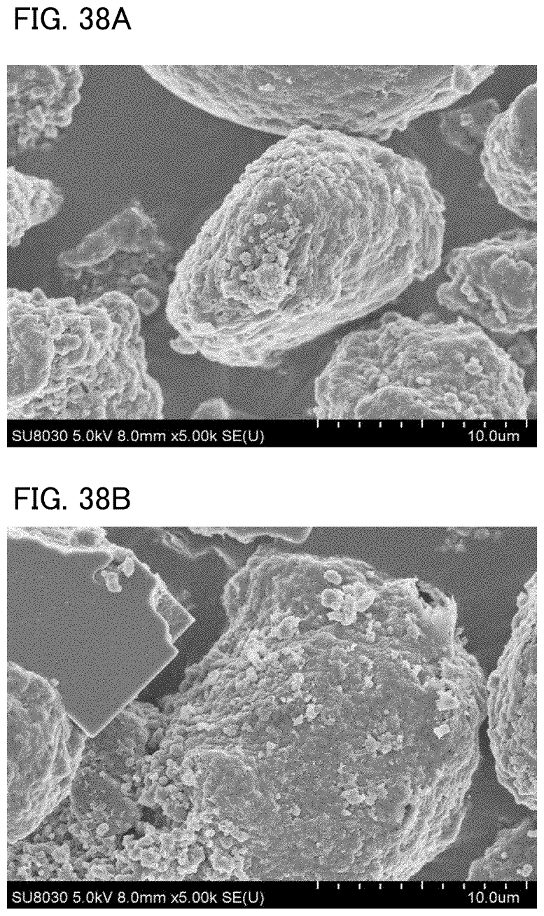

Observation of scanning electron microscope (SEM) images and EDX analysis of the formed active material AG1 and active material AG3 were performed using SU8030 produced by Hitachi High-Technologies Corporation. An observation image of the active material AG1 is shown in FIG. 38A, and an observation image of the active material AG3 is shown in FIG. 38B.

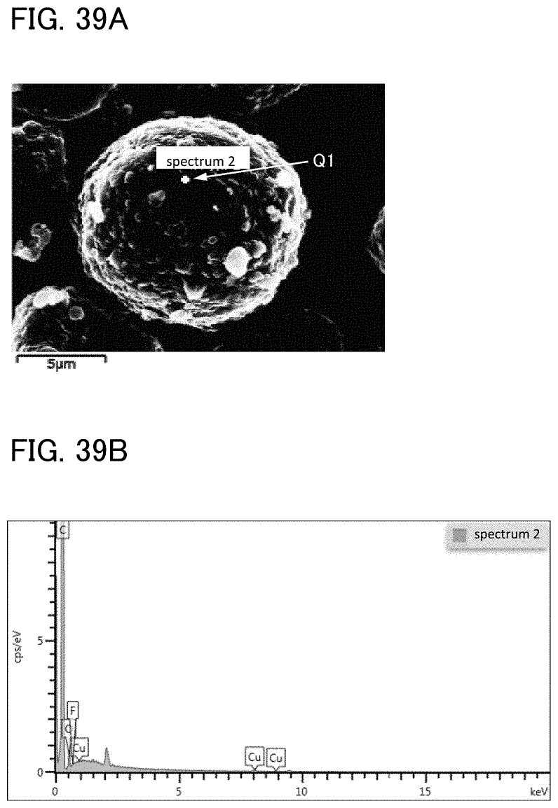

The active material AG1 was subjected to EDX analysis at a point Q1 shown in FIG. 39A. A spectrum obtained is shown in FIG. 39B.

Table 1 shows concentrations of elements obtained by the EDX. Oxygen and fluorine were detected as main elements in the active material AG1, which indicates that a region containing oxygen and fluorine is formed on a particle surface.

TABLE 1

| | atomic % |
|---|---|
| O | 62.3 |
| F | 37.7 |
| Cu | 0 |

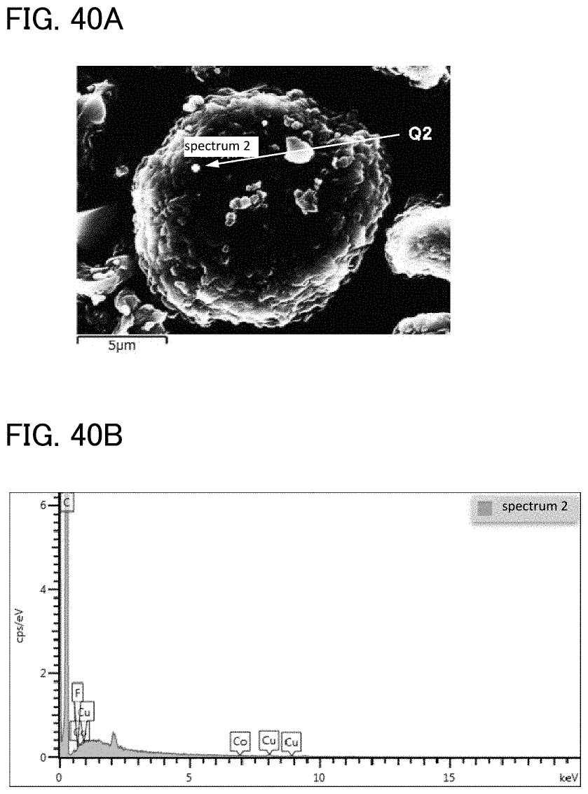

The active material AG3 was subjected to EDX analysis at a point Q2 shown in FIG. 40A. A spectrum obtained is shown in FIG. 40B.

Table 2 shows concentrations of elements obtained by the EDX. Fluorine and copper were detected as main elements in the active material AG3, which indicates that a region containing fluorine and copper is formed on a particle surface.

TABLE 2

| | atomic % |
|---|---|
| F | 49.1 |
| Co | 0 |
| Cu | 50.9 |

### <XPS>

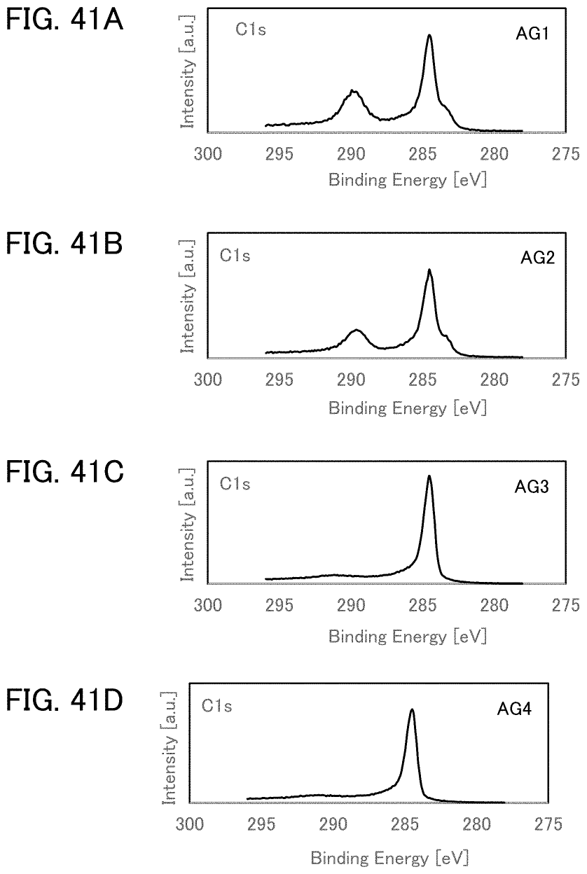

XPS measurement was performed on each of the formed active materials. The detection area was approximately 100 μmφ, and the take-off angle was 45°. FIG. 41 to FIG. 47 show obtained narrow spectra. In each graph, the vertical axis represents the spectrum intensity, and the horizontal axis represents the binding energy.

FIG. 41A, FIG. 41B, FIG. 41C, and FIG. 41D show a C1s spectrum of the active material AG1, that of the active material AG2, that of the active material AG3, and that of the active material AG4, respectively.

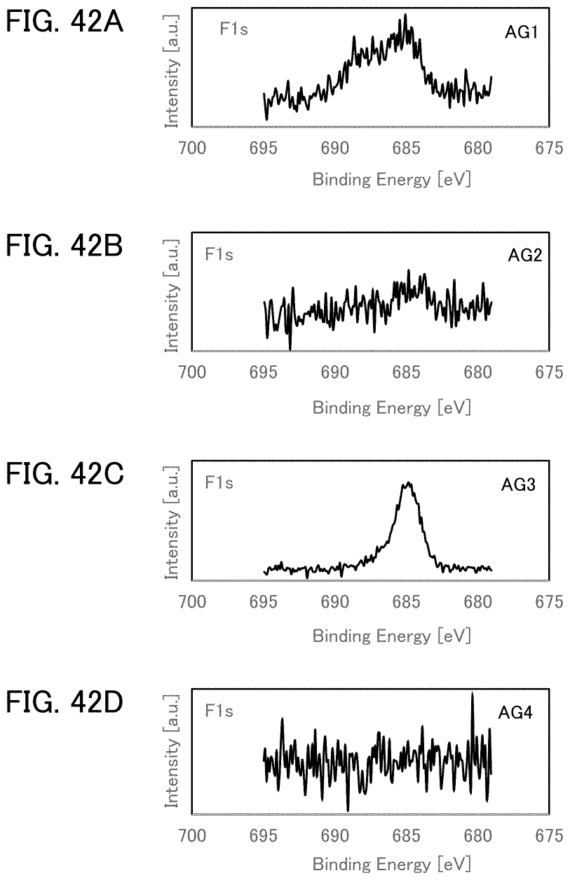

FIG. 42A, FIG. 42B, FIG. 42C, and FIG. 42D show an F1s spectrum of the active material AG1, that of the active material AG2, that of the active material AG3, and that of the active material AG4, respectively.

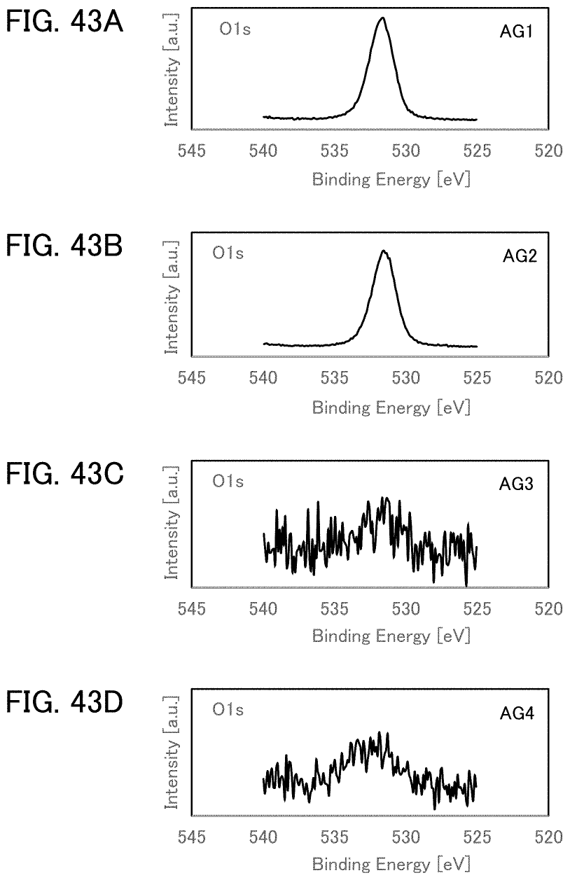

FIG. 43A, FIG. 43B, FIG. 43C, and FIG. 43D show an O1s spectrum of the active material AG1, that of the active material AG2, that of the active material AG3, and that of the active material AG4, respectively.

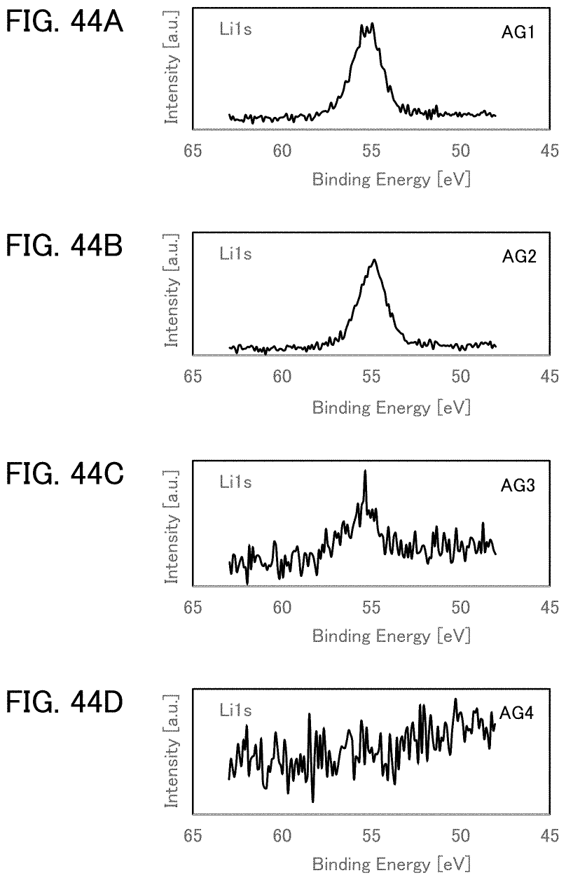

FIG. 44A, FIG. 44B, FIG. 44C, and FIG. 44D show a Li1s spectrum of the active material AG1, that of the active material AG2, that of the active material AG3, and that of the active material AG4, respectively.

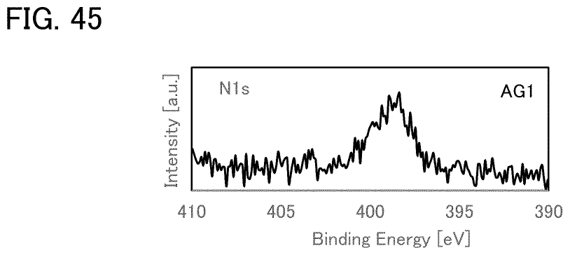

FIG. 45 shows an N1s spectrum of the active material AG1.

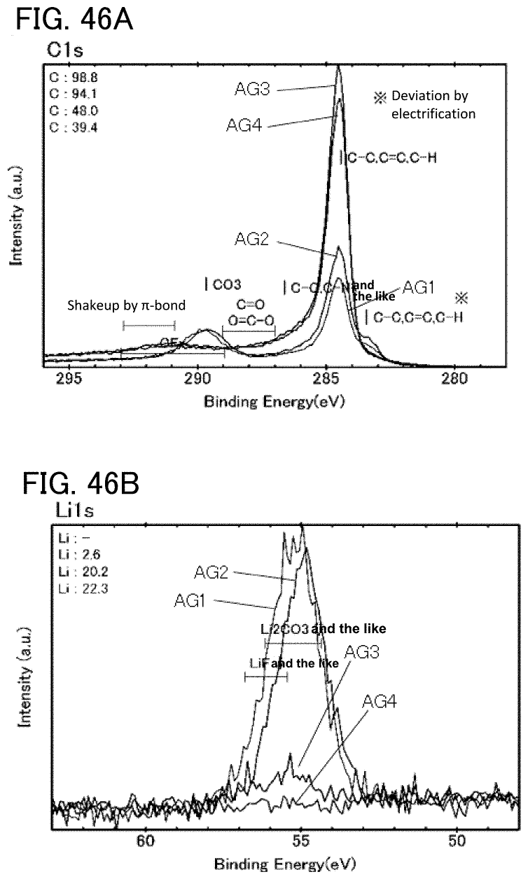

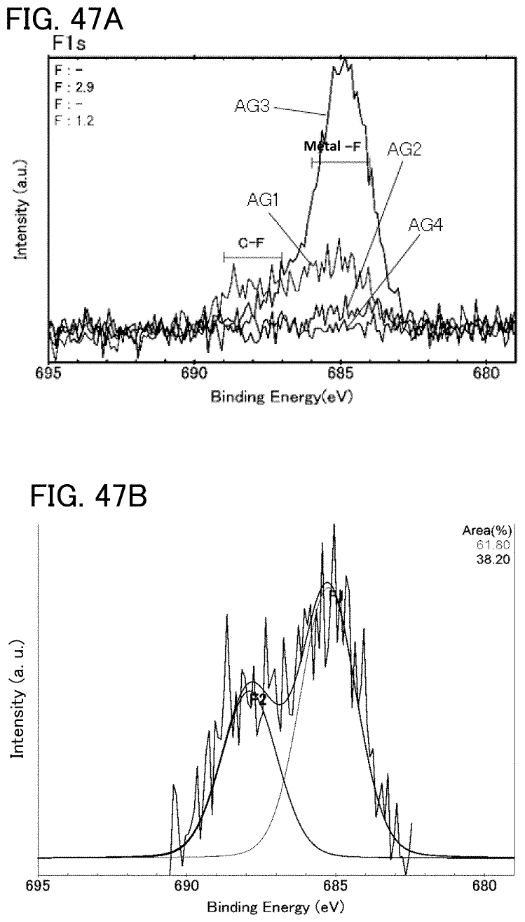

FIG. 46A is a graph exhibiting the C1s spectra of the active materials superimposed on each other. FIG. 46B is a graph exhibiting the Li1s spectra of the active materials superimposed on each other. FIG. 47A is a graph exhibiting that the F1s spectra of the active materials are superimposed on each other. FIG. 47B shows a fitting result of the obtained F1s spectrum of the active material AG1, focusing on a peak attributed to a metal-F bonding state and a peak attributed to a C—F binding state.

Table 3 shows element concentrations calculated from the XPS results of the active materials.

TABLE 3

| | atomic % | | | | |
|---|---|---|---|---|---|
| | C | O | Li | F | N |
| AG1 | 39.4 | 35.4 | 22.3 | 1.2 | 1.7 |
| AG2 | 48.0 | 31.9 | 20.2 | 0 | 0 |
| AG3 | 94.1 | 0.3 | 2.6 | 2.9 | 0 |
| AG4 | 98.8 | 1.2 | 0 | 0 | 0 |

According to Table 3, fluorine was detected at 1 atomic % or more from each of the active materials AG1 and AG3 using lithium fluoride as a material in the active material formation. In each of the active materials AG1 and AG2 using lithium carbonate as a material in the active material formation, carbon, oxygen, and lithium were detected significantly. The detected carbon concentration was 1 or more times as high as the detected oxygen concentration, and the detected lithium concentration was approximately 0.6 times as high as the detected oxygen concentration.

As for each of the active materials AG1 and AG2 measured by XPS, the O1s spectrum exhibits a significant peak at around 531 eV, and the C1s spectrum exhibits a significant peak at around 290 eV. This indicates the existence of carbonate groups.

As a result of fitting in the active material AG1, the F1s spectrum obtained by XPS indicates the existence of a peak at around 688 eV, and the active material AG1 presumably has C—F bonds on its surface or the like. From the above, it is considered that fluorine of the lithium fluoride is bonded to at least one of carbon in the graphite and carbon in the lithium carbonate.

### Example 2

In this example, electrodes were formed using the negative electrode active materials formed in Example 1, and secondary batteries using the electrodes were fabricated and evaluated.

### <Formation of Electrode>

Next, each of the prepared negative electrode active materials was mixed with a vapor-grown carbon fiber and PVDF such that the negative electrode active material:the vapor-grown carbon fiver:PVDF=96:1:3 (weight ratio), and with use of NMP for a solvent, slurry was formed.

As the vapor-grown carbon fiber, VGCF (registered trademark)-H (manufactured by SHOWA DENKO K.K., the fiber diameter: 150 nm, the specific surface area: 13 m²/g) was used.

A current collector was coated with the formed slurry and then drying was performed, so that an active material layer was formed on the current collector. As the current collector, copper foil having a thickness of 18 μm was used. The active material layer was provided on one surface of the current collector. The loading amount of the active material layer is approximately in a range of from 6 mg/cm² to 8 mg/cm².

### <Fabrication of Secondary Battery>

Next, CR2032 type coin-type secondary batteries (a diameter of 20 mm, a height of 3.2 mm) were fabricated for evaluation.

Lithium metal was used for a counter electrode of each formed electrode.

As an electrolyte contained in an electrolyte solution, 1 mol/L lithium hexafluorophosphate (LiPF₆) was used. As the electrolyte solution, a solution in which ethylene carbonate (EC) and diethyl carbonate (DEC) were mixed at a volume ratio of 3:7 was used.

As a separator, 25-μm-thick polypropylene was used.

A positive electrode can and a negative electrode can that were formed using stainless steel (SUS) were used.

### <Rate Performance>

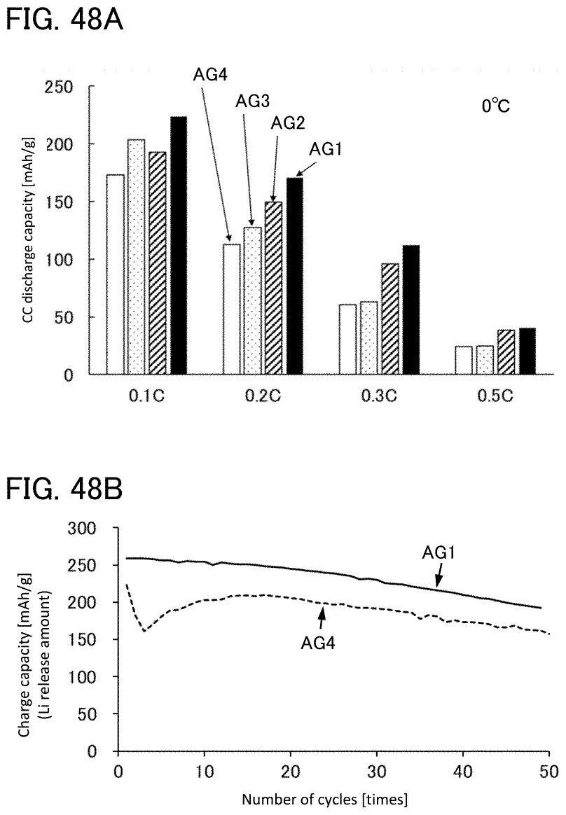

With use of the fabricated secondary batteries, the rate dependency of discharge capacity was evaluated. In this evaluation, during discharging the electrodes including the respective negative electrode active materials formed in Example 1, lithium is inserted into the negative electrode active materials. FIG. 48A shows discharge capacity of the secondary batteries using the respective negative electrode active materials at 0° C.

The active material AG1 exhibits high discharge capacity at every rate, which indicates an improvement in performance by existence of a region containing oxygen and fluorine formed on the particle surface.

### <Cycle Performance>

The cycle performances of the fabricated secondary batteries were evaluated. In FIG. 48B, the vertical axis represents charge capacity in each charge/discharge cycle, and the horizontal axis represents the number of cycles. In this evaluation, during charging the electrodes including the respective negative electrode active materials formed in Example 1, lithium is extracted from the negative electrode active materials.

The active material AG1 exhibits high charge capacity in the first cycle, which indicates an improvement in charge/discharge efficiency by existence of a region containing oxygen and fluorine formed on the particle surface.

### Example 3

In this example, laminated secondary batteries were fabricated using the negative electrode active materials formed in Example 1 and evaluated.

### <Formation of Negative Electrode>

AG1 was mixed with a conductive additive, CMC-Na (carboxymethyl cellulose), and SBR (styrene-butadiene rubber) such that AG1:the conductive additive:CMC-Na:SBR=96:1:1:2 (weight ratio), and with use of water as a solvent, slurry was formed.

The polymerization degree of CMC-Na that was used was 600 to 800, and the viscosity of a 1 wt % CMC-Na aqueous solution was in the range from 300 mPa×s to 500 mPa×s. As the conductive additive, VGCF (registered trademark)-H (manufactured by SHOWA DENKO K.K., the fiber diameter: 150 nm, the specific surface area: 13 m²/g) was used.

A current collector was coated with the formed slurry and then drying was performed, so that a negative electrode active material layer was formed on the current collector. As the current collector, copper foil having a thickness of 18 μm was used. The negative electrode active material layer was provided on one surface of the current collector.

Moreover, AG4 was mixed with a conductive additive, CMC-Na (carboxymethyl cellulose), and SBR (styrene-butadiene rubber) such that AG4:the conductive additive:CMC-Na:SBR=96:1:1:2 (weight ratio), and with use of water as a solvent, slurry was formed.

The polymerization degree of CMC-Na that was used was 600 to 800, and the viscosity of a 1 wt % CMC-Na aqueous solution was in the range from 300 mPa×s to 500 mPa×s. As the conductive additive, VGCF (registered trademark)-H (manufactured by SHOWA DENKO K.K., the fiber diameter: 150 nm, the specific surface area: 13 m²/g) was used.

A current collector was coated with the formed slurry and then drying was performed, so that a negative electrode active material layer was formed on the current collector. As the current collector, copper foil having a thickness of 18 μm was used. The negative electrode active material layer was provided on one surface of the current collector.

### <Formation of Positive Electrode>

Next, a positive electrode was fabricated. A Sample fabricated in this example is described with reference to the formation method shown in FIG. 14.

As LiMO₂ in Step S64, with use of cobalt as the transition metal M, a commercially available lithium cobalt oxide (Cellseed C-10N produced by NIPPON CHEMICAL INDUSTRIAL CO., LTD.) not containing any additive was prepared. Lithium fluoride and magnesium fluoride were mixed therewith by a solid phase method, as in Step S71 to Step S73 and Step S81 and Step S82. Lithium fluoride and magnesium fluoride were added such that the number of molecules of lithium fluoride was 0.33 and the number of molecules of magnesium fluoride was 1 with the number of cobalt atoms assumed as 100. The mixture here is the mixture 903.

Next, the heating was performed as in Step S83. In a square-shaped alumina container, 30 g of the mixture 903 was placed, a lid was put on the container, and heating was performed in a muffle furnace. The atmosphere in the furnace was purged and an oxygen gas was introduced; the oxygen flow was stopped during the heating. The heating was performed at a temperature of 900° C. for 20 hours.

To the composite oxide that had been heated, nickel hydroxide and aluminum hydroxide were added and mixed by a dry method as Step S101. The addition was performed so that the number of nickel atoms was 0.5 and the number of aluminum atoms was 0.5 with the number of cobalt atoms assumed as 100.

Next, the heating was performed as in Step S103. In a square-shaped alumina container, 30 g of the mixture 903 was placed, a lid was put on the container, and heating was performed in a muffle furnace. The atmosphere in the furnace was purged and an oxygen gas was introduced; the oxygen flow was performed during the heating. The heating was performed at a temperature of 850° C. for 10 hour.

After that, the mixture was made to pass through a sieve with an aperture diameter of 53 pimp and powder was collected, so that positive electrode active materials were obtained.

Next, a positive electrode was fabricated using the formed positive electrode active material. Acetylene black was used as a conductive additive, the formed positive electrode active material and the conductive additive were mixed to form a slurry, and the slurry was applied to a current collector of aluminum.

After the slurry was applied onto the current collector, a solvent was volatilized. After that, pressure was applied at 210 kN/m, and then pressure was applied at 1467 kN/m. Through the above process, the positive electrode was obtained. The loading amount of the positive electrode was approximately 7 mg/cm².

### <Fabrication of Secondary Battery>

With use of the positive electrode and the negative electrodes fabricated in the above manner, the secondary batteries using films as exterior bodies were fabricated.

As a separator, 25-μm-thick polypropylene was used.

The positive electrode, the separator, and the negative electrode were stacked in this order. Arrangement was performed so that the positive electrode active material provided on the one surface of the current collector faces the negative electrode active material with the separator sandwiched therebetween.

Leads were bonded to the positive electrode and the negative electrode.

A stack in which the positive electrodes, the negative electrode, and the separators are stacked was sandwiched between facing portions of the exterior body that is folded in half, and the stack was placed so that one ends of the leads extend outside the exterior body. Next, one side of the exterior body was left as an aperture, and the other sides were sealed.

As a film to be the exterior body, a film in which a polypropylene layer, an acid modified polypropylene layer, an aluminum layer, and a nylon layer are stacked in this order was used. The thickness of the film was approximately 110 μm. The film to be the exterior body was bent so that the nylon layer is placed as the surface of the exterior body placed on the outer side and the polypropylene layer is placed as the surface of the exterior body placed on the inner side. The thickness of the aluminum layer was approximately 40 μm, the thickness of the nylon layer was approximately 25 μm, and the total thickness of the polypropylene layer and the acid modified polypropylene layer was approximately 45 μm.

Next, in an argon gas atmosphere, an electrolyte solution was introduced from the one side left as an aperture.

As the electrolyte solution, 1 mol/L lithium hexafluorophosphate (LiPF₆) was used. As the electrolyte solution, a solution in which fluoroethylene carbonate (FEC), ethylmethyl carbonate (EMC), and dimethyl carbonate (DMC) were mixed at a volume ratio of 3:3.5:3.5 was used.

Then, the one side of the exterior body left as an aperture was sealed in a reduced-pressure atmosphere.

Through the above steps, two secondary batteries using reduced graphene oxide as a conductive additive (hereinafter, referred to as a cell AG1-C1 and a cell AG4-C2) were fabricated.

### <Cycle Performance>

The cycle performances of the fabricated secondary batteries were evaluated. The measurement temperature was set to −40° C. As charge, CC charging was performed at 0.05 C with a termination voltage of 4.5 V and then CV charging was performed under termination conditions of 0.02 C. As discharge, CC discharging was performed at 0.05 C with a termination voltage of 3.0 V.

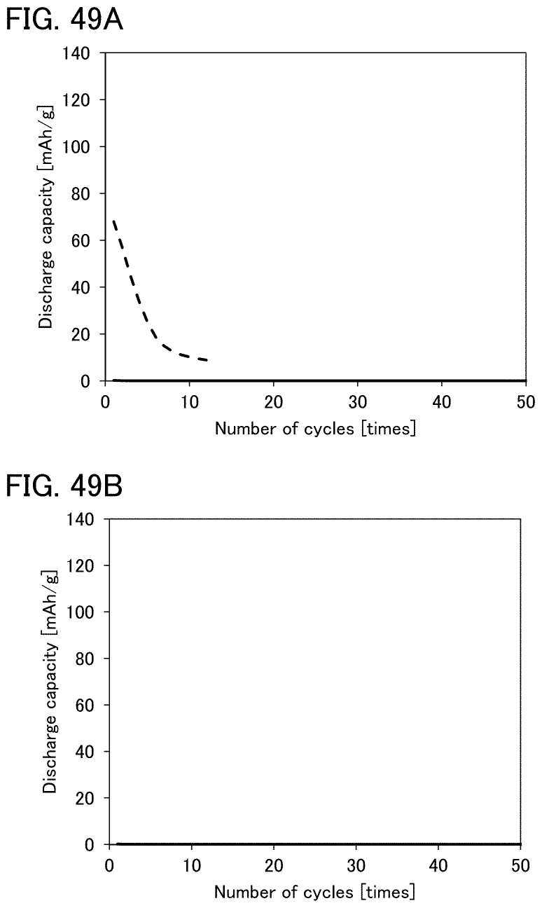

FIG. 49A shows measurement results of AG1-C1, and FIG. 49B shows measurement results of AG4-C2.

Whereas AG4-C2 was incapable of charging and discharging even in combination with the electrolyte using FEC, AG1-C1 was capable of charging and discharging in combination with an electrolyte using FEC though having low capacity.

### Example 4

### <<XRD>>

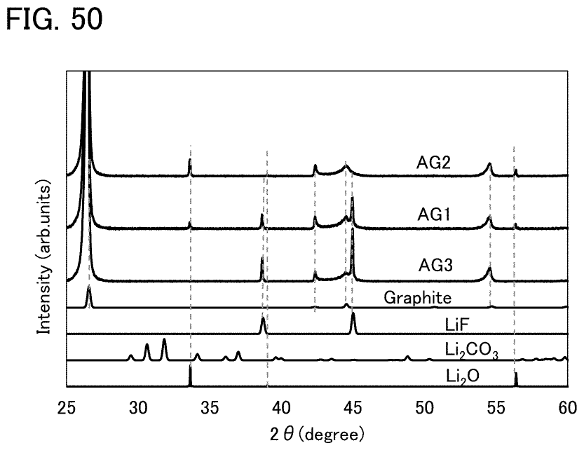

Next, X-ray diffraction (XRD) measurement was performed on AG1, AG2, and AG3 formed in Example 1. FIG. 50 shows ideal XRD spectra obtained by CuKα1 radiation, which are calculated from crystal structure models of AG1, AG2, and AG3. The vertical axis of the graph represents the spectrum intensity, and the horizontal axis thereof represents the diffraction angle (2θ). For comparison, ideal XRD patterns calculated from crystal structures of graphite, LiF, LiCoO₂ (O3), and Li₂O are also shown. The space group of Li₂O was Fm-3m (225), and its lattice constant was 4.610 Å (0.4610 nm). Note that the patterns of graphite, LiF, LiCoO₂ (O3), and Li₂O were made from crystal structure data obtained from the ICSD (Inorganic Crystal Structure Database) (see Non-Patent Document 2) with Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The space group of Li₂O was Fm-3m, and its lattice constant was 0.4610 nm.

As shown in FIG. 50, the X-ray peaks of AG1 and AG2 are observed substantially at the same positions as the ideal peak positions of graphite, LiF, and Li₂O; thus, it is considered that AG1 and AG2 each contain graphite, LiF, and Li₂O. Meanwhile, the X-ray peak of AG3 is positioned substantially at the same position as the ideal peaks of graphite and LiF but does not align with the ideal peak position of Li₂O. Thus, AG3 is considered not containing Li₂O, and oxygen detected from AG1 and AG2 by XPS or the like is conceivably derived from Li₂O.

### REFERENCE NUMERALS

100: positive electrode active material, 102: space in heating furnace, 104: hot plate, 106: heater unit, 108: heat insulator, 116: container, 118: lid, 119: space, 120: heating furnace, 144: C atom, 210: electrode stack, 211a: positive electrode, 211b: negative electrode, 212a: lead, 212b: lead, 214: separator, 215a: bonding portion, 215b: bonding portion, 217: fixing member, 250: secondary battery, 251: exterior body, 261: folded portion, 262: seal portion, 263: seal portion, 271: crest line, 272: trough line, 273: space, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: negative electrode active material, 401: region, 401a: region, 401b: region, 402: region, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 440: secondary battery, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 550: current collector, 553: acetylene black, 554: graphene, 561: negative electrode active material, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: wiring, 617: temperature control device, 750a: positive electrode, 750b: solid electrolyte layer, 750c: negative electrode, 751: electrode plate, 752: insulating tube, 753: electrode plate, 761: lower component, 762: upper component, 764: butterfly nut, 765: O ring, 766: insulator, 770a: package component, 770b: package component, 770c: package component, 771: external electrode, 772: external electrode, 773a: electrode layer, 773b: electrode layer, 801: material, 802: material, 803: material, 804: mixture, 805: negative electrode active material, 808: cobalt-containing material, 811: composite oxide, 812: fluoride, 813: compound, 814: mixture, 900: circuit board, 902: mixture, 903: mixture, 904: mixture, 910: label, 911: terminal, 911a: terminal, 911b: terminal, 912: circuit, 913: secondary battery, 914: antenna, 915: seal, 916: layer, 917: layer, 918: antenna, 920: display device, 921: sensor, 922: terminal, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 980: secondary battery, 981: film, 982: film, 993: wound body, 994: negative electrode, 995: positive electrode, 996: separator, 997: lead electrode, 998: lead electrode, 1300: rectangular secondary battery, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power windows, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 4000: glasses-type device, 4000a: frame, 4000b: display portion, 4001: headset-type device, 4001a: microphone part, 4001b: flexible pipe, 4001c: earphone portion, 4002: device, 4002a: housing, 4002b: secondary battery, 4003: device, 4003a: housing, 4003b: secondary battery, 4005: watch-type device, 4005a: display portion, 4005b: belt portion, 4006: belt-type device, 4006a: belt portion, 4006b: wireless power feeding and receiving portion, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper, camera, 6404: speaker, 6405: display portion, 6406: lower camera, 6407: obstacle sensor, 6408: moving mechanism, 6409: secondary battery, 6500: flying object, 6501: propeller, 6502: camera, 6503: secondary battery, 6504: electronic component, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8000: display device, 8001: housing, 8002: display portion, 8003: speaker portion, 8004: secondary battery, 8021: charging apparatus, 8022: cable, 8024: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 8400: automobile, 8401: headlight, 8406: electric motor, 8500: automobile, 8600: motor scooter, 8601: side mirror, 8602: secondary battery, 8603: direction indicator, 8604: under-seat storage, 9600: tablet terminal, 9625: switch, 9626: switch, 9627: switch, 9628: operation switch, 9629: fastener, 9630: housing, 9630a: housing, 9630b: housing, 9631: display portion, 9631a: display portion, 9631b: display portion, 9633: solar cell, 9634: charge/discharge control circuit, 9635: power storage unit, 9636: DCDC converter, 9637: converter, 9640: movable portion

1-2. (canceled)

3. A method for manufacturing a negative electrode active material, the method comprising the steps of:
forming a first mixture by mixing a first material, a second material comprising halogen, and a third material comprising oxygen and carbon; and
heating the first mixture,
wherein the first material comprises one or more selected from graphite, graphitizing carbon, non-graphitizing carbon, carbon nanotube, carbon black, and graphene, and
wherein the heating is performed in a reduction atmosphere.

4. The method for manufacturing a negative electrode active material according to claim 3,
wherein the second material comprises fluoride or chloride comprising one or more selected from lithium, magnesium, aluminum, sodium, potassium, calcium, barium, lanthanum, cerium, chromium, manganese, iron, cobalt, nickel, zinc, zirconium, titanium, vanadium, and niobium.

5. The method for manufacturing a negative electrode active material according to claim 3, wherein the third material comprises carbonate comprising one or more selected from lithium, magnesium, aluminum, sodium, potassium, calcium, barium, lanthanum, cerium, chromium, manganese, iron, cobalt, and nickel.

6. The method for manufacturing a negative electrode active material according to claim 3, wherein the reduction atmosphere is a nitrogen atmosphere or a rare gas atmosphere.

7. The method for manufacturing a negative electrode active material according to claim 3,
wherein the second material comprising halogen comprises lithium fluoride,
wherein the third material comprising oxygen and carbon comprises lithium carbonate,
wherein the heating is performed at a temperature higher than or equal to 350° C. and lower than or equal to 900° C. for a time longer than or equal to 1 hour and shorter than or equal to 60 hours, and
wherein the heating is performed in a nitrogen atmosphere or a rare gas atmosphere.

8. The method for manufacturing a negative electrode active material according to claim 7, wherein the first material comprises one or more selected from graphite, graphitizing carbon, non-graphitizing carbon, carbon nanotube, carbon black, and graphene.

9. The method for manufacturing a negative electrode active material according to claim 7, wherein the first material comprises a metal or a compound comprising one or more elements selected from silicon, tin, gallium, aluminum, germanium, lead, antimony, bismuth, silver, zinc, cadmium, and indium.

10. The method for manufacturing a negative electrode active material according to claim 7, wherein the first material comprises an oxide comprising one or more elements selected from titanium, niobium, tungsten, and molybdenum.

11. A negative electrode active material comprising:
a first region comprising a first material;
a second region comprising lithium, carbon, and at least one of fluorine and oxygen;
wherein the second region is positioned on an outer side of the first region,
wherein the second region is in contact with at least a part of a surface of the first region,
wherein a concentration of fluorine in the second region is higher than a concentration of fluorine in the first region,
wherein a concentration of oxygen in the second region is higher than a concentration of oxygen in the first region, and
wherein the first material comprises one or more selected from graphite,
graphitizing carbon, non-graphitizing carbon, carbon nanotube, carbon black, and graphene.

12. The negative electrode active material according to claim 11, wherein at least a part of the first region comprises a surface of the negative electrode active material.

13. The negative electrode active material according to claim 11, wherein a concentration of lithium in the second region is higher than a concentration of lithium in the first region.

14. A negative electrode active material comprising:
a first region comprising a first material; and
a second region comprising at least one of lithium fluoride and lithium carbonate,
wherein the second region is positioned on an outer side of the first region, and
wherein the second region is in contact with at least a part of the first region.

15. The negative electrode active material according to claim 14, wherein at least a part of the first region comprises a surface of the negative electrode active material.

16. The negative electrode active material according to claim 14, wherein when the negative electrode active material is measured by an energy dispersive X-ray spectrometry method with a scanning electron microscope, fluorine concentration whose concentration unit is represented as atomic % is higher than or equal to 10 atomic % and lower than or equal to 70 atomic %.

17. The negative electrode active material according to claim 14, wherein the first material comprises one or more selected from graphite, graphitizing carbon, non-graphitizing carbon, carbon nanotube, carbon black, and graphene.

18. The negative electrode active material according to claim 14, wherein fluorine concentration is higher than or equal to 1 atomic % when the negative electrode active material is measured by X-ray photoelectron spectroscopy.

19. The negative electrode active material according to claim 14,
wherein the first material comprises one or more selected from graphite, graphitizing carbon, non-graphitizing carbon, carbon nanotube, carbon black, and graphene, and
wherein fluorine concentration is higher than or equal to 1 atomic % with respect to a total concentration of fluorine, oxygen, and lithium when the negative electrode active material is measured by X-ray photoelectron spectroscopy.

20. A secondary battery comprising:
a negative electrode comprising the negative electrode active material according to claim 14;
a positive electrode; and
an electrolyte.

21. A vehicle comprising:
the secondary battery according to claim 20;
an electric motor; and
a circuit portion,
wherein the circuit portion is configured to control the secondary battery.

22. An electronic device comprising:
the secondary battery according to claim 20;
a display portion; and
a circuit portion,
wherein the circuit portion is configured to control the secondary battery.
